(19) United States
(12) Patent Application Publication
(10) Pub. No.: US 2024/0130367 A1
(43) Pub. Date: Apr. 25, 2024

(54) PLANT GROWTH PROMOTERS

(71) Applicant: University of Durham, Durham (GB)

(72) Inventors: Patrick Giles Steel, Durham (GB); Marc Knight, Durham (GB)

(21) Appl. No.: 18/268,852

(22) PCT Filed: Dec. 16, 2021
(86) PCT No.: PCT/GB2021/053335

§ 371 Date: Jun. 21, 2023

(30) Foreign Application Priority Data
Dec. 22, 2020 (GB) 2020389.9

(51) Int. Cl. A01N 43/42; A01N 41/06; A01P 21/00

(52) U.S. Cl. CPC A01N 43/42; A01N 41/06; A01P 21/00

(57) ABSTRACT

The present invention concerns the use of small molecule DELLA degradation promoters of formula (I) in promoting plant growth.

### FIELD OF THE INVENTION

The present invention concerns small molecule DELLA degradation promoters of formula (I). The invention also concerns the use of such compounds in promoting plant growth.

### BACKGROUND OF THE INVENTION

Plant growth and development involves the integration of many environmental signals and plant hormones (W. M. Gray, PLos Biology2 (9), 1270-1273, 2004). Plant hormones including gibberellic acid (GA), abscisic acid (ABA), cytokinin, ethylene and brassinosteroids regulate many aspects of plant growth and development at relatively low concentrations (Gray 2004, supra). GA promotes important processes in plant growth and development such as seed germination, cell elongation and cell division, as well as floral transition (D. E. Richards, K. E. King, T. Ait-ali and N. P. Harberd, Annu. Rev. Plant Physiol. Plant Mol. Biol. 52, 67-88, 2001).

Bioactive GAs are diterpene phytohormones that modulate plant growth and development throughout the plant life cycle. The major function of GAs is to stimulate organ growth through the enhancement of cell elongation and cell division (R. Gupta, and S. K. Chakrabarty, Plant Signaling & Behavior 8, 1-5, 2013). The GA receptor was first identified in rice where OsGID1 gene encodes a protein possessing GA-binding activity, and its mutation results in a severe dwarf phenotype that does not respond to GA in either stem elongation or seed germination (Y. Tao, Cell, 133, 164-176, 2008). In Arabidopsis there are three homologs of the GA receptors, AtGID1a, AtGID1b and AtGID1c (M. Nakajima et al., Plant Journal, 46, 880-889, 2008). The specificity of GID1 homologs function can be observed from double mutants (H. Suzuki, S.-H. Park and K. Okubo, The Plant Journal, 60, 48-55, 2009).

In GA signalling the key mechanism is that GA represses DELLA protein function. DELLA proteins are negative regulators of plant growth, which belong to the GRAS protein superfamily of transcriptional regulators. The degradation of these proteins is considered a major event in plant growth (A. L. Hauvermale, T. Ariizumi and C. M. Steber (2012), Plant Physiology, 160: 83-92). There are five DELLA repressor proteins in Arabidopsis: REPRESSOR OF GIBBERELLIC ACID (RGA), GA-INSENSITIVE (GAI), RGA-Like Protein (RGA1), RGA2, RGA3. Activation of the GA signalling pathway is initiated by the interaction between bioactive GAs and GID1, which promotes a conformational change in the receptor. The formation of a GA-GID1-DELLA complex enables a protein-protein interaction between the DELLA and the F-box protein SLY1 resulting in ubiquitination and degradation of the DELLA protein (K. Hirano et al., Plant Cell, 22, 2680-2696, 2010). The degradation of DELLA protein activates transcription factors downstream hence the response of GA signalling can be observed through the manifestation of this gene expression.

Etiolated seedlings are regulated by phytochrome interacting factors (PlFs), a subset of basic helix-loop-helix (bHLH) transcription factors. PlFs mediate hypocotyl elongation and their activity is negatively regulated by the red light photoreceptor phyB and by DELLA proteins that act as a repressor in the GA signalling pathway (M. de Lucas et al., Nature, 451, 480-484, 2008). The activation of phyB in the light leads to destabilization of PlFs while the accumulation of DELLA proteins block PlFs activity by binding the DNA-recognition domain of this factor. In contrast, PIF proteins accumulate and directly regulate genes to maintain skotomorphogenesis in the dark (K. Li et al., Nat. Commun., 7, 11868, 2016), leading to elongated hypocotyls. For this reason hypocotyl growth is an often used growth assay to monitor GA-DELLA signalling.

GAs are complicated molecules produced industrially by fermentation using the fungus Fusarium moniliforme (see C. Rodrigues et al., Crit. Rev. Biotechnol., 2011, 32 (3), 263-273). The costs associated with producing GAs preclude their use in promoting plant growth, except in specific high value plants. The present invention aims to provide small molecule DELLA degradation promoters that are easy and cheap to manufacture and have a potential use in the promotion of plant growth.

### SUMMARY OF THE INVENTION

The structures of N-(6-Aminohexyl)-1-naphthalenesulfonamide (NA/5) and N-(6-Aminohexyl)-5-chloro-1-naphthalenesulfonamide (W7) are shown in FIG. 1. These compounds are known to act as inhibitors of calmodulins (CaMs), calmodulin-like proteins (CM Ls) and calcium-dependent protein kinases (CPKs) (see W. Sinclair et al., Planta, 1996, 199, 343-351). Any calcium dependent process (including plant growth) is blocked by these compounds. Consequently, W5 and W7 inhibit plant growth and, on prolonged exposure to these compounds, a plant will eventually die.

On investigating derivatives of W5 and W7, the present inventors have found that compounds of formula (I) are surprisingly effective plant growth promotors. These findings were unexpected, given the known inhibition of plant growth by W5 and W7. Without being bound by theory, the inventor's studies suggest that compounds of formula (I) promote growth via the GA-DELLA pathway and act to enhance the potency of endogenous GAs. Consequently, the compounds of formula (I) have potential use as agrochemicals for promoting plant growth.

Compounds of formula (I) are easy to make and easier to store than GAs known to be useful in promoting plant growth. GAs are prone to degradation by sunlight or heat and are typically stored in cool, dry conditions within aluminium foil to protect them from sunlight. Degradation of GAs makes them less effective or entirely ineffective. Consequently, the use of GAs in promoting plant growth is restricted; GA compositions should be prepared on the day of use owing to their instability (these compositions typically degrade within about one week). The inventors have found that compounds of formula (I) are less prone to such degradation and are consequently easier to store and use.

Viewed from a first aspect, there is provided use of a compound as a plant growth promoter, wherein the compound is of formula (I):

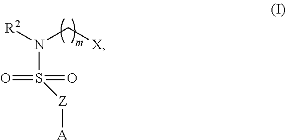

wherein Z-A is any one of the structures represented by formulae (IIIb), (IVb), (Vb) and (VIb):

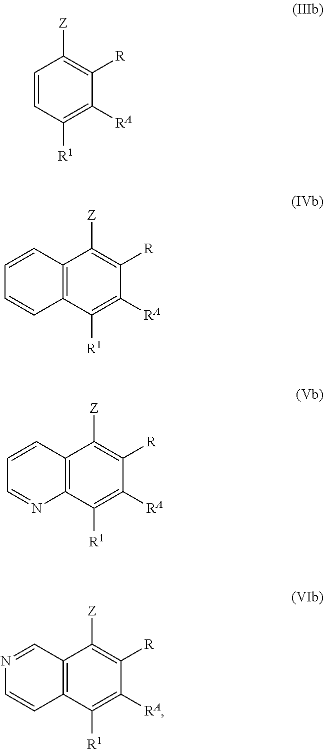

X is NH₂, NHCH₃ or NHCH₂CH₃,
Z is —(CH₂)ₙ— or —O(CH₂)ₙ—, wherein n is 0 or 1,
m is 2, 3 or 4,
R is selected from the group consisting of H, C₁-C₈alkyleneoxyC₁-C₈alkoxy, C₁-C₈alkyl, C₁-C₄alkoxy, fluoro, nitro and optionally substituted phenyl,
R¹ is selected from the group consisting of H, C₁-C₈alkyleneoxyC₁-C₈alkoxy, C₁-C₈alkyl, C₁-C₄alkoxy, optionally substituted phenyl, nitro and fluoro,
R^{A} is selected from the group consisting of H, C₁-C₄alkoxy, fluoro, C₁-C₈alkyleneoxyC₁-C₈alkoxy, C₁-C₈alkyl, optionally substituted phenyl and nitro,
R² is H, C₁-C₄ alkyl or of formula (II):

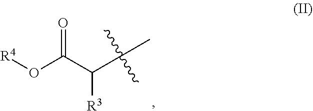

wherein R₃ and R₄ are each H or C₁-C₄alkyl.

Viewed from a second aspect, there is provided a composition comprising any one or a selection of the compounds defined in the first aspect and a fertiliser.

Viewed from a third aspect, there is provided use of a composition of the second aspect as a plant growth promoter.

Viewed from a fourth aspect, there is provided a plant, seed, bulb or tuber comprising a compound or selection of the compounds defined in the first aspect or a composition of the second aspect.

Viewed from a fifth aspect, there is provided a method of promoting plant growth comprising contacting a plant, seed, bulb or tuber with a compound or selection of the compounds defined in the first aspect or a composition of the second aspect.

Viewed from a sixth aspect, there is provided a plant, seed, bulb or tuber obtainable by the method of the fifth aspect.

Further aspects and embodiments of the invention will be evident from the discussion that follows below.

### BRIEF DESCRIPTION OF THE FIGURES

FIG. 1: The chemical structures of N-(6-Aminohexyl)-1-naphthalenesulfonamide (W5) and N-(6-Aminohexyl)-5-chloro-1-naphthalenesulfonamide (W7).

FIG. 2: The screening of the series at the concentration of 100 uM to investigate the effect of the compounds on root length. Error bars represent standard error. Asterisks indicate statistically significant differences (independent t-test, **P<0.005, ***P<0.001) between DMSO and chemical treatment.

FIG. 3: A: Fresh weight differences of leaves, roots and the whole plant, and B: Ratio between dry weight and fresh weight of plants after control and eW5 treatment. Asterisks indicate statistically significant differences (independent t-test, *P<0.05, **P<0.005) between control and eW5 treatment.

FIG. 4: Effect of eW5 on the fluorescence level in the roots of a transgenic Arabidopsis line expressing RGA-GFP. The concentration for GA3, eW5 and PAC was 100 μM. The seedlings were treated with GA and eW5 at different time points, 2 hr and 24 hr, while the treatment of PAC was for 48 hr. Scale bars indicate 10 μm.

FIG. 5: Hypocotyl length of Arabidopsis after eW5 treatment. GA and PAC represent positive and negative control, respectively. Error bars represent standard error from 30 seedlings. Asterisks indicate statistically significant differences (independent t-test, **P<0.005, ***P<0.001) between chemical treatment.

FIG. 6: Bar chart of hypocotyl growth assay for della quintuple mutant. This mutant lacks of all DELLA function, hence it was used to investigate the DELLA-dependency of eW5. Error bars represent standard error and asterisks indicate statistically significant differences (independent t-test, *P<0.05, ***P<0.001) between chemical treatment.

FIG. 7: Bar chart of hypocotyl length of GA biosynthesis mutant, ga1-5 after eW5 treatment for three days. The concentration used for this assay was 100 μM. Error bars represent standard error. Asterisks indicate statistically significant differences (independent t-test, ***P<0.001) between chemical treatment.

FIG. 8: The graph of hypocotyl length for GA receptor double mutants. The assay was performed using at least 30 seedlings per treatment. Asterisks indicate statistically significant differences (independent t-test, **P<0.005) between chemical treatment.

FIG. 9: Root growth assay for eW5 analogues with eW5 as a positive control. The data shown is based on three biological replicates. A: New root growth (in cm) after treatment with the chemicals at 100 μM concentration. B: The relative percentage of growth as compared to control (DMSO). Asterisks indicate statistically significant differences (independent t-test, *P<0.05, ***P<0.001) between chemical treatment and the control, DMSO.

FIG. 10: Hypocotyl growth assay for eW5 analogues with eW5 as a positive control. A: New hypocotyl growth (in cm) after treatment with the chemicals at 100 μM concentration. The error bars represent standard error. B: The relative percentage of growth as compared to control (DMSO). The graph was based on three biological replicates. Asterisks indicate statistically significant differences (independent t-test, *P<0.05, **P<0.005, ***P<0.001) between chemical treatment and DMSO (as control).

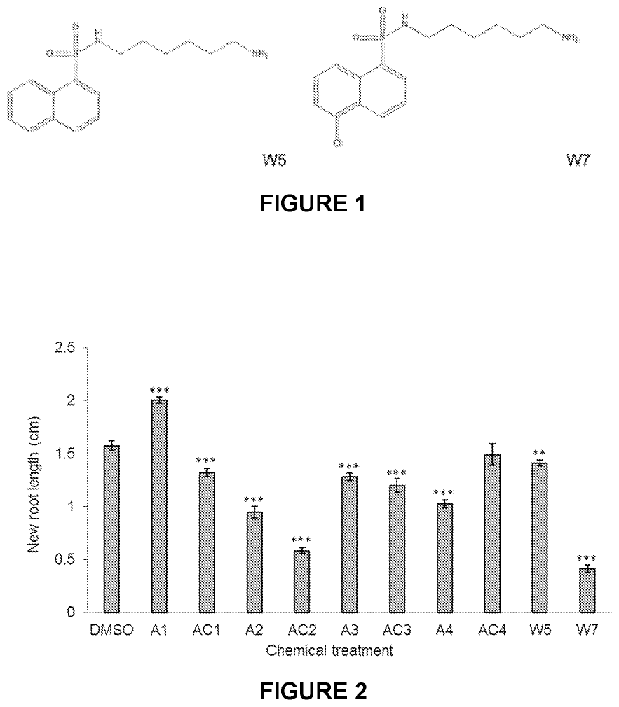

### DETAILED DESCRIPTION OF THE INVENTION

Throughout this specification, one or more aspects of the invention may be combined with one or more features described in the specification to define distinct embodiments of the invention.

As described above, the present inventors have found that compounds of formula (I) are surprisingly effective plant growth promotors. Compounds of formula (I) are derivatives of W5 and W7, which are known inhibitors of plant growth, thus promotion of plant growth by compounds of formula (I) was unexpected.

In the discussion that follows, reference is made to a number of terms, which are to be understood to have the meanings provided below, unless a context indicates to the contrary. The nomenclature used herein for defining compounds, in particular the compounds described herein, is intended to be in accordance with the rules of the International Union of Pure and Applied Chemistry (IUPAC) for chemical compounds, specifically the “IUPAC Compendium of Chemical Terminology (Gold Book)” (see A. D. Jenkins et al., Pure & Appl. Chem., 68, 2287-2311 (1996)). For the avoidance of doubt, if an IUPAC rule is contrary to a definition provided herein, the definition herein is to prevail.

The term “comprising” or variants thereof will be understood to imply the inclusion of a stated element, integer or step, or group of elements, integers or steps, but not the exclusion of any other element, integer or step, or group of elements, integers or steps. The term “consisting” or variants thereof will be understood to imply the inclusion of a stated element, integer or step, or group of elements, integers or steps, and the exclusion of any other element, integer or step or group of elements, integers or steps.

The term “about” herein, when qualifying a number or value, is used to refer to values that lie within ±5% of the value specified. For example, if a concentration is defined as about 20 μM to about 200 μM, concentrations of 19 μM to 210 μM are included.

The term “monocyclic” defines a moiety comprising a single ring of atoms in its structure. Examples of monocycles include benzene and pyridine.

The term “bicyclic” defines a moiety comprising two fused rings of atoms in its structure. Examples of bicycles include naphthalene and benzopyridine.

The term “polycyclic” defines a moiety comprising more than one ring of atoms in its structure. Examples of polycycles include naphthalene, benzopyridine, naphtholactam and benzoxadiazole (such as 2,1,3-benzoxadiazole).

The term “aryl” defines a group derived from an arene by removal of a hydrogen atom from a ring carbon atom, wherein an arene is a monocyclic or polycyclic aromatic hydrocarbon.

The term “heteroaryl” defines a group derived from a heteroarene by removal of a hydrogen atom from a ring carbon or heteroatom, wherein a heteroarene is a monocyclic or polycyclic aromatic hydrocarbon comprising one or more heteroatoms.

The term “aromatic” defines a cyclically conjugated molecular entity with a stability (due to delocalisation) significantly greater than that of a hypothetical localised structure. The Huckel rule is often used in the art to assess aromatic character; monocyclic planar (or almost planar) systems of trigonally (or sometimes digonally) hybridised atoms that contain (4n+2) π-electrons (where n is a non-negative integer) will exhibit aromatic character. The rule is generally limited to n=0 to 5.

The term “conjugated” or variants thereof defines a molecular entity whose structure may be represented as a system of alternating single and multiple bonds. In such systems, conjugation is the interaction of one p-orbital with another across an intervening π-bond in such structures. In appropriate molecular entities d-orbitals may be involved. The term is also extended to the analogous interaction involving a p-orbital containing an unshared electron pair.

The term “delocalised” defines the 7-bonding in a conjugated system where the bonding is not localised between two atoms, but instead each link has a fractional double bond character, or bond order.

The term “alkyl” is well known in the art and defines univalent groups derived from alkanes by removal of a hydrogen atom from any carbon atom, wherein the term “alkane” is intended to define acyclic branched or unbranched hydrocarbons having the general formula CₙH₂ₙ₊₂, wherein n is an integer ≥1. C₁-C₄alkyl refers to any one selected from the group consisting of methyl, ethyl, n-propyl, iso-propyl, n-butyl, sec-butyl, iso-butyl and tent-butyl.

The term “alkoxy” defines univalent groups derived from alcohols by removal of the hydrogen atom from the oxygen atom of the alcohol, wherein the term “alcohol” is intended to define compounds derived from alkanes, wherein a hydrogen atom bonded to any carbon atom is substituted for a hydroxy group, —OH. C₁-C₄alkoxy refers to any one selected from the group consisting of methoxy, ethoxy, n-propoxy, iso-propoxy, n-butoxy, sec-butoxy, iso-butoxy and tert-butoxy.

The term “alkyleneoxyalkoxy” defines univalent groups derived from alkoxyalkanol by removal of the hydrogen atom from the oxygen atom of the —OH moiety. Examples of alkyleneoxyalkoxy groups include ethoxyethoxy, ethoxymethoxy, methoxyethoxy and methoxymethoxy groups.

For the avoidance of doubt, the term “ethoxyethoxy” defines univalent groups derived from 2-ethoxyethanol by removal of the hydrogen atom from the oxygen atom of the —OH moiety.

Dicotyledons, also known as dicots, are flowering plants organised into the class Dicotyledonae or Magnoliopsida, depending on which classification system is used. Dicots typically have a pair of embryonic seed leaves (cotyledons), broad leaves with a network of veins, vascular bundles in ring shapes and floral parts in multiples of 4 or 5. Dicots include kale, cauliflower, broccoli, mustard plant, cabbage, pea, clover, alfalfa, broad bean, tomato, cassava, soybean, peanut, canola, alfalfa, sunflower, safflower, tobacco, Arabidopsis, and cotton.

Monocotyledons, also known as monocots, are either a class or clade of flowering plants, depending on which classification system is used. Monocots typically have a single cotyledon, parallel veins running down the leaf, scattered vascular bundles in the stem, the absence of a typical cambium (being one which produces a secondary xylem towards the pith and a secondary phloem towards the bark), and an adventitious root system. Monocots include corn, rice, barley, sorghum, wheat, rye, millet, sugarcane, oat, triticale, switchgrass, or turfgrass plant.

The term “hypocotyl” refers to the stem of a germinating seedling, situated below the cotyledon(s) and above the root.

The term “fertiliser” is used herein to refer to any substance that supplies one or more plant nutrients that play a part in the growth of plants. Fertilisers may be added to soil, land or other plant growth medium; the leaves of a plant (known as “foliar feeding”); the roots of a plant; or directly onto seeds, bulbs or tubers before planting. Often, fertilisers are added to soil, land or other plant growth medium. Fertilisers typically comprise one or more nutrients from the group consisting of nitrogen, phosphorus, potassium, calcium, magnesium, sulfur, copper, iron, manganese, molybdenum, zinc and boron. Sometimes, fertilisers contain one or more of silicon, cobalt, and vanadium.

Where a compound or selection of compounds or a composition described herein is used as a plant growth promoter, it is used to increase the rate of growth of any part of a plant relative to the normal rate of plant growth (normal being the rate of plant growth under the same conditions, absent the growth promoter). For the avoidance of doubt, the growth of roots from a seed, bulb or tuber is included within the definition of “plant growth”.

For the avoidance of doubt, references herein to a plant or parts of a plant include trees, shrubs, herbs, grasses, ferns, and mosses, and parts thereof. Also included are saplings and seedlings, i.e. the plant may be at any stage of growth.

A seed is defined herein as an embryonic plant enclosed in a protective outer covering (seed coat) that is capable of producing a spermatophyte (also known as a phanerogam), that is a plant that itself produces seeds.

Bulbs and tubers are defined herein as a short stems that functions as a plant's food storage organ during dormancy and are capable of producing a geophyte (a plant that itself produces bulbs and tubers). Bulbs are typically round to oval in shape, with a pointed top. Inside the bottom or basal portion of the bulb is typically a bud. Examples of bulbs include onions, garlic, leeks, fennel, chives, tulips, narcissus and lilies. Unlike bulbs, tubers do not have a basal plate. Tubers may be any of a variety of shapes, including flat or cylindrical. Tubers may also come in dusters. Examples of tubers include potatoes, kumara, yam, taro, Jerusalem artichoke, ulluco, begonias and dahlias.

The term “solvate” is used herein to refer to a compound comprising a solute, such as a compound or salt of the compound, and a solvent. If the solvent is water, the solvate may be termed a hydrate, for example a mono-hydrate, di-hydrate, tri-hydrate etc, depending on the number of water molecules present per molecule of substrate.

The term “isotope” is used herein to define a variant of a particular chemical element, in which the nucleus necessarily has the same atomic number but has a different mass number owing to it possessing a different number of neutrons.

Described herein is a compound of formula (IA):

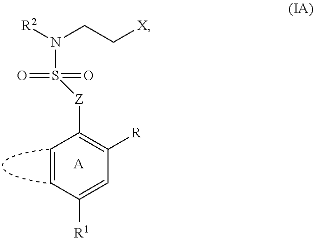

wherein A is a 6-membered monocyclic aryl or heteroaryl or a polycyclic aryl or heteroaryl,
X is NH₂ or NH(C₁-C₄alkyl),
Z is —(CH₂)ₙ— or —O(CH₂)ₙ—, wherein n is 0 or 1,
R and R¹ are each independently selected from the group consisting of H, C₁-C₈alkyleneoxyC₁-C₈alkoxy, C₁-C₈alkyl and C₁-C₈alkoxy,
R² is H, C₁-C₄alkyl or of formula (II):

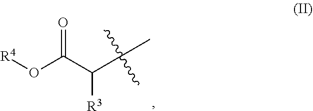

wherein R³ and R⁴ are each H or C₁-C₄alkyl.

For the avoidance of doubt, when Z is —O(CH₂)ₙ—the oxygen atom of Z is bonded directly to A.

When A is a 6-membered monocyclic heteroaryl or a polycyclic heteroaryl, it comprises one or more heteroatoms. The heteroatoms may be selected from the group consisting of nitrogen, oxygen and sulfur. For example, the heteroatoms may be nitrogen atoms. When A is a heteroaryl, it may comprise one nitrogen atom.

The polycyclic aryl or heteroaryl may be a bicyclic aryl or heteroaryl. Often, the polycyclic aryl or heteroaryl is a 10-membered bicyclic aryl or heteroaryl, i.e. A is a 6-membered monocyclic aryl or heteroaryl or a 10-membered bicyclic aryl or heteroaryl.

A may be benzene or a 10-membered bicyclic aryl or heteroaryl. In particular, A may be benzene, naphthalene or benzopyridine ring.

For the avoidance of doubt, where A is a benzene, naphthalene or benzopyridine ring, the compound of formula (IA) is of the structure represented by formulae (III) to (V), respectively:

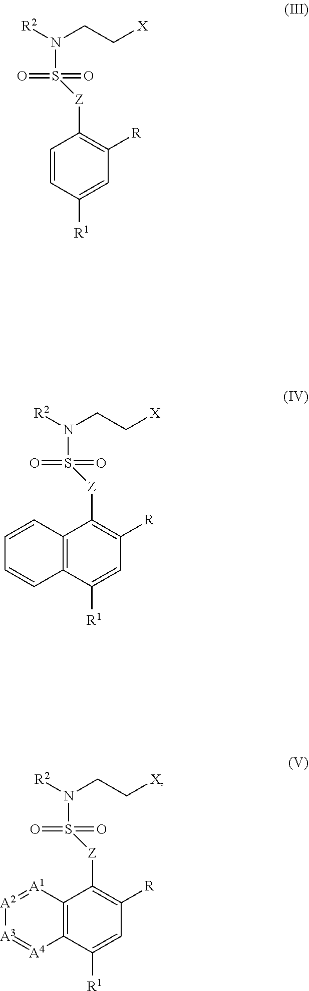

where any one of A¹ to A⁴ is a nitrogen atom and the other three of A¹ to A⁴ are each carbon atoms.

Sometimes, where A is benzopyridine, the compound of formula (V) is represented by formulae (Va) or (Vb):

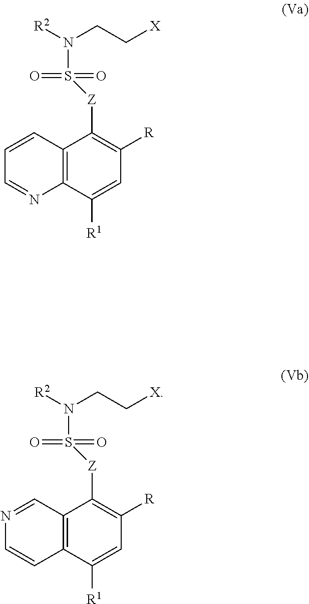

The compound of formula (V) may be represented by formula (Va).

As described above, in a first aspect there is provided use of a compound as a plant growth promoter, wherein the compound is of formula (I):

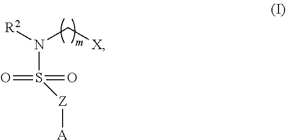

wherein Z-A is any one of the structures represented by formulae (IIIb), (IVb), (Vb) and (VIb):

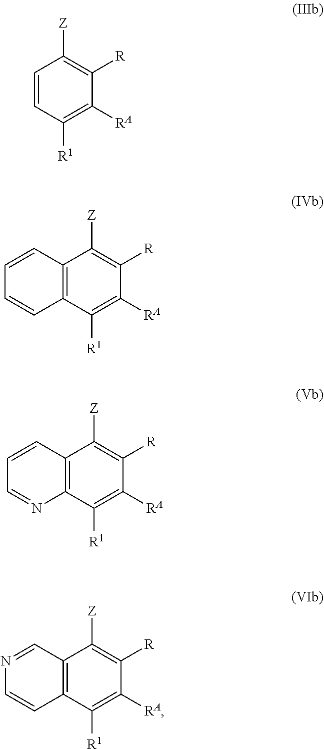

X is NH₂, NHCH₃ or NHCH₂CH₃,
Z is —(CH₂)ₙ— or —O(CH₂)ₙ—, wherein n is 0 or 1,
m is 2, 3 or 4,
R is selected from the group consisting of H, C₁-C₈alkyleneoxyC₁-C₈alkoxy, C₁-C₈alkyl, C₁-C₄alkoxy, fluoro, nitro and optionally substituted phenyl,
R¹ is selected from the group consisting of H, C₁-C₈alkyleneoxyC₁-C₈alkoxy, C₁-C₈alkyl, C₁-C₄alkoxy, optionally substituted phenyl, nitro and fluoro,
R^{A} is selected from the group consisting of H, C₁-C₄alkoxy, fluoro, C₁-C₈alkyleneoxyC₁-C₈alkoxy, C₁-C₈alkyl, optionally substituted phenyl and nitro,
R² is H, C₁-C₄ alkyl or of formula (II):

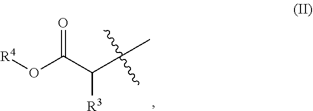

wherein R₃ and R₄ are each H or C₁-C₄alkyl.

In some embodiments, when Z is —O(CH₂)ₙ—, n is 1. The inventors have found that when Z is —(CH₂)ₙ— and n is 1, the resultant compounds are particularly useful in root growth. In some embodiments, Z is —(CH₂)ₙ— wherein n is 0 or Z is —O(CH₂)ₙ— wherein n is 1. In some embodiments, Z is —(CH₂)ₙ— wherein n is 0.

X of formula (IA) may be NH₂ or NH(C₁-C₄alkyl). X of formula (IA) may be any one selected from the group consisting of NH₂, NHCH₃, NHCH₂CH₃, NHCH₂CH₂CH₃ and NHCH(CH₃)₂, such as NH₂, NHCH₃ or NHCH₂ CH₃. X of formula (IA) may be NH₂ or NHCH₃. Sometimes, X of formula (IA) is NH₂. X of formula (I) is NH₂, NHCH₃ or NHCH₂CH₃. In some embodiments, X of formula (I) is NH₂ or NHCH₃, such as NH₂.

m of formula (I) is 2, 3 or 4. In some embodiments, m is 2 or 3, such as 2.

R of formula (I) is selected from the group consisting of H, C₁-C₈alkyleneoxyC₁-C₈alkoxy, C₁-C₈alkyl, C₁-C₄alkoxy, fluoro, nitro and optionally substituted phenyl. Sometimes, the C₁-C₈alkyleneoxyC₁-C₈alkoxy is C₁-C6alkyleneoxyC₁-C₆alkoxy, e.g. C₁-C₄alkyleneoxyC₁-C₄alkoxy such as C₁-C₂alkyleneoxyC₁-C₂alkoxy. In some cases, the C₁-C₈alkyl is C₁-C₆alkyl, such as C₁-C₄alkyl. Sometimes, the C₁-C₄ alkoxy is C₁ -C₂ alkoxy. In some embodiments, R is selected from the group consisting of H, C₁-C₂alkyleneoxyC₁-C₂alkoxy, C₁-C₄alkyl, C₁-C₄alkoxy, fluoro and nitro. In particular embodiments, R is selected from the group consisting of H, ethoxyethoxy, methoxy and fluoro.

R¹ of formula (I) is selected from the group consisting of H, C₁-C₈alkyleneoxyC₁-C₈alkoxy, C₁-C₈alkyl, C₁-C₄alkoxy, optionally substituted phenyl, nitro and fluoro. Sometimes, the C₁-C₈alkyleneoxyC₁-C₈alkoxy is C₁-C₆alkyleneoxyC₁-C₆alkoxy, e.g. C₁-C₄alkyleneoxyC₁-C₄alkoxy such as C₁-C₂alkyleneoxyC₁-C₂alkoxy. In some cases, the C₁-C₈alkyl is C₁-C₆alkyl, such as C₁-C₄alkyl. Sometimes, the C₁ -C₄alkoxy is C₁ -C₂alkoxy. In some embodiments, R¹ is selected from the group consisting of H, C₁-C₂alkyleneoxyC₁-C₂alkoxy, C₁-C₄alkyl, C₁-C₄alkoxy, phenyl, nitro and fluoro. In particular embodiments, R¹ is selected from the group consisting of H, ethoxyethoxy, methyl, ethyl, n-propyl, tent-butyl, methoxy, phenyl and nitro.

In some embodiments R¹ is not methyl. In particular, R¹ may not be methyl where Z-A is of formula (IIIb), n is 0, m is 2, R², R and R^{A} are each H, and X is NH₂. In such embodiments, R¹ may be selected from H, C₁-C₈alkyleneoxyC₁-C₈alkoxy, C₂-C₈alkyl, C₁-C₄alkoxy, optionally substituted phenyl, nitro and fluoro. In some cases, the C₂-C₈alkyl is C₂-C₆alkyl, such as C₂-C₄alkyl. R¹ may selected from the group consisting of H, C₁-C₂alkyleneoxyC₁-C₂alkoxy, C₂-C₄alkyl, C₁-C₄alkoxy, phenyl, nitro and fluoro. Alternatively, R¹ may be selected from the group consisting of H, ethoxyethoxy, ethyl, n-propyl, tent-butyl, methoxy, phenyl and nitro.

R^{A} is selected from the group consisting of H, C₁-C₄alkoxy, fluoro, C₁-C₈alkyleneoxyC₁-C₈alkoxy, C₁-C₈alkyl, optionally substituted phenyl and nitro. Sometimes, the C₁-C₈alkyleneoxyC₁-C₈alkoxy is C₁-C₆alkyleneoxyC₁-C₆alkoxy, e.g. C₁-C₄alkyleneoxyC₁-C₄alkoxy such as C₁-C₂alkyleneoxyC₁-C₂alkoxy. In some cases, the C₁-C₈alkyl is C₁-C₆alkyl, such as C₁-C₄alkyl. Sometimes, the C₁-C₄alkoxy is C₁-C₂alkoxy. In some embodiments, R^{A} is selected from the group consisting of H, C₁-C₄alkoxy, fluoro, C₁-C₂alkyleneoxyC₁-C₂alkoxy, C₁-C₄alkyl, phenyl and nitro. In particular embodiments, R^{A} is selected from the group consisting of H, methoxy and fluoro.

Where a phenyl herein is optionally substituted, it may be substituted with any substituent provided that the substituent does not have a detrimental effect on the ability of the compound to act as a plant growth promoter. Often, an optionally substituted phenyl is either unsubstituted or substituted with one or more substituents selected from the group consisting of C₁-C₈alkyl, C₁-C₄alkoxy, halo (such as fluoro), C₁-C₈alkyleneoxyC₁-C₈alkoxy and nitro. Sometimes, the C₁-C₈alkyleneoxyC₁-C₈alkoxy is C₁-C₆alkyleneoxyC₁-C₆alkoxy, e.g. C₁-C₄alkyleneoxyC₁-C₄alkoxy such as C₁-C₂alkyleneoxyC₁-C₂alkoxy. In some cases, the C₁-C₈alkyl is C₁-C₆alkyl, such as C₁-C₄alkyl. Sometimes, the C₁-C₄alkoxy is C₁-C₂alkoxy. Often, an optionally substituted phenyl is either unsubstituted or substituted with one or more substituents selected from the group consisting of C₁-C₄alkyl, C₁-C₄alkoxy, fluoro, C₁-C₄alkyleneoxyC₁-C₄alkoxy and nitro. Typically, an optionally substituted phenyl is unsubstituted.

Often, at least one of R, R¹ and R^{A} is H. Sometimes, at least one of R and R¹ is H. In some embodiments, at least two of R, R¹ and R^{A} are H.

In some embodiments, R^{A} is H. In particular embodiments, R^{A} is H and R and R¹ are each independently selected from the group consisting of H, C₁-C₈alkyleneoxyC₁-C₈alkoxy, C₁-C₈alkyl and C₁-C₄alkoxy. In some embodiments, R^{A} is H and R and R¹ are each independently selected from the group consisting of H, ethoxyethoxy, methyl, ethyl, n-propyl and methoxy, such as H, ethoxyethoxy and methoxy.

R and R¹ of formula (IA) are each independently selected from the group consisting of H, C₁-C₈alkyleneoxyC₁-C₈alkoxy, C₁-C₈alkyl and C₁-C₈alkoxy. In some embodiments, the C₁-C₈alkyleneoxyC₁-C₈alkoxy is C₁-C₄alkyleneoxyC₁-C₄alkoxy, often C₁-C₂alkyleneoxyC₁-C₂alkoxy such as ethoxyethoxy. In some embodiments, the C₁-C₈alkyl is C₁-C₆alkyl such as C₁-C₄alkyl. In some embodiments, the C₁-C₈alkoxy is C₁-C₆alkoxy such as C₁-C₄alkoxy. Often, R and R¹ are each independently selected from the group consisting of H, C₁-C₂alkyleneoxyC₁-C₂alkoxy, C₁-C₄alkyl and C₁-C₄alkoxy. For example, R and R¹ may be independently selected from the group consisting of H, ethoxyethoxy, methyl, ethyl, n-propyl and methoxy.

In some embodiments, when R of formula (IA) is selected from the group consisting of ethoxyethoxy, C₁-C₄ alkyl and C₁-C₄ alkoxy, R¹ is H. In other words, at least one of R and R¹ is H.

In some embodiments, R of formula (IA) is H, ethoxyethoxy, or C₁-C₄ alkoxy, for example R may be selected from the group consisting of H, ethoxyethoxy, methoxy, ethoxy or n-propoxy. In some embodiments, R is H, ethoxyethoxy, methoxy or ethoxy, such as H, ethoxyethoxy or methoxy.

In some embodiments, R¹ of formula (IA) is H, ethoxyethoxy, C₁-C₃alkyl or C₁-C₃alkoxy, for example R¹ may be selected from the group consisting of H, ethoxyethoxy, methyl, ethyl, n-propyl, methoxy, ethoxy or n-propoxy. In some embodiments, R¹ is H, ethoxyethoxy, methyl, ethyl, n-propyl, methoxy or ethoxy, such as H, ethoxyethoxy, methyl, ethyl, n-propyl or methoxy.

R² is H, C₁-C₄alkyl or of formula (II):

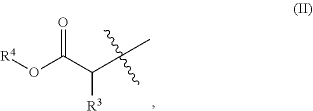

wherein R₃ and R₄ are each H or C₁-C₄alkyl.

In some embodiments, R² is selected from the group consisting of H, methyl, ethyl, n-propyl, n-butyl, iso-propyl and formula (II). For example, R² may be selected from the group consisting of H, methyl, ethyl, n-propyl, n-butyl and formula (II). In some embodiments, R² is selected from the group consisting of H, methyl, ethyl and formula (II). In some embodiments, R² is H, methyl or of formula (II).

In some embodiments, R³ of formula (II) is H, methyl, ethyl, n-propyl or iso-propyl. For example, R³ of formula (II) may be H, methyl or ethyl. In some embodiments, R³ of formula (II) is H or methyl, often H.

In some embodiments, R⁴ of formula (II) is ethyl, methyl, n-propyl or iso-propyl. For example, R⁴ of formula (II) may be ethyl or methyl. Sometimes, R⁴ is ethyl.

Sometimes, R⁴ is ethyl and R³ is methyl or H.

In some embodiments, R² is not of formula (II). For example, R² is H or methyl.

The compound of formula (IA) may have a structure represented by any one of formulae (Ia) to (Ip):

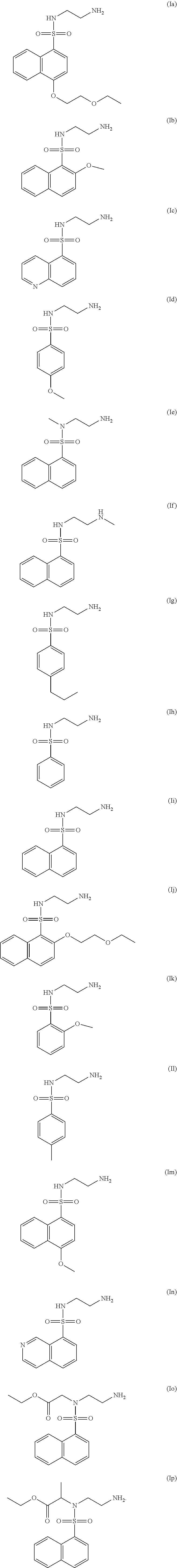

Sometimes, the compound of formula (IA) has the structure represented by any one of formulae (Ia) to (II). For example, the compound of formula (I) may have the structure represented by any one of formulae (Ia) to (Ih).

In some embodiments, the compound of formula (I) is any one of formulae (Ia) to (Iz):

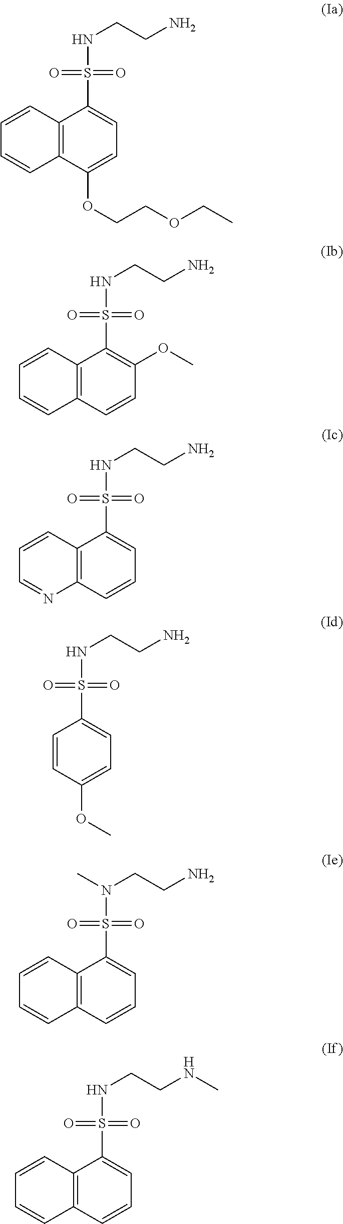

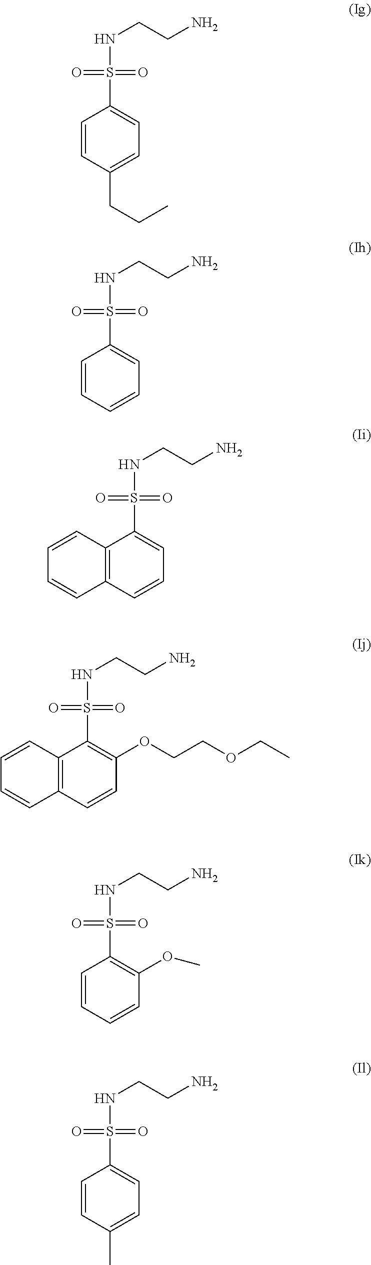

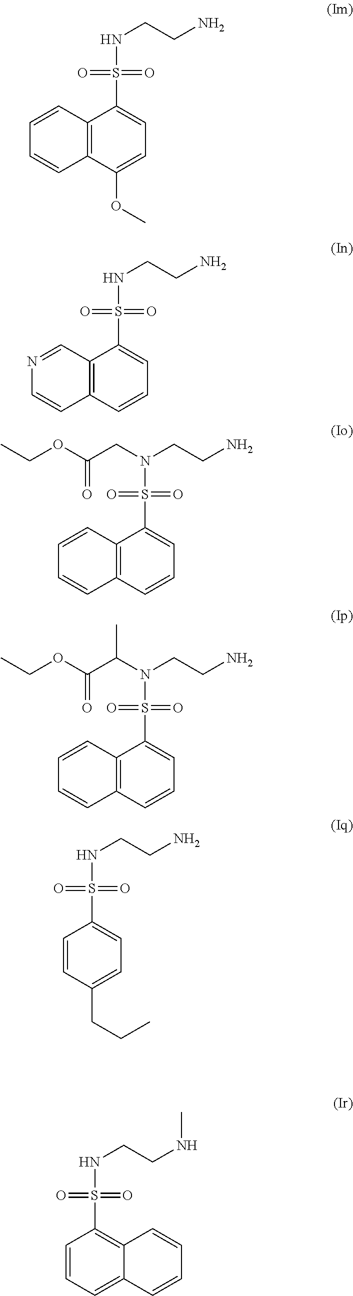

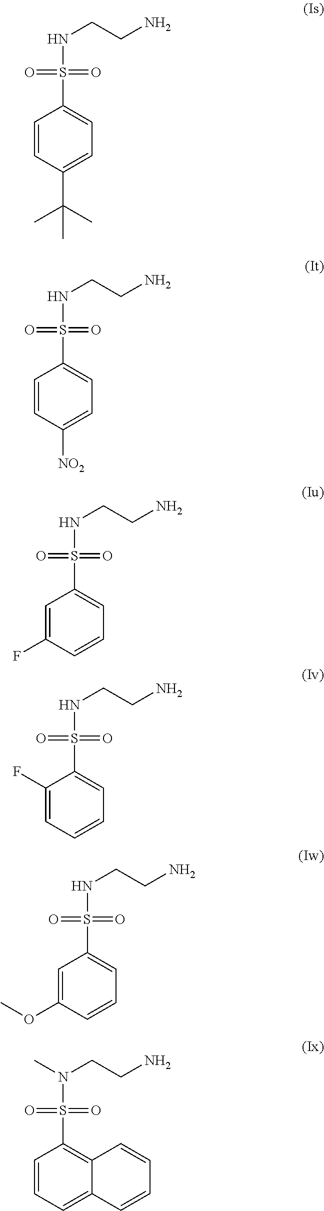

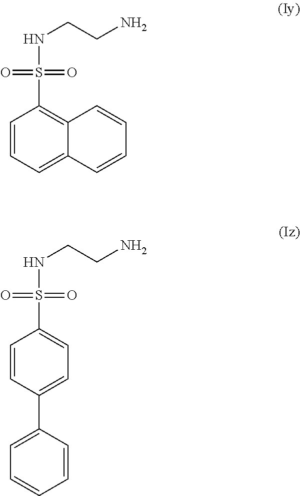 [SMILES: NCCNS(=O)(=O)c1cccc2ccccc12 ; NCCNS(=O)(=O)c1ccc(-c2ccccc2)cc1]

In some embodiments, the compound of formula (I) is any one of formulae (Ia) to (Ip).

In specific embodiments, the compound of formula (I) is not of formula (II), i.e. the compound is not:

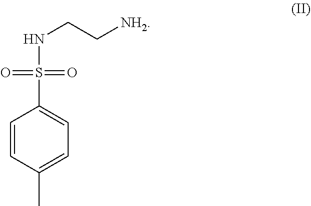

The compounds described herein may form a salt derived from the compound and an acid. For example, reaction of a compound of formula (I) with phosphoric acid may form a salt comprising a protonated compound of formula (I) (e.g. protonated at X to form —[NH₃]⁺ or —[NH₂(C₁-C₄alkyl)]⁺) and a phosphate ([H₂PO₄]⁻). For the avoidance of doubt, salts derived from a compound of formula (I) and an acid are within the scope of this disclosure, i.e. a compound of formula (I) or a salt thereof is provided.

The compounds disclosed herein may be used as the corresponding ammonium salt. Such a salt may be prepared by treatment of the compound with a suitable acid. Suitable acids include Generally Recognised As Safe (GRAS) acids listed in the Select Committee on GRAS substances (SCOGS) database (see https://www.cfsanappsexternal.fda.goviscripts/fdcc/?set=SCOGS, as available on 11 Nov. 2020). A non-exclusive list of acids includes phosphoric acid, hydrogen chloride, hydrogen bromide, sulfuric acid, acetic acid, trifluoroacetic acid, propionic acid, glycolic acid, maleic acid, malonic acid, toluenesulfonic acid, methanesulfonic acid, fumaric acid, succinic acid, tartaric acid, citric acid, benzoic acid and ascorbic acid.

Also included are solvates and isotopically-labelled compounds of formula (I). Isotopically-labelled compounds are identical to those disclosed herein, but for the fact that one or more atoms are replaced by an atom having an atomic mass or mass number that is different from the atomic mass or mass number predominantly found in nature. Examples of isotopes that can be incorporated into compounds of the invention include isotopes of hydrogen, carbon, nitrogen, oxygen and sulfur, such as ²H, ³H, ¹³C, ¹⁴C, ¹⁵N, ¹⁸O, ¹⁷O, and ³⁵S, respectively.

As described above, the present inventors have found that compounds of formula (I) are surprisingly effective plant growth promotors. Where plant growth is promoted, ensuring that the plant has access to the nutrients required for growth is likely to be beneficial.

Where growth material, e.g. soil, is lacking in such nutrients, it may be advantageous to provide a fertiliser. Accordingly, provided herein is a composition comprising any one or a selection of compounds of formula (I) (including salts, solvates or isotopically-labelled compounds of formula (I)) and a fertiliser.

Fertilisers typically comprise one or more nutrients from the group consisting of nitrogen, phosphorus, potassium, calcium, magnesium, sulfur, copper, iron, manganese, molybdenum, zinc and boron. Sometimes, fertilisers contain one or more of silicon, cobalt, and vanadium. In some embodiments, the fertiliser of the composition comprises any one or a combination of urea, urea ammonium nitrate, urea ammonium phosphate, urea phosphate, ammonium nitrate, ammonium sulfate, ammonium phosphate sulfate, ammonium nitrate phosphate, ammonium phosphate sulfate nitrate, nitrophosphate, potassium sulphate, potassium schoenite (K₂Mg(SO₄)₂.6(H₂O)), ammonium chloride, calcium ammonium nitrate, ammonia, calcium nitrate, diammonium phosphate, monoammonium phosphate, potassium phosphate, diphosphorus pentoxide, potassium nitrate, potassium chloride, sulfur, zinc sulphate heptahydrate (ZnSO₄.7H₂O), manganese sulphate, borax (sodium tetraborate), copper sulphate, ferrous sulphate, ammonium molybdate, Zn-EDTA, Fe-EDTA, zinc sulphate mono-hydrate (ZnSO₄.H₂O), magnesium sulphate, boric acid, di-sodium octaborate tetrahydrate, di-sodium tetraborate pentahydrate, zinc oxide, zincated urea, zincated phosphate and potassium magnesium sulphate.

The compound of formula (I) (including salts, solvates or isotopically-labelled compounds of formula (I)) within the composition may be a solid, e.g. in a powder or crystalline form. Sometimes, to increase stability of the compound, it may be freeze-dried or spray-dried before incorporation into the composition. Freeze-drying a compound involves freezing the compound in the presence of solvent and separating the solvent from the compound by sublimation. Spray-drying a compound involves introducing a solution of the compound into an atomizer, which breaks up the solution into a spray of fine droplets. The droplets are ejected into a drying gas chamber where moisture vaporisation occurs, resulting in the formation of dry particles. Finally, the dried particles are separated from the drying medium. For a review of spray-drying see D. Santos et al., Biomaterials—Physics and Chemistry—New Edition, Chapter 2, 9-35 (2018).

The composition may be a solid, e.g. in a powder or crystalline form. Alternatively, the composition may be a solution or a suspension comprising a solvent, such as water.

The compounds of formula (I) (including salts, solvates or isotopically-labelled compounds of formula (I)) or the composition disclosed herein may be stored in any suitable container. As described above, compounds of formula (I) are easier to store than GAs known to be useful in promoting plant growth, which are prone to degradation by sunlight or heat and are typically stored in cool, dry conditions within aluminium foil to protect them from sunlight. Accordingly, in another aspect, there is provided a container comprising a compound or selection of compounds of the first aspect or a composition of the second aspect, wherein the container is not protected from sunlight, i.e. sunlight is able to penetrate through the container—the container does not reflect or absorb sunlight. For example, the container does not comprise or is not surrounded by aluminium foil or is not a UV or amber glass container.

The compounds of formula (I) (including salts, solvates or isotopically-labelled compounds of formula (I)) or the composition disclosed herein may be stored in a container adapted to prevent penetration of ultraviolet light. The container may be airtight and the compound or composition may be stored under an inert atmosphere, such as under nitrogen or argon, typically nitrogen. The compound or composition may be stored at room temperature, e.g. at about 20° C. Alternatively, it may be stored at temperatures lower than room temperature, e.g. in a refrigerator or freezer.

Provided herein is the use of any one or a selection of compounds of formula (I) (including salts, solvates or isotopically-labelled compounds of formula (I)) as a plant growth promoter. Also provided herein is the use of the composition disclosed herein as a plant growth promoter. For the avoidance of doubt, the embodiments of the first and second aspects apply mutatis mutandis to this aspect. As described above, plant growth promoters are used to increase the rate of growth of any part of a plant relative to the normal rate of plant growth (normal being the rate of plant growth under the same conditions, absent the growth promoter). In some embodiments, the use of any one or a selection of compounds or composition disclosed herein is as a stem or leaf growth promoter. In some embodiments, the use is as a root growth promoter. As mentioned above, the inventors have found that when Z is —(CH₂)ₙ— and n is 1, the resultant compounds are particularly useful in root growth. Thus, in some embodiments, the use of any one or a selection of compounds of formula (I), wherein Z is —(CH₂)ₙ— and n is 1 as a root growth promoter is provided. Sometimes, the use of any one or a selection of compounds or composition disclosed herein is as a root or hypocotyl growth promoter. Sometimes, the use is as a plant growth promoter in wet growing conditions, in which the amount of water available to the plant is sufficient, and water is not a limiting factor in plant growth.

In some cases, the compound of formula (I) increases plant growth by a factor of at least 1.2. In some cases, the compound of formula (I) increases plant growth by a factor of at least 1.4.

Also provided herein is a plant, seed, bulb or tuber comprising a compound or selection of compounds of formula (I) or a composition comprising any one or a selection of compounds of formula (I) and a fertiliser. The plant, seed, bulb or tuber may be coated with the compound(s) or composition and/or the compound(s) or composition may be contained within the plant, seed, bulb or tuber. The plant, seed, bulb or tuber comprising the compound(s) or composition may be prepared using any of the methods described below.

A method of promoting plant growth is provided comprising contacting a plant, seed, bulb or tuber with a compound or selection of compounds of formula (I) (including salts, solvates or isotopically-labelled compounds of formula (I)) or the composition disclosed herein. For the avoidance of doubt, the embodiments of the first, second and third aspects apply mutatis mutandis to this aspect. For example, the plant growth may be root or hypocotyl growth.

It will be understood that the contacting of the method may be achieved in a variety of ways. For example, the compound or selection of compounds of formula (I) or composition may be spread onto the plant growth medium (e.g. soil) and contacted with the plant, seed, bulb or tuber by absorption into the plant or seed. Alternatively, the compound of formula (I) or composition may be placed directly onto the plant, seed, bulb or tuber either when the plant, seed, bulb or tuber is on or in the growth medium, or before the plant, seed, bulb or tuber is planted.

In some embodiments, the compound or selection of compounds or composition of the invention is diluted with solvent, such as water, prior to contacting with the plant, seed, bulb or tuber. The diluting with solvent comprises contacting the compound or selection of compounds or composition of the invention with solvent. When the compound or selection of compounds or composition of the invention is a solid, e.g. in a powder or crystalline form, it may be diluted with solvent to form a solution or suspension. When the composition is a solution or a suspension comprising a solvent, it may be diluted to produce a less concentrated solution or suspension. In some cases, where the composition is a suspension comprising a solvent, it may be diluted to produce a solution.

In some embodiments, the compound or selection of compounds of formula (I) are present at a concentration of about 20 to about 200 μM. In these embodiments, where a selection of compounds of formula (I) is used, the total concentration of all compounds of formula (I) is within the concentration range specified, i.e. about 20 to about 200 μM. In some embodiments, the concentration of compound or selection of compounds of formula (I) is about 50 to about 150 μM, such as about 70 to about 130 μM or about 80 to about 120 μM. In some embodiments, the concentration of compound or selection of compounds of formula (I) is about 90 to about 110 μM. For example, the concentration of compound or selection of compounds of formula (I) may be about 100 μM.

In some embodiments, the method comprises contacting a seed with a mixture comprising a compound or selection of compounds of formula (I) (including salts, solvates or isotopically-labelled compounds of formula (I)) or the composition disclosed herein, and a solvent, which is typically water.

The contacting of the method may be achieved in a variety of ways. For example, the compound or selection of compounds of formula (I) or composition may be mixed with water to produce a solution or suspension, which may then be spread onto the plant growth medium (e.g. soil) and contacted with the seed by absorption into the seed. Alternatively, the solution or suspension may be placed directly onto the seed, either when the seed is on or in the growth medium, or before the seed is planted.

In some embodiments, the seed is soaked in the solution or suspension before it is planted. Optimum soaking time depends on the type of seed, specifically on the thickness of the seed coat. In some embodiments, the seed is soaked for about 30 minutes to about 24 hours, such as about 1 to about 18 hours or about 16 to about 24 hours.

In some embodiments, the method further comprises drying the seed. Often, where the seed has been soaked in the solution or suspension, it is then dried before it is planted.

Drying may be achieved in any suitable way, i.e. any way that does not risk damage to the seed. For example, the seed may be air dried, dried under vacuum, or dried at elevated temperatures (i.e. heat may be applied to dry the seed). Any drying methods that reduce the amount of compound or selection of compounds of formula (I) or composition on or within the seed, such as blotting the seed with absorbent material, may be avoided.

Also provided herein is a plant, seed, bulb or tuber obtainable by any one of the methods described above. The term “obtainable” includes within its ambit the term “obtained”, thus in some embodiments, the plant, seed, bulb or tuber is obtained by any one of the methods described.

Each and every reference referred to herein is hereby incorporated by reference in its entirety, as if the entire content of each reference was set forth herein in its entirety.

Described herein are the following clauses:

C1. A compound of formula (I):

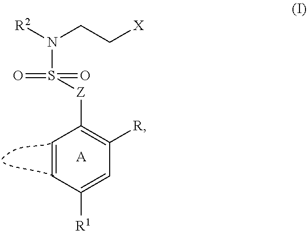

wherein A is a 6-membered monocyclic aryl or heteroaryl or a polycyclic aryl or heteroaryl,
X is NH₂ or NH(C₁-C₄alkyl),
Z is —(CH₂)ₙ— or —O(CH₂)ₙ—, wherein n is 0 or 1,
R and R¹ are each independently selected from the group consisting of H, C₁-C₈alkyleneoxyC₁-C₈alkoxy, C₁-C₈alkyl and C₁-C₈alkoxy,
R² is H, C₁-C₄alkyl or of formula (II):

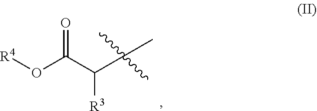

wherein R₃ and R₄ are each H or C₁-C₄alkyl.

C2. The compound of clause C1, wherein the polycyclic aryl is a 10-membered bicyclic aryl or heteroaryl.

C3. The compound of clause C1, wherein A is a benzene, naphthalene or benzopyridine ring.

C4. The compound of clause C3, wherein benzopyridine is 2,3-benzopyridine.

C5. The compound of any one preceding clause, wherein Z is —(CH₂)₀— or Z is —O(CH₂)₁—.

C6. The compound of any one of clauses C1 to C4, wherein Z is —(CH₂)₀—.

C7. The compound of any one preceding clause, wherein X is NH₂ or NHCH₃.

C8. The compound of any one preceding clause, wherein when R is selected from the group consisting of C₁-C₈alkyleneoxyC₁-C₈alkoxy, C₁-C₈alkyl and C₁-C₈alkoxy, R¹ is H.

C9. The compound of any one preceding clause, wherein R and R¹ are each independently selected from the group consisting of H, C₁-C₂alkyleneoxyC₁-C₂alkoxy, C₁-C₄alkyl and C₁-C₄alkoxy.

C10. The compound of any one of clauses C1 to C8, wherein R and R¹ are each independently selected from the group consisting of H, ethoxyethoxy, methyl, ethyl, n-propyl and methoxy.

C11. The compound of any one preceding clause, wherein R is selected from the group consisting of H, ethoxyethoxy and methoxy.

C12. The compound of any one preceding clause, wherein R² is H, methyl or of formula (II).

C13. The compound of any one preceding clause, wherein R³ is H or methyl.

C14. The compound of any one of clauses C1 to C12, wherein R³ is H.

C_{15.} The compound of any one preceding clause, wherein R⁴ is methyl or ethyl.

C16. The compound of any one of clauses C1 to C14, wherein R⁴ is ethyl.

C17. The compound of clause C1, which is any one of formula (Ia) to (Ip):

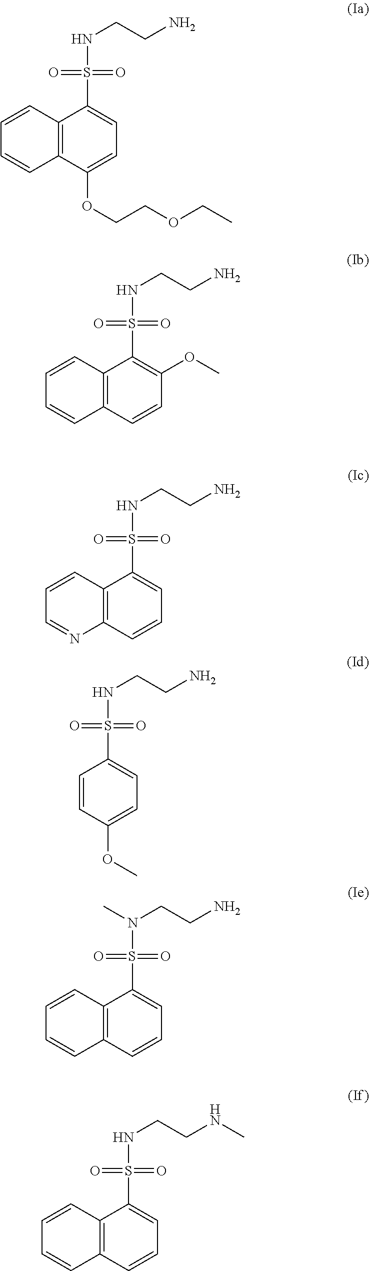

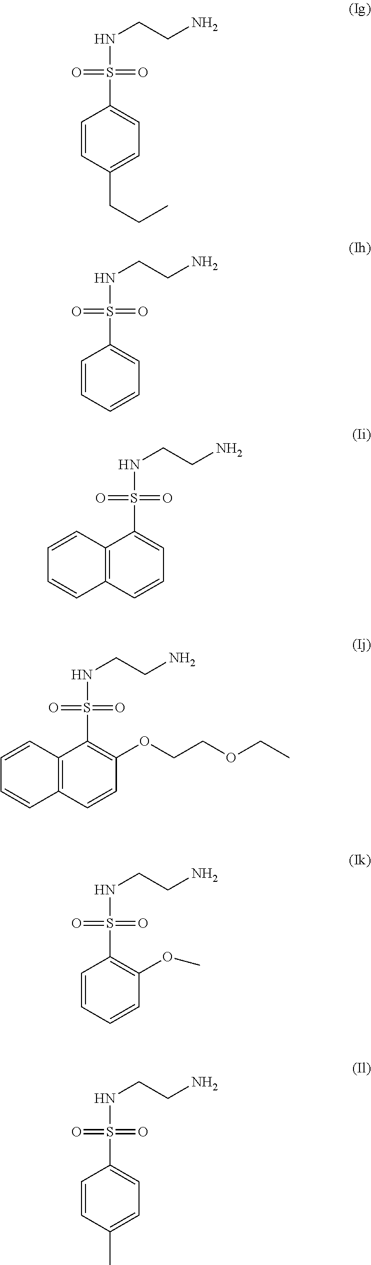

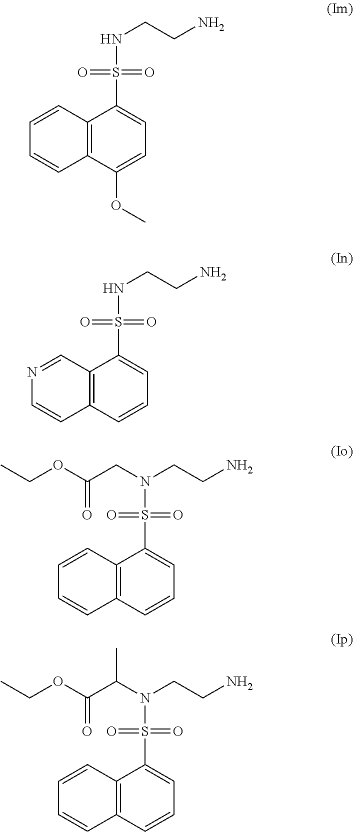

C18. A composition comprising any one or a selection of compounds of any one preceding clause and a fertiliser.

C19. Use of a compound or selection of compounds of any one of clauses C1 to C17 or a composition of clause C18 as a plant growth promoter.

C20. A plant, seed, bulb or tuber comprising a compound or selection of compounds of any one of clauses C1 to C17 or a composition of clause C18.

C21. A method of promoting plant growth comprising contacting a plant, seed, bulb or tuber with a compound or selection of compounds of any one of clauses C1 to C17 or a composition of clause C18.

C22. The method of clause C21, wherein the compound or selection of compounds is at a concentration of about 20 to 200 μM.

C23. The method of clause C21 or C22, comprising contacting a seed with a mixture comprising a compound or selection of compounds of any one of clauses C1 to C17 or a composition of clause C18 and a solvent.

C24. The method of clause C23, further comprising drying the seed.

C25. A plant, bulb or tuber obtainable by the method of clause C21 or clause C22 or a seed obtainable by the method of any one of clauses C21 to C24.

The invention may be further understood with reference to the examples, below.

### EXAMPLES

### Chemicals

All chemicals were purchased from commercial suppliers and were used without further purification unless otherwise stated.

### TLC

TLC analysis was performed on a pre-coated aluminium-backed plate (Silica gel 60 F254, Merck). Signals were visualized with UV-light (254 nm and 36 nm) or by staining with potassium permanganate in water where necessary.

### Column Chromatography

Flash column chromatography was performed on a CombiFlash System from Teledyne Isco equipped with an UV-light detector using prepacked silica RediSep Rf cartridges with the stated solvent gradient. Crude mixture to be purified were dried loaded onto silica prior loading on the column.

### Elemental Analysis

CHN analysis were conducted on an Exeter CE-440 Elemental Analyser. The elemental characterization of the product was confirmed upon ±0.4% of the result.

### LC-MS

LC-MS analysis were conducted using a TQD mass spectrometer (Waters Ltd, UK) which equipped with an Acquity UPLC, using Acquity UPLC BEH C18 1.7 μm (2.1 mm×50 mm) column, and an electrospray ion source. Absorbance data were acquired from 210 to 400 nm using an Acquity photodiode array detector.

### HRMS

The analysis were carried out using QToF Premier mass spectrometer (Waters Ltd, UK) with an electrospray ion source.

### IR Spectroscopy

IR spectra were recorded on a Perkin-Elmer RX I FT-IR spectrometer via use of a Diamond ATR accessory (Golden Gate) in the range of 3500-600 cm⁻¹. Assigned peaks are recorded in wavenumber (cm⁻¹).

### Melting Points

Melting points were measured in open capillary tubes using a Thermo Scientific Melting Point Apparatus and are uncorrected.

### NMR-Spectroscopy

NMR-spectra were recorded from CDCl₃ or D₂O solutions on a Bruker Advance-400 (400 MHz) spectrometer. Chemical shift values are reported in parts per million (ppm) and coupling constant (J) are given in Hertz (Hz). The multiplicity is indicated by singlet (s), doublet (d), triplet (t), quartet (q), broad (br) or a combination thereof.

2′-Amino-1′-(1-naphthylsulfonylamino)Ethane Hydrochloric Acid Salt (2, A1 or eW5)

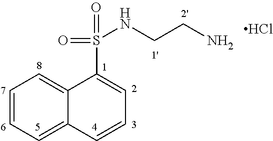 [SMILES: NCCNS(=O)(=O)c1cccc2ccccc12 ; Cl]

Naphthalene sulfonylchloride (1.00 g, 4.41 mmol) was dissolved in 15 mL of dry DCM and added dropwise to a solution of ethylene diamine (5.9 mL, 88.2 mmol, 20 equiv) in 10 mL of dry DCM. After stirring at room temperature for 1 h, the reaction was quenched by addition of 10 mL of H₂O. The mixture was extracted with DCM (3×10 mL) and the combined organic layers were dried over MgSO₄. The mixture was concentrated to afford a crude product as a light yellow oil (0.88 g, 80%). Without further purification this product (0.88 g, 3.5 mmol) was dissolved in 10 mL of dry DCM and added to a solution of di-tert-butyl dicarbonate (1.08 g, 4.94 mmol, 1.4 equiv) in 10 mL of dry DCM. The mixture was stirred at room temperature for 16 h when TLC analysis confirmed complete consumption of the amine. The reaction was then quenched with 10 mL of H₂O and the reaction mixture extracted with DCM (3×10 mL). The combined organic layers were dried over MgSO₄, concentrated to afford a white powder (1.15 g, 94%). Without further purification, this product (0.65 g, 1.8 mmol) was dissolved in 10 mL of dry DCM and HCl (1 mL of a 4.0M solution in dioxane (excess)) added. The mixture was then stirred at room temperature for 16 h when TLC analysis (hexane:ethyl acetate, 2:1) showed complete consumption of starting material. After concentrating under vacuum, the solid obtained was washed with diethyl ether, filtered and dried under vacuum overnight to afford the title salt as a white solid (0.92g, 65%). M.p: 178.8-179.3, V⁻ₘₐₓ (ATR): (N—H): 3022, 1154, 1130, 1021, 777 cm⁻¹. δ_{H} (400 MHz, D₂O): 8.55 (d, 1H, J=8.0 Hz, Ar—H), 8.28 (d, 1H, J=7.8 Hz, Ar—H), 8.25 (d, 1H, J=7.8 Hz, Ar—H), 8.13 (d, 1H, J=8.0 Hz, Ar—H), 7.81 (t, 1H, J=8.0 Hz, Ar—H), 7.74 (t, 1H, J=8.0Hz, Ar—H), 7.68 (t, 1H, J=7.8 Hz, 3-H), 3.15 (m, 2H, CH₂), 3.10 (m, 2H, CH₂). δ_{C} (D₂O, 400 MHz): 135.3 (C—Ar), 134.1 (C—Ar), 132.1 (C—Ar), 129.9 (C—Ar), 129.5 (C—Ar), 128.8 (C—Ar), 127.3 (C—Ar), 127.1 (C—Ar), 124.4 (C-3), 123.2 (C—Ar), 39.8 (CH₂), 39.14 (CH₂). LRMS (ES+): m/z 251 (M+H), HRMS (ASAP⁺): Found M+H, 251.0854, C₁₂H₁₅N₂O₂S, requires M 251.0856. Elemental analysis: Calculated for C₁₂H₁₅ClN₂O₂S C, 50.26; H, 5.27; N, 9.77. Measured C, 50.32; H, 5.27; N, 9.69.

5-chloro-naphthalenesulfonic Acid

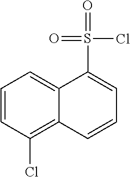 [SMILES: O=S(=O)(Cl)c1cccc2c(Cl)cccc12]

5-amino-naphthalenesulfonic acid (10 g, 44.8 mmol) was added to 0.55 M sodium hydroxide solution (0.96 equiv.). 40 mL (0.45 mL/mmol sulfonic acid) of 6M aqueous hydrochloric acid was then added at room temperature. The resulting mixture was cooled to below 2° C. and 7M aqueous sodium nitrite (1.09 equiv.) solution was added dropwise maintaining the temperature below 2° C. The mixture was stirred for a further 30 minutes at this temperature. Urea (0.13 equiv.) was then added. The mixture was then added to freshly prepared and heated (80° C.) copper chloride (CuCl) solution (1 equiv) in 20 mL of 6M HCl. After stirring the mixture at 80° C. for 1 h, it was cooled to room temperature and concentrated in vacuo. The product was washed with hexane and then dried in a vacuum dessicator overnight to afford the title sulfonic acid as a grey solid (9.8 g, 91.2%). V⁻ₘₐₓ (ATR): (O—H): 3591, 1373. LRMS (ES⁺): m/z 241 ((M+H), ³⁵Cl), 243 ((M+H), ³⁷Cl).

5-chloronaphthalenesulfonylchloride (1)

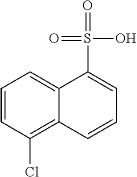 [SMILES: O=S(=O)(O)c1cccc2c(Cl)cccc12]

5-chloronaphthalenesulfonic acid (3 g, 12.39 mmol) was dissolved in excess thionyl chloride (60 mL). Dimethyl formamide (1.8 mL) was added and the mixture then heated under reflux for 2 hours. Upon cooling, the mixture was added to an excess ice and the product extracted with DCM (3×10 mL). The combined organic extracts were dried over MgSO₄ and concentrated to give the title sulfonyl chloride as a brownish yellow solid (2.6 g, 81.6%). LRMS (ES⁺): m/z 261 ((M+H), ³⁵Cl), 263 ((M+H), ³⁷Cl).

5-chloro-1′-(1-naphthylsulfonylamino)-2′-amino ethane (3, AC1)

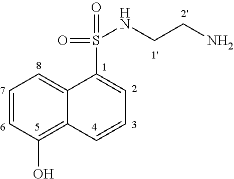 [SMILES: NCCNS(=O)(=O)c1cccc2c(O)cccc12]

Without further purification, Compound (1) (4.69 g, 18 mmol) was dissolved in dry DCM (40 mL) and added dropwise to a solution of ethylene diamine (20.06 mL, 360 mmol, 20 equiv.) in 30 mL dry DCM. The mixture was stirred at room temperature for 1h before being quenched with 15 mL H₂O. The reaction mixture was then extracted with DCM (3×10 mL) and the combined organic layers were dried over MgSO₄ and concentrated. Recrystallization from MeOH then afforded the title ethane as a light brown solid (1.64 g, 32%). M.p: 168.9-179.3, V⁻ₘₐₓ (ATR): (N—H): 3350, 1306, 1131, 1102, 784 cm⁻¹. δ_{H} (400 MHz, d⁶-DMSO): 8.68 (d, 1H, J=8.0 Hz, Ar—H), 8.50 (d, 1H, J=7.9 Hz, Ar—H), 8.24 (d, 1H, J=7.9 Hz, Ar—H), 7.87 (d, 1H, J=8.0 Hz, Ar—H), 7.82 (t, 1H, J=7.9 Hz, Ar—H), 7.70 (t, 1H, J=8.0 Hz, Ar—H), 2.76 (t, 2H, J=6.5 Hz, CH₂), 2.43 (t, 2H, J=6.5 Hz, CH₂). δ_{C} (d⁶-DMSO, 400 MHz): 136.6 (C—Ar), 131.5 (C—Ar), 130.7 (C—Ar), 129.4 (C—Ar), 129.1 (C—Ar), 129.0 (C—Ar), 128.0 (C—Ar), 127.5 (C—Ar), 126.3 (C—Ar), 124.3 (C—Ar), 46.1 (CH₂), 41.4 (CH₂). LRMS (ESI+): m/z 285 ((M+H), ³⁵Cl), 287 ((M+H), ³⁷Cl). HRMS (ASAP⁺): Found M+H, 285.0465, C₁₂H₁₄N₂O₂S³⁵Cl, requires M 285.0459. Elemental analysis: Calculated for C₁₂H₁₃ClN₂O₂S; C, 50.62; H, 4.60; N, 9.84. Measured C, 50.56; H, 4.61; N, 9.75.

N-[(napthylsulfonylamino)ethyl]-propanamide (4, A2)

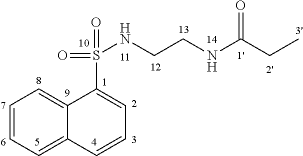 [SMILES: CCC(=O)NCCNS(=O)(=O)c1cccc2ccccc12]

2′-Amino-1′-(1-naphthylsulfonylamino)ethane was prepared as described above. Without further purification, the crude product (1.6 g, 6.4 mmol) was dissolved in dry DCM (20 mL) before added dropwise to a solution of propionic anhydride (0.82 mL, 6.4 mmol, 1 equiv) and triethylamine (2.23 mL, 16.0 mmol 2.5 equiv) in dry DCM (5 mL). The reaction was stirred for 16h at room temperature when it was quenched with H₂O (10 mL) and the reaction mixture extracted with DCM (3×10 mL). The combined organic layers were dried (MgSO₄) and concentrated. Flash column chromatography (hexane:EtOAc; 3:1) yielded the title amide as a white solid (1 g, 51%). M. p.: 118.1-118.8, V⁻ₘₐₓ (ATR): (N—H): 3393, 3044, 1742, 1618, 1540 cm⁻¹. δ_{H} (400 MHz, CDCl₃): 8.62 (d, 1H, J=8.0 Hz, Ar—H), 8.25 (d, 1H, J=7.7 Hz, Ar—H), 8.08 (d, 1H, J=7.7 Hz, Ar—H), 7.96 (d, 1H, J=8.0 Hz, Ar—H), 7.70 (t, 1H, J=8.0 Hz, Ar—H), 7.62 (t, 1H, J=8.0 Hz Ar—H), 7.55 (t, 1H, J=7.7 Hz, Ar—H), 5.71 (s, 1H, NH), 5.41 (s, 1H, NH), 3.30 (t, 2H, J=5.6 Hz, CH₂), 3.04 (t, 2H, J=5.6 Hz, CH₂), 2.03 (q, 2H, J=7.7 Hz, 2′-H), 1.04 (t, 3H, J=7.7 Hz, 3′-H). δ_{C} (CDCl₃, 400 MHz): 175.0 (C═O), 134.4 (C—Ar), 134.3 (C—Ar), 134.2 (C—Ar), 129.7 (C—Ar), 129.2 (C—Ar), 128.4 (C—Ar), 128.0 (C—Ar), 127.0 (C—Ar), 124.3 (C—Ar), 124.1 (C—Ar), 43.8 (CH₂), 39.3 (CH₂), 29.4 (C-2′), 9.80 (C-3′). LRMS (ES+): m/z 307 (M+H), HRMS (ASAP⁺): Found M+H 307.1116, C₁₅H₁₉N₂O₃S, requires M 307.1113. Elemental analysis: Calculated for C₁₅H₁₈N₂O₂S C, 58.80; H, 5.92; N, 9.14. Measured C, 58.69; H, 5.90; N, 9.07.

N-[(5-chloronapthylsulfonylamino)ethyl]-propanamide (5, AC₂)

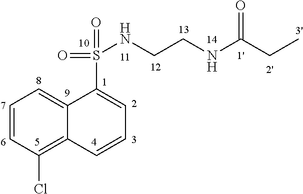 [SMILES: CCC(=O)NCCNS(=O)(=O)c1cccc2c(Cl)cccc12]

5-chloro-1′-(1-naphthylsulfonylamino)-2′-amino ethane (3) (2.25 g, 7.9 mmol) was dissolved in dry DCM (20 mL) and added to the a solution of propionic anhydride (1.01 mL, 7.9 mmol, 1 equiv) and triethylamine (2.76 mL, 19.81 mmol, 2.5 equiv) in dry DCM (5 mL). The solution was stirred at room temperature for 16 h and then quenched with H₂O (10 mL). The reaction mixture was extracted with DCM (3×10 mL) and the combined organic layers dried over MgSO₄ and concentrated. Flash column chromatography (hexane: EtOAc; 1:3) afforded the title amide as a light brown solid (1.62 g, 60%). M. p.: 145.9-146.6, V⁻ₘₐₓ (ATR): (N—H): 3414, 1746, 1621, 1539, 1320, 1138 cm⁻¹. δ_{H} (400 MHz, CDCl₃): 8.60 (d, 1H, J=4.6 Hz, Ar—H), 8.59 (d, 1H, J=4.6 Hz, Ar—H), 8.31 (d, 1H, J=7.5 Hz, Ar—H), 7.71 (d, 1H, J=7.5 Hz, Ar—H), 7.66 (t, 1H, J=7.5 Hz, Ar—H), 7.60 (t, J=4.6 Hz, Ar—H), 5.74 (s, 1H, NH), 5.62 (s, 1H, NH), 3.31 (t, 2H, J=5.5 Hz, CH₂), 3.04 (t, 2H, J=5.5 Hz, CH₂), 2.07 (q, 2H, J=7.6 Hz, 2′-/-1), 1.06 (t, 3H, J=7.6, 3′-H). δ_{C} (CDCl₃, 400 MHz): 174.8 (C═O), 134.4 (C—Ar), 134.2 (C—Ar), 129.7 (C—Ar), 129.1 (C—Ar), 128.5 (C—Ar), 128.0 (C—Ar), 126.9 (C—Ar), 124.2 (C—Ar), 124.1 (C—Ar), 43.6 (CH₂), 39.1 (CH₂), 30.9 (C-2′), 29.3 (C-3′). LRMS (ES⁺): m/z 341 ((M+H), ³⁵Cl), 343 ((M+H), ³⁷Cl) HRMS (ASAP⁺): Found M+H, 341.0718, C₁₅H₁₇N₂O₃S³⁵Cl, requires M 341.0715. Elemental analysis: Calculated for C₁₅H₁₇ClN₂O₂S C, 52.86; H, 5.03; N, 8.22. Measured C, 52.91; H, 5.03; N, 8.19.

N-propyl-N-naphthylsulfonyl-1,2-ethanediamine Hydrochloric Acid Salt (6, A3)

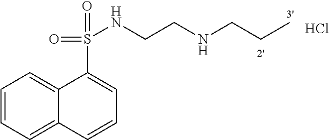 [SMILES: CCCNCCNS(=O)(=O)c1cccc2ccccc12 ; Cl]

Amide (4) (0.46 g, 1.50 mmol) was dissolved in dry THF (10 mL) and added to BH₃. THF (4.50 mL, 4.50 mmol, 3 equiv) solution. The mixture was stirred at 55-60° C. for 16 h when TLC analysis (DCM:MeOH; 9:1) showed complete consumption of starting material. The reaction was quenched by adding MeOH (1.3 mL) and the mixture heated under refluxed for 3 h. The mixture was then added to a solution of di-tert-butyl dicarbonate (0.46 g, 21 mmol, 1.4 equiv) in dry DCM (5 mL). The mixture was stirred at room temperature for 16 h and then quenched with H₂O. The mixture extracted with DCM (3×10 mL) and combined organic layers were dried over MgSO₄ and concentrated to give a white solid. Without further purification, this product (0.34, 0.86 mmol) was dissolved in dry DCM (5 mL) and 1 mL HCl in 4.0 dioxane (excess) was added. The mixture was stirred for 16 h at room temperature when TLC analysis (hexane: EtOAc; 2:1) showed complete consumption of starting material. After concentration in vacuo, the solid obtained was washed with diethyl ether and dried under vacuum to afford the title amine salt as a white solid product (0.11 g, 44%). M. p.: 159.5-159.9, V⁻ₘₐₓ (ATR): (N—H): 3142, 1315, 1169, 769 cm⁻¹. δ_{H} (400 MHz, D₂O): 8.56 (d, 1H, J=7.2 Hz, Ar—H), 8.30 (d, 1H, J=7.7, Ar—H), 8.27 (d, J=7.7 Hz, Ar—H), 8.14 (d, 1H, J=7.2 Hz, Ar—H), 7.82 (t, 1H, J=7.2 Hz, Ar—H), 7.75 (t, 1H, J=7.2 Hz, Ar—H), 7.69 (t, 1H, J=7.7 Hz, Ar—H), 3.20 (t, 2H, J=5.6, CH₂), 3.12 (t, 2H, J=5.6 Hz, CH₂), 2.94 (t, 2H, J=7.4 Hz, CH₂), 1.63 (sex, 2H, J=7.4 Hz, 2′-H), 0.93 (t, 3H, J=7.4, 3′-H). δ_{C} (D₂O, 400 MHz): 135.3 (C—Ar), 134.3 (C—Ar), 132.2 (C—Ar), 130.0 (C—Ar), 130.0 (C—Ar), 128.9 (C—Ar), 127.5 (C—Ar), 127.0 (C—Ar), 124.4 (C—Ar), 123.2 (C—Ar), 49.0 (CH₂), 46.5 (CH₂), 38.8 (CH₂), 18.9 (C-2′), 10.0 (C-3′). LRMS (ES⁺): m/z 293 (M+H). HRMS (ASAP⁺): Found M+H, 293.1324, C₁₅H₂₁N₂O₂S, requires M293.1307. Elemental analysis: Calculated C₁₅H₂₁ClN₂O₂S; C, 54.79; H, 6.44; N, 8.52. Measured C, 54.62; H, 6.44; N, 8.25.

N-propyl-5-Chloro-N-naphthylsulfonyl-1,2-ethanediaminehydrochloric Salt (7, AC₃)

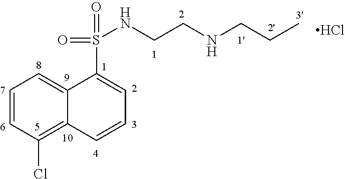 [SMILES: CCCNCCNS(=O)(=O)c1cccc2c(Cl)cccc12 ; Cl]

Amide 5 (0.7 g, 2.06 mmol) was dissolved in dry THF (15 mL) and added to borane BH₃. THF (6.18 mL, 6.18 mmol, 3 equiv) solution. The mixture was stirred at 55-60° C. for 16 hours when TLC analysis (DCM: MeOH; 9:1) showed the complete consumption of starting material. The reaction was quenched by adding MeOH (1.3 mL) and the mixture heated under refluxed for 3 h. The mixture was then added to a solution of di-tert-butyl dicarbonate (0.63 g, 2.88 mmol, 1.4 equiv.) in dry DCM (5 mL). The mixture was stirred at room temperature for 16 h and then quenched with H₂O (10 mL). The mixture was extracted with DCM (3×10 mL) and the combined organic layers were dried over MgSO₄ and concentrated. Without further purification, this product (0.5 g, 1.17 mmol) was dissolved in dry DCM (5 mL). 1 mL of HCl in 4.0M dioxane (excess) was added. The mixture was stirred for 16 h at room temperature when TLC analysis (DCM; MeOH; 9:1) showed the complete consumption of starting material. After concentrating in vacuo, the product obtained was washed with diethyl ether and dried under vacuum to afford the title amine as a white solid (0.35 g, 83%). M. p.: 178.9-179.6, V⁻ₘₐₓ (ATR): (N—H): 2968, 1742, 1328, 1135, 1010, 786 cm⁻¹. δ_{H} (400 MHz, D₂O): 8.60 (d, 1H, J=8.2 Hz, Ar—H), 8.47 (d, 1H, J=8.1 Hz, Ar—H), 8.29 (d, 1H, J=8.2 Hz, Ar—H), 7.80 (d, 1H, J=8.1 Hz, Ar—H), 7.73 (t, 1H, J=8.2 Hz, Ar—H), 7.68 (t, 1H, J=8.1 Hz, Ar—H), 3.18 (t, 2H, J=5.6, CH₂), 3.12 (t, 2H, J=5.6 Hz, CH₂), 2.95 (t, 2H, J=7.4 Hz, CH₂), 1.64 (sex, 2H, J=7.4 Hz, 2′-H), 0.94 (t, 3H, J=7.4 Hz, 3′-H). δ_{C} (D₂O, 400 MHz): 132.7 (C—Ar), 132.6 (C—Ar), 131.2 (C—Ar), 131.1 (C—Ar), 130.5 (C—Ar), 128.6 (C—Ar), 128.4 (C—Ar), 127.7 (C—Ar), 125.5 (C—Ar), 122.6 (C—Ar), 49.0 (CH₂), 46.5 (CH₂), 38.6 (CH₂), 18.7 (C-2′), 9.9 (C-3′). LRMS (ES+): m/z 327 ((M+H), ³⁵Cl), 329 ((M+H), ³⁷Cl), HRMS (ASAP⁺): Found M+H, 327.0934, C₁₅H₂₀N₂O₂S³⁵Cl, requires M 327.0936. Elemental analysis: Calculated for C₁₅H₂₀Cl₂N₂O₂S; C, 49.59; H, 5.55; N, 7.71. Measured C, 49.25; H, 5.62; N, 7.84.

(1-Na phthylsulfonyl)hexylamine (8, A4)

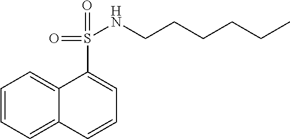 [SMILES: CCCCCCNS(=O)(=O)c1cccc2ccccc12]

Naphthalenesulfonamide (1 g, 3.85 mmol) was dissolved in dry DCM (15 mL) and added dropwise to a solution of hexylamine (0.76 mL, 5.77 mmol, 1.5 equiv) and triethylamine (1.34 mL, 9.63 mmol, 2.5 equiv) in dry DCM (15 mL) at 0° C. The reaction was stirred at room temperature for 1 h and then quenched with 10 mL of H₂O. The mixture was extracted with DCM (3×10 mL) and combined organic layers dried over MgSO₄ and concentrated. Column chromatography (hexane:ethyl acetate (9:1)) yielded the title hexylamine as a light yellow oil (1.05 g, 94%). V⁻ₘₐₓ (ATR): 2927, 2855, 1315, 1158, 1130, 768 cm⁻¹. δ_{H} (400 MHz, CDCl₃): 8.65 (d, 1H, J=7.7 Hz, Ar—H), 8.27 (d, 1H, J=8.0 Hz, Ar—H), 8.07 (d, 1H, J=8.0 Hz, Ar—H), 7.96 (d, 1H, J=7.7 Hz, Ar—H), 7.68 (t, 1H, J=7.7 Hz, Ar—H), 7.61 (t, 1H, J=7.7 Hz, Ar—H), 7.55 (t, 1H, J=8.0 Hz, Ar—H), 4.53 (s, 1H, NH), 2.90 (q, 2H, J=7.1 Hz, CH₂), 1.35 (p, 2H, J=7.1 Hz, CH₂), 1.12 (m, 2H, CH₂), 1.05 (m, 2H, CH₂), 0.77 (t, 3H, J=7.1 Hz, CH₃). δ_{C} (CDCl₃, 400 MHz): 135.0 (C—Ar), 134.6 (C—Ar), 134.5 (C-4), 130.1 (C-2), 129.5 (C—Ar), 128.7 (C—Ar), 128.5 (C—Ar), 127.2 (C—Ar), 124.6 (C—Ar), 124.5 (C-3), 43.7 (CH₂), 31.4 (CH₂), 29.8 (CH₂), 26.5 (CH₂), 22.7 (CH₂), 14.2 (CH₃). LRMS (ES⁺): m/z 292, HRMS (ASAP⁺): Found M+H, 292.1371, C₁₆H₂₂NO₂S, requires M 292.1379. Elemental analysis: Calculated for C₁₆H₂₁NO₂S; C, 65.95; H, 7.26; N, 4.81. Measured C, 65.78; H, 7.15; N, 4.66.

5-Chloro-(1-naphthylsulfonyl)hexylamine (9, AC₄)

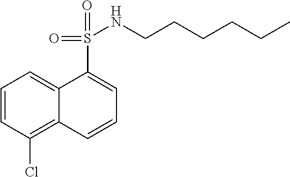 [SMILES: CCCCCCNS(=O)(=O)c1cccc2c(Cl)cccc12]

Compound 1 (1.5 g, 5.77 mmol) was dissolved in dry DCM (15 mL) and added dropwise to a solution of hexylamine (1.42 mL, 8.65 mmol, 1.5 equiv), triethylamine (2.01 mL, 14.43 mmol, 2.5 equiv) in dry DCM (5 mL) at 0° C. The mixture was stirred at room temperature for 1 h. The reaction was quenched with H₂O (10 mL) and extracted with DCM (3×10 mL). The combined organic layers dried over MgSO₄ and concentrated. Column chromatography (hexane:EtOAc; 9:1) afforded the title hexylamine as a light brown solid (1.38 g, 74%). M. p.: 99.5-100.3, V⁻ₘₐₓ (ATR): (N—H): 2941, 2855, 1422, 1315, 1136, 1100, 779. δ_{H} (400 MHz, CDCl₃): 8.62 (d, 1H, J=7.9 Hz, Ar—H), 8.59 (d, 2H, J=7.9 Hz, Ar—H), 8.34 (d, 1H, J=7.9 Hz, Ar—H), 7.71 (d, 1H, J=7.9 Hz, Ar—H), 7.67 (t, 1H, J=7.9 Hz, Ar—H), 7.58 (t, 1H, J=7.9 Hz, Ar—H), 4.50 (s, 1H, NH), 2.91 (q, 2H, J=5.5 Hz, CH₂), 1.35 (p, 2H, J=5.5 Hz, CH₂), 1.12 (m, 4H, CH₂), 1.07 (m, 2H, CH₂), 0.78 (t, 3H, J=5.5 Hz, CH₃). δ_{C} (CDCl₃, 400 MHz): 135. 7 (C—Ar), 133.5 (C—Ar), 132.0 (C—Ar), 130.8 (C—Ar), 130.7 (C—Ar), 129.9 (C—Ar), 128.4 (C—Ar), 127.7 (C—Ar), 125.6 (C—Ar), 123.9 (C—Ar), 43.7 (CH₂), 31.4 (CH₂), 29.8 (CH₂), 26.4 (CH₂), 22.7 (CH₂), 14.2 (CH₃). LRMS (ES⁺): m/z 326 ((M+H), ³⁵Cl), 328 ((M+H), ³⁷Cl). HRMS (ASAP⁺): Found M+H, 326.0982, C₁₆H₂₁NO₂S³⁵Cl, requires M, 326.0981. Elemental analysis: Calculated for C₁₆H_{21Cl}NO₂S; C, 58.98; H, 6.19; N, 4.30. Measured C, 59.04; H, 6.09; N, 4.05.

### Alpha-toluenesulfonylethylene Diamine Hydrochloric Acid Salt (E3)

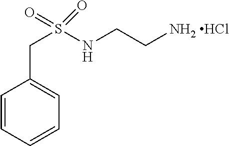

Alpha-toluenesulfonyl chloride (0.25 g, 1.31. mmol) was dissolved in dry DCM (2 mL) before added dropwise into a solution of N-Boc-ethylene diamine (0.21 mL, 1.31. mmol, 1 equiv.) and trimethylamine (0.37 mL, 2.62 mmol, 2 equiv.) in dry DCM (5 mL). The reaction was stirred for 1 h at room temperature. The reaction was quenched with water (5 mL) after the complete consumption of starting material by TLC (hexane: ethyl acetate; 3:2). The reaction mixture was extracted with DCM (3×5mL). The combined organic layers were washed with NaHCO₃, dried (MgSO₄) and concentrated. Flash column chromatography (hexane: EtOAc; 3:2) yielded the Boc-protected compound as white solid (0.13 g, 31%). The Boc-protected compound (0.13 g, 0.41 mmol) was then dissolved in dry DCM (5 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.06 g, 75%).The M. p.: 191.3-191.8, V⁻ₘₐₓ (ATR): (N—H): 3410, 1587, 777, 695 cm⁻¹. δ_{H} (400 MHz, D₂O): 7.51 (m, 5H, Ar—H), 4.58 (s, 1H, J=7.7 Hz, N—H), 3.31 (t, 2H, J=5.7 Hz, N—CH₂), 3.08 (t, 2H, J=5.7 Hz, N-CH₂), 1.20 (t, 1H, J=7.1 Hz, CH₂). δ_{C} (CDCl₃, 400 MHz): 130.7 (C—Ar), 129.1 (C—Ar), 128.8 (C—Ar), 128.4 (C—Ar), 57.5 (C-1), 40.3 (CH₂), 39.6 (CH₂). LRMS (ES⁺): m/z 215 (M+H), HRMS (ASAP⁺): Found M+H 215.0852, C₁₅H₁₉N₂O₃S, requires M 215.0854.

4-n-propylbenzenesulfonylethylene Diamine Hydrochloric Acid Salt (E2)

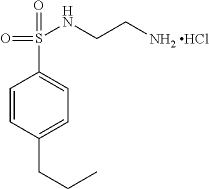

4-n-propylbenzenesulfonyl chloride (0.25 g, 1.14 mmol) was dissolved in dry DCM (3 mL) before added dropwise to a solution of N-Boc-ethylene diamine (0.18 mL, 1.14 mmol, 1 equiv) and triethylamine (0.32 mL, 2.28 mmol, 2 equiv) in dry DCM (7 mL). The reaction was stirred for 1 h at room temperature when it was quenched with H₂O (5 mL) and the reaction mixture extracted with DCM (3×5 mL). The combined organic layers were washed with NaHCO₃ (5 mL), dried (MgSO₄) and concentrated. Flash column chromatography (hexane:EtOAc; 3:2) yielded the Boc-protected compound as a white solid (0.22 g, 55.5%). The Boc-protected compound (0.22 g, 0.64 mmol) was then dissolved in dry DCM (5 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.13 g, 89%). The M. p.: 158.8-159.4, V⁻ₘₐₓ (ATR): (N—H): 3044, 1598, 730, 695 cm⁻¹. δ_{H} (400 MHz, D₂O): 7.78 (d, 2H, J=7.6 Hz, Ar—H), 7.20 (d, 2H, J=7.6 Hz, Ar—H), 3.37 (t, 2H, J=7.7 Hz, CH₂), 3.28 (t, 2H, J=7.7 Hz, Ar—H), 2.55 (t, 1H, J=7.6 Hz, C-1), 1.58 (t, 2H, J=7.6 Hz, C-2), 0.88 (t, 3H, J=7.6 Hz, CH₃). δ_{C} (D₂O, 400 MHz): 148.1 (C—Ar), 136.2 (C—Ar), 129.2 (C—Ar), 127.3 (C—Ar), 40.4 (CH₂), 37.8 (CH₂), 24.3 (C-1), 15.3 (C-2), 13.7 (CH₃). LRMS (ES⁺): m/z 244 (M+H), HRMS (ASAP⁺): Found M+H 243.1167, C₁₁H₁₉N₂O₂S, requires M243.1170.

Alpha-p-xylenesulfonylethylene Diamine Hydrochloric Acid Salt (E4)

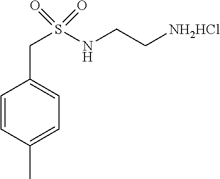

Alpha-p-xylenesulfonyl chloride (0.2 g, 0.98 mmol) was dissolved in dry DCM (3 mL) before added dropwise to a solution of N-Boc-ethylene diamine (0.16 mL, 0.98 mmol, 1 equiv) and triethylamine (0.27 mL, 1.95 mmol, 2 equiv) in dry DCM (7 mL). The reaction was stirred for 1 h at room temperature when it was quenched with H₂O (5 mL) and the reaction mixture extracted with DCM (3×5 mL). The combined organic layers were washed with NaHCO₃, dried (MgSO₄) and concentrated. Flash column chromatography (hexane:EtOAc; 3:2) yielded the Boc-protected compound as a white solid (0.21 g, 67%). The Boc-protected compound (0.17 g, 0.58 mmol) was then dissolved in dry DCM (7 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.09 g, 89%). The M. p.: 191.3-192.0, V⁻ₘₐₓ (ATR): (N—H): 3293, 1624, 795 cm⁻¹. δ_{H} (400 MHz, D₂O): 7.22 (d, 2H, J=8.0 Hz, Ar—H), 7.17 (d, 2H, J=7.7 Hz, Ar—H), 4.36 (s, 2H, 1-H), 3.12 (d, 2H, J=6.2 Hz, CH₂), 2.92 (d, 2H, J=6.2 Hz, CH₂), 2.23 (s, 3H, CH₃). δ_{C} (D₂O, 400 MHz): 139.6 (C—Ar), 130.1 (C—Ar), 129.6 (C—Ar), 125.3 (C—Ar), 57.2 (C-1), 40.3 (CH₂), 39.5 (CH₂), 20.2 (CH₃). LRMS (ES⁺): m/z 230 (M+2H), HRMS (ASAP⁺): Found M+H 229.1011, C₁₀H₁₇N₂O₂S, requires M229.1022.

### Benzenesulfonylethylene Diamine Hydrochloric Acid Salt (E1)

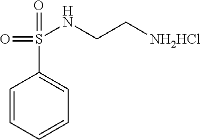

Benzenesulfonyl chloride (0.2 g, 1.13 mmol) was dissolved in dry DCM (3 mL) before added dropwise to a solution of N-Boc-ethylene diamine (0.18 mL, 1.13 mmol, 1 equiv) and triethylamine (0.32 mL, 2.26 mmol, 2 equiv) in dry DCM (5 mL). The reaction was stirred for 1 h at room temperature when it was quenched with H₂O (5 mL) and the reaction mixture extracted with DCM (3×5 mL). The combined organic layers were washed with NaHCO₃, dried (MgSO₄) and concentrated. Flash column chromatography (hexane:EtOAc; 3:2) yielded the Boc-protected compound as a white solid (0.17 g, 50 10%). The Boc-protected compound (0.17 g, 0.58 mmol) was then dissolved in dry DCM (7 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.32 g, 99%). The M. p.: 179.2-179.9, V⁻ₘₐₓ (ATR): (N—H): 3000, 1677, 1632, 1540 cm⁻¹. δ_{H} (400 MHz, D₂O): 7.75 (m, 2H, Ar—H), 7.61 (m, 1H, Ar—H), 7.53 (m, 2H, Ar—H), 3.05 (d, 2H, J=6.2 Hz, CH₂), 2.99 (d, 2H, J=6.2 Hz, CH₂). δ_{C} (D₂O, 400 MHz): 137.4 (C—Ar), 133.8 (C—Ar), 129.9 (C—Ar), 126.6 (C—Ar), 39.9 (CH₂), 39.1 (CH₂). LRMS (ES⁺): m/z 201 (M+H), HRMS (ASAP⁺): Found M+H 201.0698, C₈H₁₃N₂O₂S, requires M 201.0697.

N-methyl-N-naphthylsulfonyl-1,2-ethanediamine Hydrochloric Acid Salt (E5)

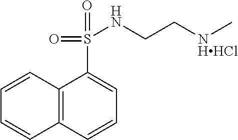

Naphthalenesulfonyl chloride (0.3 g, 1.33 mmol) was dissolved in dry DCM (3 mL) before added dropwise to a solution of N-(2-Aminoethyl)-N-methyl-carbamic acid tert-butyl ester (0.24 mL, 1.33 mmol, 1 equiv) and triethylamine (0.37 mL, 2.66 mmol, 2 equiv) in dry DCM (7 mL). The reaction was stirred for 1 h at room temperature when it was quenched with H₂O (5 mL) and the reaction mixture extracted with DCM (3×5 mL). The combined organic layers were washed with NaHCO₃, dried (MgSO₄) and concentrated. Flash column chromatography (DCM; MeOH; 9:1) yielded the Boc-protected compound as a white solid (0.31 g, 64%). The Boc-protected compound (0.21 g, 0.57 mmol) was then dissolved in dry DCM (8 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.15 g, 73%). The M. p.: 182.8-183.5, V⁻ₘₐₓ (ATR): (N—H): 3251, 1613, 891, 775 cm¹. δ_{H} (400 MHz, D₂O): 8.43 (d, 1H, J=8.7 Hz, Ar—H), 8.14 (m, 2H, Ar—H), 8.00 (d, 1H, J=8.7 Hz, Ar—H), 7.69 (d, 1H, J=8.7 Hz, Ar—H), 7.62 (d, 1H, J=8.3 Hz, Ar—H), 7.54 (t, 1H, J=8.3 Hz Ar—H), 3.46 (t, 2H, J=7.0 Hz, CH₂), 3.04 (t, 2H, J=7.0 Hz, CH₂), 1.08 (d, 3H, J=7.1 Hz, CH₃). δ_{C} (D₂O, 400 MHz): 135.3 (C—Ar), 134.0 (C—Ar), 131.9 (C—Ar), 129.9 (C—Ar), 129.5 (C—Ar), 128.8 (C—Ar), 127.3 (C—Ar), 127.1 (C—Ar), 124.4 (C—Ar), 123.2 (C—Ar), 48.3 (CH₂), 38.6 (CH₂), 32.7 (CH₃). LRMS (ES⁺): m/z 266 (M+2H), HRMS (ASAP⁺): Found M+H 265.1011, C₁₃H₁₇N₂O₂S, requires M 265.1009.

N-methylamino-N-naphthylsulfonyl-ethylamine Hydrochloric Acid Salt (E6)

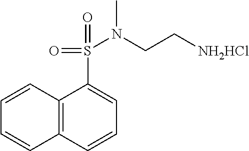

Naphthalenesulfonyl chloride (0.2 g, 0.89 mmol) was dissolved in dry DCM (3 mL) before added dropwise to a solution of N-Boc-2-methylamino-ethylamine (0.3 g, 1.77 mmol, 2 equiv) and triethylamine (0.37 mL, 1.77 mmol, 2 equiv) in dry DCM (7 mL). The reaction was stirred for 1 h at room temperature when it was quenched with H₂O (5 mL) and the reaction mixture extracted with DCM (3×5 mL). The combined organic layers were washed with NaHCO₃, dried (MgSO₄) and concentrated. Flash column chromatography (hexane:EtOAc; 3:2) yielded the Boc-protected compound as a white solid (0.06 g, 19%). The Boc-protected compound (0.06 g, 0.11 mmol) was then dissolved in dry DCM (5 mL). 1 mL (excess) of HCl in 4.0M dioxane was added dropwise. The mixture was then stirred at room temperature for 16 h when TLC analysis (DCM:MeOH; 9:1) showed complete consumption of starting material. After concentrated in vacuo, the solid obtained was washed with diethyl ether and dried under vacuum overnight to afford the title sulfonamide as a white solid (0.02 g, 74%). The M. p.: 118.1-118.8, V⁻ₘₐₓ (ATR): (N—H): 3025, 1651, 814, 774 cm⁻¹. δ_{H} (400 MHz, D₂O): 8.54 (d, 1H, J=8.3 Hz, Ar—H), 8.19 (d, 1H, J=7.4 Hz, Ar—H), 8.07 (d, 1H, J=7.4 Hz, Ar—H), 8.02 (d, 1H, J=8.3 Hz, Ar—H), 7.70 (t, 1H, J=8.3 Hz, Ar—H), 7.64 (t, 1H, J=7.4 Hz Ar—H), 7.58 (t, 1H, J=7.4 Hz, Ar—H), 3.44 (t, 2H, J=5.8 Hz, CH₂), 3.14 (t, 2H, J=5.8 Hz, CH₂), 2.89 (s, 3H, CH₃). δ_{C} (D₂O, 400 MHz):.135.3 (C—Ar), 134.3 (C—Ar), 131.4 (C—Ar), 129.6 (C—Ar), 129.4 (C—Ar), 128.8 (C—Ar), 127.8 (C—Ar), 127.3 (C—Ar), 124.5 (C—Ar), 123.8 (C—Ar), 47.3 (CH₂), 36.8 (CH₂), 34.5 (CH₃). LRMS (ES⁺): m/z 266 (M+2H), HRMS (ASAP⁺): Found M+H 265.1011, C₁₃H₁₇N₂O₂S, requires M 265.1017.

### Plant Materials and Growth

Arabidopsis thaliana wild-type seeds were from laboratory stocks of Columbia (Col-0) and Landsberg erecta (Ler-0) accessions. Arabidopsis thaliana is a dicot. The mutants of gid1 (J. Griffiths, et al., Plant Cell, 2006, 18, 3399-3414) were obtained from Dr. Steve Thomas (Rothamsted Research, UK) and were in a Col-0 background, whilst the della quintuple mutant (S. H. Feng et al. Nature, 2008, 451: 475-479) and ga1-5 (I. Fridborg et al. Plant Cell, 1999, 11: 1019-1031) were in a Ler-0 background and was obtained from the Nottingham Arabidopsis Stock Centre (NASC). The A. thaliana line expressing RGA-GFP (A. L. Silverstone et al. The Plant Cell, 2001, 13: 1555-1565), Col-0 background was obtained from Prof. Keith Lindsey (Durham University, UK). Seeds were plated out 1×MS medium pH 5.8 (T. Murashige and F. Skoog (1962) Physiologia Plantarum 15: 473-497) in petri dishes with a concentration of either 0.8% or 1.2% (w/v) phytoagar for root and hypocotyl measurements, respectively. After sowing seeds were stratified on plates at 4° C. for a minimum of 48 h to achieve synchronous germination. Seedlings were grown for either 7 or 2 days for root and hypocotyl measurements, respectively, prior to treatment with chemicals. For hypocotyl measurements, seeds were sown on nylon mesh (acid resistant monofilament nylon filter mesh fabric; GZ, model number H20M). Seedling were grown in a Percival (CU-36L5D, CLF plant climatics, Emersacker, Germany) with a photoperiod of 16/8 h with a light intensity of either 150 μmol m² s⁻¹ or 50 μmol m² s⁻¹ for root and hypocotyl measurements, respectively, and a temperature of 20±1° C.

### Root and Hypocotyl Measurements

After growing as described above seedlings for root assays were transferred to 1.2% (w/v) agar plates containing each chemical at a final concentration of 100 μM (the addition of the chemicals was performed when media had cooled to 50° C. after autoclaving), with an equivalent concentration of DMSO as control. At this stage the positions of the root tips were marked on the petri dish. The plants were subsequently grown vertically and after a further 5 days images of the plates were scanned and the root growth that occurred during the 5 days on chemicals was measured using ImageJ software. 18 seedlings were measured for each treatment. For hypocotyl measurements the assay performed was adapted from de Lucas et al. (2008, supra). After growing seedlings as described above, the nylon mesh was transferred across to the plates containing chemical. The plants were then placed in vertical orientation for three days under reduced light intensity (by covering plates with 2 layers of 80 g·m² white paper) before the plates were scanned. The measurement of hypocotyl was done using ImageJ software. At least 15 seedlings were measured for each plate.

### Fresh and Dry Weight Measurements

Leaves and roots fresh weights of 12 days old seedlings, that were subjected to 5 days chemical treatment as described above, were measured. Dry weights were recorded after placing the plant material in oven at 65° C. for 3 days. The measurements were performed on 15 seedlings for each treatment.

### Confocal Laser Scanning Microscopy Techniques

Confocal microscopy was performed using a Leica SP5 CLSM FLIM FCCS (Leica Microsystems, Wetzlar, Germany). GFP:RGA seeds were germinated and grown on 1.2% MS vertically for 7 days, and then incubated in chemical solution (at the final concentration of 100 μM) for 2 and 24 hours before being analyzed. At least five roots were imaged for each time point. The excitation wavelength of the argon laser was 488 nm and the emission was detected using a bypass filter of 495-550 nm. Images (1024×1024 pixel size) were processed using Leica software, LAS AF Lite.

### Results—A1 to A4 and AC1 to AC4

A set of 8 chemicals (A1 to A4 and AC1 to AC4) representing 4 pairs of related compounds based on the calmodulin inhibitors W5 and W7, respectively, were synthesized by sulfonamide formation from commercially available naphthalene sulfonyl chlorides.

The effect of these 8 compounds upon plant growth was investigated to gauge their potency relative to W5 and W7, which are known inhibitors of plant growth. Whilst most compounds inhibited root growth compared to a DMSO control, A1, promoted root growth (see FIG. 2).

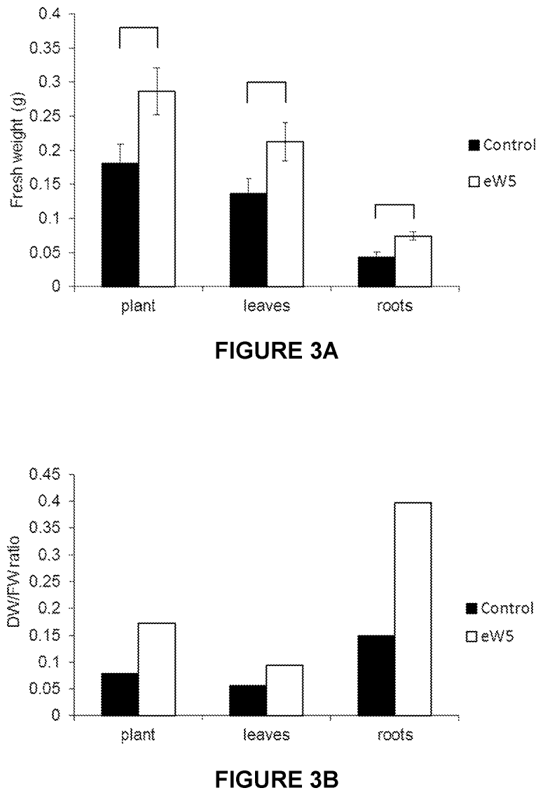

Having discovered the root growth-promoting properties of A1, we wished to establish if the effects were limited to the roots, or whether A1 could also promote growth of shoot tissue. We were also interested to see if the effect was on fresh weight, dry weight or both. To investigate this, plants were treated with A1, divided into shoot and root material and the fresh and dry weight recorded. As can be seen in FIG. 3A, the fresh weight of both roots and shoots increased in response to A1. Also in both roots and shoots the dry:fresh weight ratio increased, demonstrating that the effect of A1 was to enhance both fresh and dry mass (FIG. 3B) in all plant tissue.

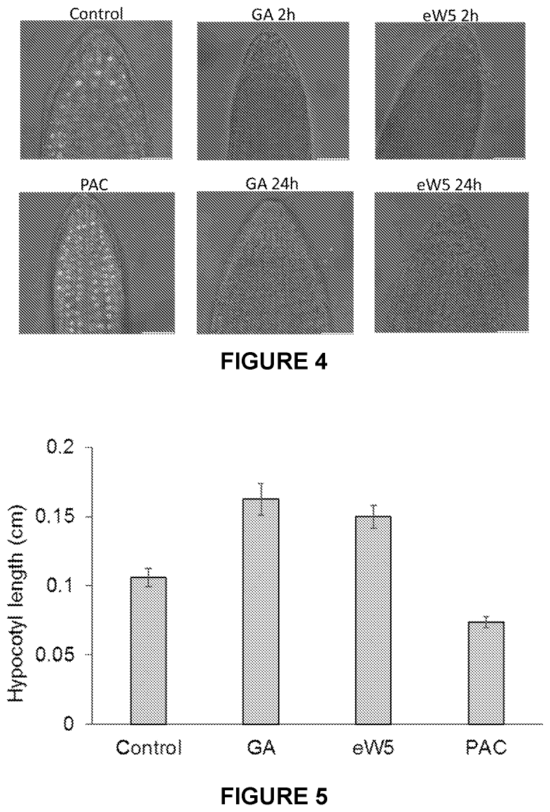

DELLA proteins are the key negative regulators of plant growth (Hauvermale et al. 2012, supra; H. Yoshida, et al. (2014) PNAS, 111: 7861-7866.). DELLA degradation in response to growth signals (such as gibberellins) leads to enhanced growth of plant tissues, including roots (S. Ubeda-Tomas et al. (2008), Nature Cell Biology, 10: 625-628). The observed promotion of root growth by A1 (FIG. 2) led to the hypothesis that A1 might therefore mediate DELLA degradation. To investigate this suggestion, the stability of DELLA proteins upon treatment with A1 was investigated (FIG. 4). An assay allowing the visualisation of DELLA degradation involves imaging fluorescent proteins fused to DELLA proteins (A. L. Silverstone et al. 2001, supra). In order to exploit this technology, Arabidopsis thaliana seedlings expressing RGA-GFP were treated with A1, GA or paclobutrazol (PAC). GA and PAC act as positive and negative controls, respectively. Roots were then imaged after 2 and 24 hours using confocal microscopy (FIG. 4). The application of A1 led to reduced GFP fluorescence indicating enhanced degradation of DELLA proteins. The A1 effect on DELLA degradation was as rapid as GA, as the response could be observed after 2 hours. Application of PAC, 48 hours prior to measurement, stabilized the DELLA protein due to the low level of GA (Silverstone et al. 2001, supra). Together, these results suggested that A1 promotes plant growth by enhancing DELLA protein degradation and, as such, its action resembles GA.

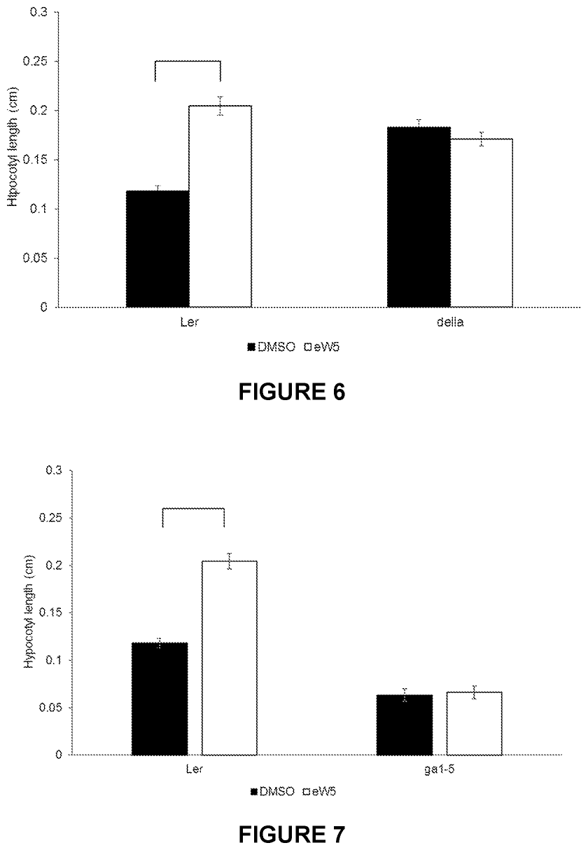

To determine the mechanism of A1 action via the GA/DELLA signaling pathway, the response of A1 in a series of GA synthesis/signalling mutants was investigated. For these assays the focus was on hypocotyl growth, because it is well established that DELLA can inhibit the binding of PIFs to their target promoter leading to a reduction in GA-regulated hypocotyl growth (A. Castillon, H. Shen and E. Huq (2007) Trends in Plant Science, 12: 514-521.; de Lucas et al. 2008, supra; S. H. Feng et al. 2008, supra. To establish the use of A1 in this assay, hypocotyl growth was first tested by growing the seedlings on agar plates containing A1, with GA and PAC used as positive and negative controls, respectively, for three days in reduced light conditions to achieve a balance between maximum and minimum hypocotyl growth. From this data it was clear that A1 stimulated hypocotyl growth in a manner very similar to GA (FIG. 5). Having established the hypocotyl assay, DELLA-dependence of the A1 effect was then confirmed genetically. To test this, a mutant line that lacks all DELLA (GAI, RGA, RGL1, RGL2 and RGL3) function was used. Due to the loss of all DELLA function, this mutant displays a longer hypocotyl phenotype as compared to wild type without treatment. Unlike wild type, no promotion of hypocotyl growth was observed after A1 treatment of this mutant (FIG. 6), supporting the suggestion that A1 requires DELLA for its growth-promoting effect.

As A1 stimulated hypocotyl growth in a very similar fashion to GA it was possible that A1 was acting as an artificial GA. To determine whether this was the case hypocotyl growth assays were performed using GA biosynthesis mutants, to test if A1 could restore growth. The ga1-5 mutant contains low levels of bioactive GA, which leads to an increase in DELLA protein and consequent growth inhibition, and hence displays a dwarfed phenotype (I. Fridborg et al. 1999, supra). In hypocotyl growth assays, ga1-5 mutants had shorter hypocotyls than wild type in untreated conditions. The treatment of the seedlings with A1 could not recover hypocotyl elongation (FIG. 7). These data suggest that A1 is not simply acting like GA and that A1 requires endogenous GA to obtain its effect on growth promotion, as mutants with low levels do not respond.

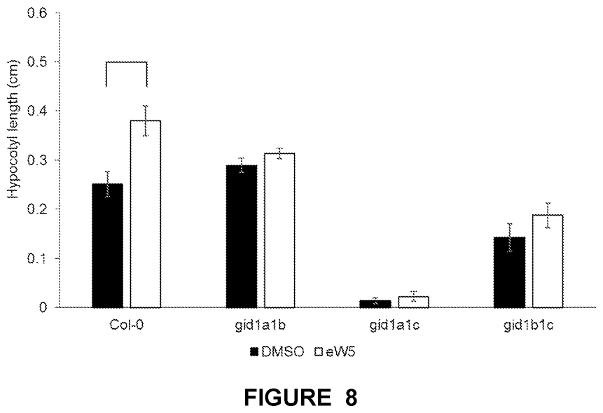

As it appeared that endogenous biosynthesis GA was needed for the A1-mediated increase in hypocotyl growth, the effect of A1 on GA receptor mutants was investigated. In Arabidopsis, there are three GA receptors named GID1a, GID1b and GID1c. These three receptors showed functional redundancy as there was no phenotype observed in gid1 single mutants (Griffiths et al. 2006, supra). The effect of A1 on hypocotyl growth in gid1 double mutants was investigated. Without treatment, gid1a1c and gid1b1c mutants showed a reduced hypocotyl length even in the absence of chemical treatment. As shown in FIG. 8, eW5 treatment increased the hypocotyl length in wild type seedlings, however the effect was reduced in the mutants. These data suggest that as well as requiring endogenous GA, A1 acts upstream of the GA receptors.

Improved root, stem (hypocotyl in particular) and leaf growth on the application of A1 to a monocot (specifically maize) has also been observed.

### Results—A1 Analogues (E1 to E6)

A1 was modified with relatively simple alterations, targeted to the naphthalene and ethylenediamine groups. E1 and E3 were synthesized to explore the effect of replacing the naphthalene ring with a simple benzoic structure, while E2 and E4 were synthesized to investigate the effect of the corresponding compounds with the addition of the alkyl group at the para position. To further study the effect of the amine group in eW5, the primary amine (E5) and secondary amine (E6) were functionalised with a methyl group.

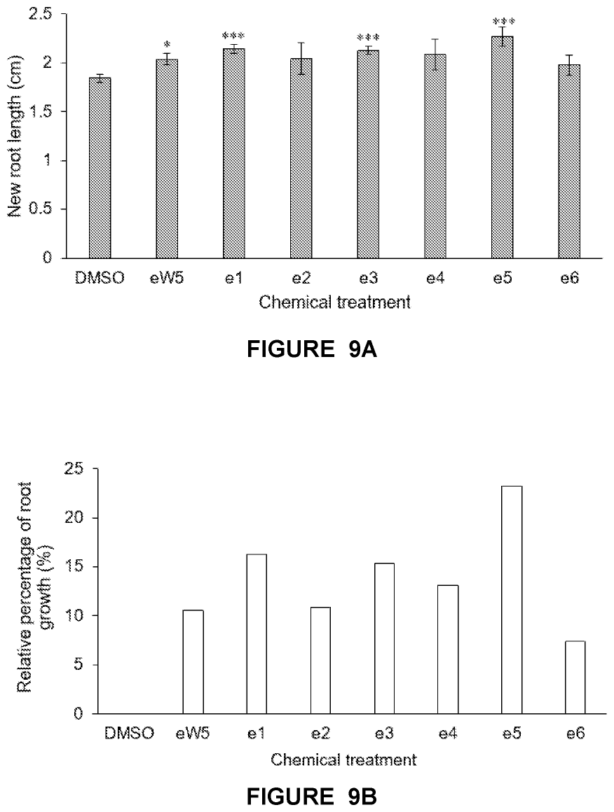

The effect of the A1 analogues on root and hypocotyl growth was investigated. In order to allow a direct comparison with eW5, the concentration used in these assays was 100 μM. The root growth assay was performed by treating the 7-day old seedlings on chemical plates for 5 days. The root length for each compound is shown in FIG. 9A, whilst the relative percentage of root growth with respect to that observed on treatment with DMSO is presented in FIG. 9B. All of the A1 analogues promoted root growth with most of them showing a higher activity than A1, suggesting that modification of the naphthalene or ethylene diamine group does not change the growth promotion effect of A1.

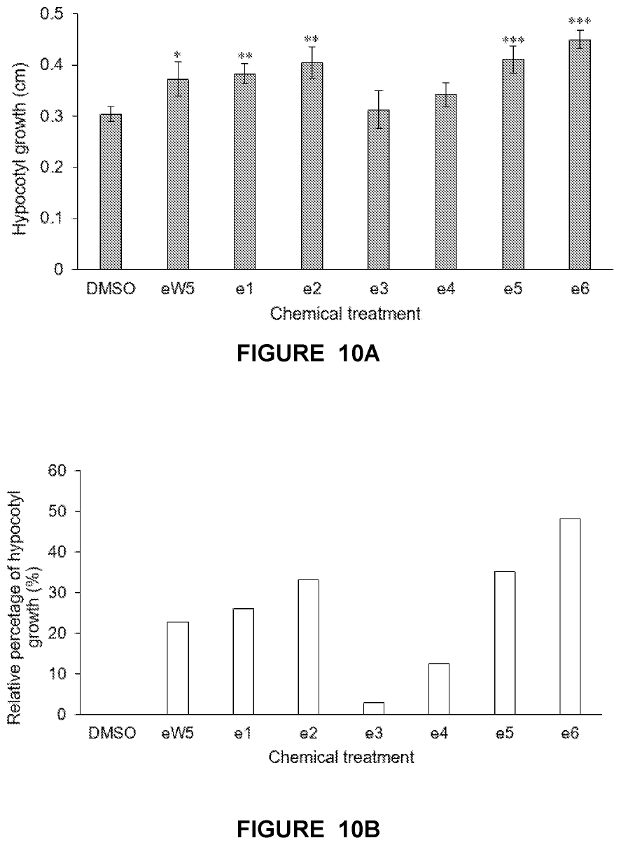

The compounds were tested for their effects on hypocotyl growth assay. The same procedure as described above was performed, whereby the seeds were grown in reduced light intensity. Similar to the root growth assay, it was found that all of the analogues showed a different degree of promotion of hypocotyl growth (FIG. 10A). Among them, only E3 and E4 showed less hypocotyl growth promotion relative to A1, which suggests that an aryl sulfonamide may be important in promoting hypocotyl growth (FIG. 10B).

Whilst all of the compounds showed a positive growth enhancement, a different promotion in root and hypocotyl growth was observed depending on the position of the sulfonamide (as observed for treatment with E3 and E4 specifically). These two compounds showed higher activity than A1 in root growth, but less activity in hypocotyl growth. Consequently, the compounds may interact differently with the protein regulating root and hypocotyl growth. Functionalisation of the ethylenediamine chain with a methyl group (E5) had the biggest effect upon root and hypocotyl growth, suggesting that the presence of this particular group is important for a greater growth activity.

### Additional Compounds

N-(2′-aminoethyl)quinoline-8-sulfonamide (JAR13)

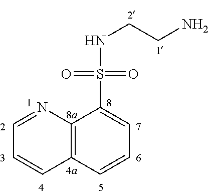 [SMILES: NCCNS(=O)(=O)c1cccc2cccnc12]

n-BuLi (1.2 mL, 2.961 mmol, 1.100 eq) was added to a solution of 8-bromoquinoline (0.560 g, 2.692 mmol, 1.000 eq) in dry ether (16 mL) under a nitrogen atmosphere at −72° C. The mixture was stirred for 20 minutes and sulfuryl chloride (0.326 mL, 4.037 mmol, 1.500 eq) was added. The reaction mixture was then stirred for an additional 1.5 hours at −20° C. and was then allowed to reach ambient temperature. The reaction was quenched by pouring over ice water. Extraction of the organic layer was then carried out using ether (3×15 mL). The combined organic layers were dried over MgSO₄ and concentrated. The resulting mixture was redissolved in DCM (20 mL) to which N-Boc ethylene diamine (0.647 g, 4.037 mmol, 1.500 eq) and triethylamine (0.536 mL, 4.037 mmol, 1.500 eq, triethylamine) were added. The reaction was allowed to stir at room temperature for 3 hours, after which time it was quenched with 1 M NaHCO_{3 (aq)} (25 mL). The aqueous layer was washed with DCM (3×15 mL). 3 M HCl (10 mL) was added to the aqueous fraction and the mixture was allowed to stir at room temperature for 1 hour. The resulting free amine was then purified with successive washes of hexane (2×20 mL), DCM (2×20 mL) and ethyl acetate (2×20 mL). The aqueous layer was then basified to pH 12 using 1 M NaOH, extracted with EtOAc (3×20 mL) and the combined organic layers were washed with brine (3×10 mL) and dried over MgSO₄. The resulting mixture was then dissolved in ice water and filtered. The filtrate was collected and dried in vacuo to yield N-8-quinoline-sulfonyl-1,2-ethanediamine (84 mg, 0.322 mmol, 12.9%) as a yellow oil. δ_{H} (699 MHz, CDCl₃) 9.03 (1H, dd, J=4.2, 1.8, 2-H), 8.41 (1H, dd, J=7.3, 1.5, 7-H), 8.26 (1H, dd, J=8.3, 1.8, 4-H), 8.04 (1H, dd, J=8.2, 1.5, 5-H), 7.64 (1H, dd, J=8.2, 7.3, 6-H), 7.54 (1H, dd, J=8.3, 4.2 Hz, 3-H), 3.65 (2H, m, b, —NH₂) 2.94 (2H, t, J=5.7, 2′-H₂), 2.83 (2H, t, J=5.7, 1′-H₂). δ_{C} (176 MHz, CDCl₃) 151.4 (C-2), 143.2 (C-8a), 137.0 (C-4), 135.8 (C-4a), 133.3 (C-5), 131.2 (C-7), 128.7 (C-8), 125.7 (C-6), 122.3 (C-3), 45.70 (C-1′), 41.28 (C-2′). vₘₐₓ (ATR) 3370 (N—H), 3257 (N—H), 2933, 2868, 2256, 1489, 1316, 1143, 905 cm⁻¹. m/z (LC-MS ESI+) 252.0 [M+H]⁺.

N-(2′-aminoethyl)-quinoline-5-sulfonamide Hydrogen Chloride (JAR30)

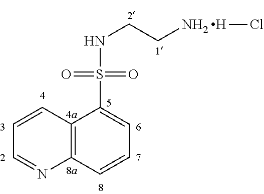

Excess 4 M HCl in dioxane (2.5 mL) was added to tert-butyl N-[2′-(quinoline-5-sulfonamido)ethyl]carbamate (86.8 mg, 0.247 mmol). The mixture was left to stir at room temperature for 16 hours, concentrated and dried in vacuo to yield the title compound as a light brown amorphous solid (69.5 mg, 0.242 mmol, 98%). δ_{H} (700 MHz, D₂O) 9.53 (1H, dt, J=8.9, 1.4 Hz, 8-H), 9.13 (1H, dd, J=5.3, 1.4 Hz, 6-H), 8.39 (1H, dd, J=7.5, 1.1 Hz, 2-H), 8.35 (1H, dt, J=8.7, 1.1 Hz, 4-H), 8.12-8.07 (2H, m, 3-H & 7-H), 3.10 (2H, dd, J=5.8, 5.1 Hz, 1′-H₂), 3.02 (2H t, J=5.8 Hz, 2′-H₂). δ_{C} (176 MHz, D₂O) δ 145.6 (C-4), 142.8 (C-5), 138.9 (C-2), 134.9 (C-8a), 133.3 (C-8), 132.3 (C-4a), 127.1 (C-3), 124.2 (C-6), 123.7 (C-7), 39.9 (C-1′), 39.2 (C-2′). vₘₐₓ (ATR) 3317 (N—H), 3222 (N—H), 2971, 2930, 2350, 2127, 1474, 1375, 1267, 1155, 1015 cm⁻¹. m/z (LC-MS ESI+) 252.30 [M+H]⁺. Accurate mass (ES+) found [M+H]⁺ 252.0812, C₁₁H₁₄N₃O₂S requires M 252.0813.

N-(2′-aminoethyl)isoquinoline-8-sulfonamide Hydrogen Chloride (JAR31)

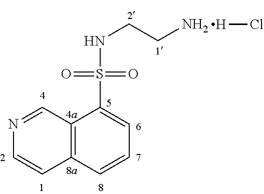

Excess 4 M HCl in dioxane (2.0 mL) was added to tert-butyl N-[2′-(isoquinoline-8-sulfonamido)ethyl]carbamate (61.1 mg, 0.174 mmol). The mixture was left to stir at room temperature for 16 hours concentrated, and dried in vacuo to yield the title compound as a light brown amorphous solid (48.0 mg, 0.167 mmol, 96%). δ_{H} (700 MHz, D₂O) 10.09 (1H, s, 1-H), 8.59 (1H, d, J=6.5 Hz, 3-H), 8.51-8.44 (2H, m, 7-H & 5-H), 8.40 (1H, d, J=6.5 Hz, 4-H), 8.16 (1H, dd, J=8.4, 7.4 Hz, 6-H), 3.72-3.50 (m (broad), —NH₃⁺), 3.14 (2H. dd, J=5.7, 5.1 Hz, 1′-H₂), 3.04 (2H, t, J=5.7 Hz, 2′-H₂). δ_{C} (176 MHz, D₂O) 143.4 (C-1), 140.5 (C-2), 136.2 (C-4a), 135.1 (C-1), 133.6 (C-5), 133.5 (C-6), 132.9 (C-7), 126.9 (C-8a), 122.4 (C-4), 40.0 (C-1′), 39.2 (C-2′). vₘₐₓ (ATR) 3345 (N—H), 3260 (N—H), 2980, 2933, 2347, 2112, 1538, 1471, 1382, 1206, 1062, 1019 cm⁻¹. m/z (LC-MS ESI+) 252.30 [M+H]⁺. Accurate mass (ES+) found [M+H]⁺ 252.0810, C₁₁H₁₄N₃O₂S requires M 252.0813.

N-(2′-aminoethyl)isoquinoline-5-sulfonamide Hydrogen Chloride (JAR32)

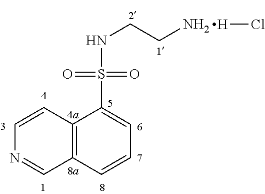

Excess 4 M HCl in dioxane (2.5 mL) was added to tert-butyl N-[2′-(isoquinoline-5-sulfonamido)ethyl]carbamate (86.8 mg, 0.247 mmol). The mixture was left to stir at room temperature for 16 hours concentrated, and dried in vacuo to yield the title compound as a light brown amorphous solid (69.5 mg, 0.242 mmol, 98%). δ_{H} (700 MHz, D₂O) 9.55 (1H, dd, J=8.9, 1.3 Hz, 3-H), 9.13 (1H, d, J=1.3 Hz, 1-H), 8.41 (1H, dd, J=7.4, 1.2

Hz, 6-H), 8.37 (1H, dd, J=8.7, 1.2 Hz, 8-H), 8.13-8.07 (2H, m, 7-H & 4-H), 3.72-3.48 (m (broad), —NH₃⁺), 3.10 (2H, t, J=5.7 Hz, 1′-H₂), 3.02 (2H t, J=5.7 Hz, 2′-H₂). δ_{C} (176 MHz, D₂O) 145.6 (C-1), 142.9 (C-3), 139.0 (C-4), 134.9 (C-8a), 133.3 (C-5), 132.2 (C-8), 127.0 (C-7), 124.3 (C-4a), 123.7 (C-6), 39.9 (C-1′), 39.2 (C-2′). vₘₐₓ (ATR) 3359 (N—H), 3273 (N—H), 2983, 2892, 2111, 2003, 1544, 1334, 1230, 1139, 1031, 953 cm⁻¹. m/z (LC-MS ESI+) 252.248 [M+H]⁺. Accurate mass (ES+) found [M+H]⁺ 252.0812, C₁₁H₁₄N₃O₂S requires M 252.0813.

N-(2′-aminoethyl)-4-methoxynaphthalene-1-sulfonamide Hydrogen Chloride (JAR33)

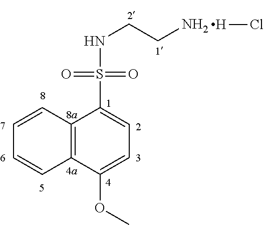

Excess 4 M HCl in dioxane (2.0 mL) was added to tert-butyl N-[2′-(4-methoxynaphthalene-1-sulfonamido)ethyl]carbamate (57.1 mg, 0.150 mmol). The mixture was left to stir at room temperature for 16 hours and concentrated to yield the title compound as a light brown amorphous solid (47.3 mg, 0.149 mmol, 99%). δ_{H} (700 MHz, D₂O) 8.69 (1H, d, J=8.9 Hz, 5-H), 7.99 (1H, d, J=9.2 Hz, 2-H), 7.77-7.72 (1H, dd, J=8.1, 1.5 8-H), 7.50 (ddd, J=8.9, 6.8, 1.5 Hz, 6-H), 7.37-7.30 (2H, m, 7-H & 3-H), 3.96 (3H, s, —OCH₃), 3.71-3.47 (m (broad), —NH₃⁺), 3.04-2.95 (4H, m, 1′-H₂ & 2′H₂). δ_{C} (176 MHz, D₂O) 156.8 (C-4), 137.1 (C-2), 130.4 (C-1), 129.2 (C-6), 129.1 (C-8a), 128.7 (C-7), 124.6 (C-4a), 122.7 (C-5), 116.8, (C-8) 113.1 (C-3), 57.0 (—OCH₃), 39.8 (C-1′), 39.1 (C-2′). vₘₐₓ (ATR) 3403 (N—H), 3277 (N—H), 2962, 2857, 2618, 2514, 1716, 1602, 1511, 1335, 1256, 1030 cm⁻¹. m/z (LC-MS ESI+) 281.694 [M+H]⁺, 561.428 [2M+H]⁺. Accurate mass (ES+) found [M+H]⁺ 281.0974, C₁₃H₁₇N₂O₃S requires M 281.0960.

N-(2′-aminoethyl)-2-methoxynaphthalene-1-sulfonamide Hydrogen Chloride (JAR36)

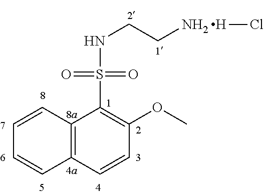

Excess 4 M HCl in dioxane (1.5 mL) was added to tert-butyl N-[2′-(2-methoxynaphthalene-1-sulfonamido)ethyl]carbamate (52.0 mg, 0.137 mmol). The mixture was left to stir at room temperature for 16 hours and concentrated to yield the title compound as a light brown amorphous solid (0.420 mg, 0.134 mmol, 98%). δ_{H} (700 MHz, D₂O) 8.66 (1H, d, J=7.9, Hz, 8-H), 7.95 (1H, d, J=9.2 Hz, 4-H), 7.72 (1H, d, J=8.2 Hz, 5-H), 7.48 (1H, dt, J=7.9, 6.8 Hz, 7-H), 7.36-7.25 (2H, m, 3-H & 6-H), 3.94 (3H, s, —OCH₃), 3.71-3.48 (m (broad), —NH₃⁺), 2.99 (4H, s, 1′-H₂ & 2′-H₂). δ_{C} (176 MHz, D₂O) 156.8 (C-2), 137.0 (C-4), 130.4 (C-8a), 129.2 (C-4a), 129.1 (C-5), 128.7 (C-7), 124.6 (C-6), 122.7 (C-8), 116.7 (C-1), 113.1 (C-3), 57.0 (—OCH₃), 39.8 (C-1′), 39.1 (C₂′). vₘₐₓ (ATR) 3425 (N—H), 3207 (N—H), 2929, 2872, 2466, 1997, 1725, 1602, 1468, 1430, 1335, 1151, 1024, 986 cm⁻¹. m/z (LC-MS ESI+) 281.664 [M+H]⁺, 561.428 [2M+H]⁺. Accurate mass (ES+) found [M+H]⁺ 281.0969, C₁₃H₁₇N₂O₃S requires M 281.0960.

N-(2′-aminoethyl)-2-pentoxynaphthalene-1-sulfonamide Hydrogen Chloride (JAR68)

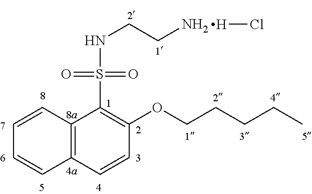

Excess 4 M HCl in dioxane (1.0 mL) was added to tert-butyl N-[2′-(2-pentoxynaphthalene-1-sulfonamido)ethyl]carbamate (25.0 mg, 0.0570 mmol). The mixture was left to stir at room temperature for 16 hours concentrated and dried to yield the title compound as a light brown amorphous solid (21.0 mg, 0.056 mmol, 98%). δ_{H} (700 MHz, CD₃OD) 9.10 (1H, d, J=8.9 Hz, 8-H), 8.14 (1H, d, J=9.1 Hz, 4-H), 7.88 (1H, d, J=8.2 Hz, 5-H), 7.57 (1H, dd, J=8.9, 6.9 Hz, 7-H), 7.53 (1H, d, J=9.1 Hz, 3-H), 7.44 (1H, dt, J=8.2, 6.9 Hz, 6-H), 4.37 (2H, t, J=7.3 Hz, 1″-H₂), 3.14 (2H, t, J=5.8 Hz, 1′-H₂), 3.07 (1H, t, J=5.8 Hz, 2′-H₂), 1.93 (2H, p, J=7.3 Hz, 2″-H₂), 1.50 (1H, p, J=7.3 Hz, 3″-H₂), 1.42 (2H, h, J=7.3 Hz, 4″-H₂), 0.95 (3H, t, J=7.3 Hz, 5″-H₃). δ_{C} (176 MHz, CD₃OD) 156.4 (C-2), 135.9 (C-4), 131.2 (C-8a), 129.3 (C-4a), 128.6 (C-5), 128.2 (C-7), 124.2 (C-6), 123.5 (C-8), 119.7 (C-1), 114.3 (C-3), 70.5 (C-1″), 40.1 (C-1′), 39.4 (C-2′), 28.5 (C-2″), 27.6 (C-3″), 22.1 (C-4″), 12.9 (C-5″). vₘₐₓ (ATR) 3339 (N—H), 2943, 2838, 1607,1511, 1339, 1149 1024 cm⁻¹. m/z (LC-MS ESI+) 337.36 [M+H]⁺, 673.47 [2M+H]⁺. Accurate mass (ES+) found [M+H]⁺ 337.1591, C₁₇H₂₅N₂O₃S requires M 337.1586.

N-(2′-aminoethyl)-4-pentoxynaphthalene-1-sulfonamide Hydrogen Chloride (JAR70)

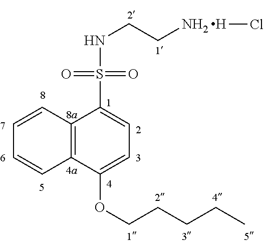

Excess 4 M HCl in dioxane (1.0 mL) was added to tert-butyl N-[2′-(4-pentoxynaphthalene-1-sulfonamido)ethyl]carbamate (65.0 mg, 0.149 mmol). The mixture was left to stir at room temperature for 16 hours concentrated and dried to yield the title compound as a light brown amorphous solid (54.0 mg, 0.145 mmol, 97%). δ_{H} (700 MHz, D₂O) 8.20 (1H, d, J=8.6 Hz, 5-H), 7.86-7.76 (2H, m, 2-H & 8-H), 7.31 (1H, dt, J=8.6, 7.6 Hz, 6-H), 7.03 (1H, t, J=7.6 Hz, 7-H), 6.30 (d, J=8.3 Hz, 3-H), 3.51 (2H, t, J=7.2 Hz, 1″-H₂), 2.96 (2H, t, J=5.7 Hz, 1′-H₂), 2.89 (2H, t, J=5.7 Hz, 2′-H₂), 1.34 (2H, d, J=7.2 Hz, 2″-H₂), 1.06-0.91 (m, 4H, 3″-H₂, 4″-H₂), 0.57 (3H, t, J=7.2 Hz, 5″-H₂). δ_{C} (176 MHz, D₂O) 158.8 (C-4), 132.0 (C-2), 128.7 (C-1), 128.5 (C-6), 125.8 (C-8a), 125.5 (C-7), 123.5 (C-4a), 122.3 (C-5), 109.6 (C-8), 102.8 (C-3), 68.4 (C-1″), 39.7 (C-1′), 39.1 (C-2′), 28.0 (C-2″), 27.8 (C-3″), 21.9 (C-4″), 13.4 (C-5″). vₘₐₓ (ATR) 3314 (N—H) 3267 (N—H), 2977, 2885, 1578, 1330, 1263, 1153, 1091, 819 cm⁻¹. m/z (LC-MS ESI+) 337.03 [M+H]⁺, 673.50 [2M+H]⁺. Accurate mass (ES+) found [M+H]⁺ 337.1593, C₁₇H₂₅N₂O₃S requires M 337.1586.

N-(2′-aminoethyl)-2-methoxybenzene-1-sulfonamide Hydrogen Chloride (JAR69)

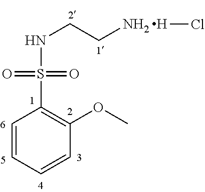

Excess 4 M HCl in dioxane (1.5 mL) was added to tert-butyl N-[2′-(2-methoybenzenesulfonamido)ethyl]carbamate (56.0 mg, 0.166 mmol). The mixture was left to stir at room temperature for 16 hours and concentrated to yield the title compound as a light brown amorphous solid (42.0 mg, 0.157 mmol, 95%). δ_{H} (700 MHz, D₂O) 7.84 (1H, dd, J=7.9, 1.7 Hz, 6-H), 7.71 (1H, ddd, J=8.5, 7.7, 1.7 Hz, 4-H), 7.26 (1H, ddd, J=8.5, 7.9, 0.9 Hz, 5-H), 7.15 (1H, td, J=7.7, 0.9 Hz, 3-H), 3.99 (3H, s, —OCH₃), 3.20-3.16 (4H, m, 1′-H₂ & 2′-H₂). δ_{C} (176 MHz, D₂O) 156.4 (C-2), 136.2 (C-4), 130.1 (C-6), 124.1 (C-1), 120.6 (C-5), 112.9 (C-3), 56.1 (—OCH₃), 39.8 (C-1′), 39.2 (C-2′). Vₘₐₓ (ATR) 3369 (N—H), 3257 (N—H), 2124, 1487, 1322, 1288, 1162, 1015 cm⁻¹. m/z (LC-MS ESI+) 231.28 [M+H]⁺, 461.35 [2M+H]⁺. Accurate mass (ES+) found [M+H]⁺ 231.0809, C₉H₁₅N₂O₃S requires M 231.0803.

N-(2′-aminoethyl)-4-methoxybenzene-1-sulfonamide Hydrogen Chloride (JAR71)

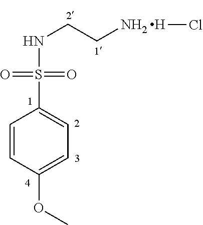

Excess 4 M HCl in dioxane (2.0 mL) was added to tert-butyl N-[2′-(4-methoxybenzenesulfonamido)ethyl]carbamate (60.0 mg, 0.182 mmol). The mixture was left to stir at room temperature for 16 hours, concentrated and dried yield the title compound as an off-white solid (44.0 mg, 0.165 mmol, 91%). δ_{H} (700 MHz, D₂O) 7.67-7.64 (2H, m, 2-H), 6.98-6.95 (2H, m, 3-H), 3.74 (3H, s, —OCH₃), 3.19-3.15 (4H, m, 1′-H & 2′-H). δ_{C} (176 MHz, D₂O) 163.1 (C-4), 129.1 (C-1), 114.8 (C-2), 66.5 (C-3), 55.7 (—OCH₃), 39.8 (C-1′), 39.1 (C-2′). Vₘₐₓ (ATR) 3353 (N—H), 3296 (N—H), 2953, 2848, 1611, 1507, 1328, 1250 1148, 1021 cm⁻¹. m/z (LC-MS ESI+) 231.27 [M+H]⁺, 461.33 [2M+H]⁺. Accurate mass (ES+) found [M+H]⁺ 231.0807, C₉H₁₅N₂O₃S requires M 231.0803.

N-(2′-aminoethyl)-2-hexoxybenzene-1-sulfonamide Hydrogen Chloride (JAR73)

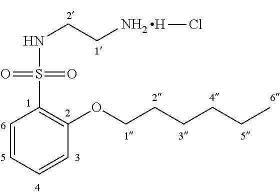

Excess 4 M HCl in dioxane (1.0 mL) was added to tert-butyl N-[2′-(2-hexoxybenzenesulfonamido)ethyl]carbamate (40.0 mg, 0.100 mmol). The mixture was left to stir at room temperature for 16 hours concentrated and dried to yield the title compound as a light brown oil (31.0 mg, 0.0920 mmol, 92%). δ_{H} (700 MHz, D₂O) 7.67 (1H, dt, J=7.9, 1.1 Hz, 6-H), 7.46 (1H, ddt, J=8.4, 7.2, 1.1 Hz, 4-H), 7.00 (1H, dd, J=8.4, 7.9 Hz, 5-H), 6.94 (1H, d, J=7.2, 3-H), 4.02 (t, J=6.7 Hz, 1″-H₂), 3.05 (2H, t, J=5.8 Hz, 1′-H₂), 3.01 (2H, t, J=5.8 Hz, 2′-H₂), 1.62 (2H, p, J=6.7 Hz, 2″-H₂), 1.23 (2H, p, J=6.7 Hz, 3″-H₂), 1.13-1.04 (4H, m, 4″-H₂, 5″-H₂), 0.70-0.62 (3H, m, 6″-H₃). δ_{C} (176 MHz, D₂O) 155.8 (C-2), 135.9 (C-4), 130.1 (C-6), 124.6 (C-1), 120.4 (C-5), 113.7 (C-3), 69.2 (C-1″), 40.0 (C-1′), 39.3 (C-2′), 30.7 (C-2″), 28.0 (C-3″), 24.8 (C-4″), 22.0 (C-5″), 13.3 (C-6″). vₘₐₓ (ATR) 3364 (N—H), 3254 (N—H), 2940, 2872, 1590, 1473, 1328, 1288, 1154, 1026 cm⁻¹. m/z (LC-MS ES+) 302.34 [M+H]⁺, 602.47 [2M+H]⁺. Accurate mass (ES+) found [M+H]⁺ 301.1600, C₁₄H₂₅N₂O₃S requires M 301.1586.

N-(2′-aminoethyl)-4-hexoxybenzene-1-sulfonamide Hydrogen Chloride (JAR72)

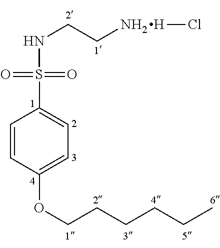

Excess 4 M HCl in dioxane (1.5 mL) was added to tert-butyl N-[2′-(4-hexoxybenzenesulfonamido)ethyl]carbamate (50.0 mg, 0.125 mmol) until it dissolved. The mixture was left to stir at room temperature for 16 hours, concentrated and dried to yield the title compound as a light brown amorphous solid (41 mg, 0.122 mmol, 97%). δ_{H} (700 MHz, D₂O) 7.61 (2H, d, J=8.8 Hz, 2-H), 6.83 (2H, d, J=8.8 Hz, 3-H), 3.81 (2H, t, J=6.5 Hz, 1″-H₂), 3.05-2.95 (4H, m, 1′H₂ & 2′-H₂), 1.56-1.49 (2H, m, 2″-H₂), 1.25-1.17 (2H, m, 3″-H₂), 1.11 (4H, m, 4″-H₂, 5″-H₂), 0.73-0.64 (3H, m, 6″-H₂). δ_{C} (176 MHz, D₂O) 162.4 (C-4), 129.3 (C-1), 129.1 (C-2), 115.0 (C-3), 68.6 (C-1″), 39.8 (C-1′), 39.1 (C-2′), 31.0 (C-2″), 28.4 (C-3″), 25.1 (C-4″), 22.1 (C-5″), 13.4 (C-6″). Vₘₐₓ (ATR) 3309 (N—H), 3266 (N—H), 2940, 2848, 1601, 1502, 1328, 1241, 1166, 1096 cm⁻¹. m/z (LC-MS ESI+) 302.3 [M+H]⁺, 601.5 [2M+H]⁺. Accurate mass (ES+) found [M+H]⁺ 301.1596, C₁₄H₂₅N₂O₃S requires M 301.1586.

N-(2′-aminoethyl)-1,8-naphtholactam-5-sulfonamide Hydrogen Chloride (JAR67)

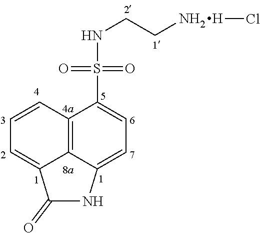

Excess 4 M HCl in dioxane (1.0 mL) was added to tert-butyl N-[2′-(5-1,8-naphtholactamsulfonamido)ethyl]carbamate (55 mg, 0.141 mmol). The mixture was left to stir at room temperature for 16 hours, concentrated and dried in vacuo to yield the title compound as a bright yellow solid (45 mg, 0.137 mmol, 98%) m.p. 179-180° C. δ_{H} (700 MHz, D₂O) 8.22 (1H, d, J=8.3 Hz, 4-H), 7.83 (1H, d, J=7.5 Hz, 6-H), 7.72 (1H, d, J=7.0 Hz, 2-H), 7.61 (1H, t, J=7.7 Hz, 3-H), 6.80 (1H, d, J=7.5 Hz, 7-H), 2.95 (4H, s, b, 1′-H₂, 2′-H₂). δ_{C} (176 MHz, D₂O) 171.2 (—NHC═O), 141.8 (C-8), 133.1 (C-6), 130.8 (C-3), 129.0 (C-4), 126.4 (C-5), 125.8 (C-1), 125.7 (C-8a), 125.6 (C-2), 123.5 (C-4a), 106.1 (C-7), 39.7 (C-1′), 39.0 (C-2′). vₘₐₓ (ATR) 3356 (N—H), 3270 (N—H) 3221 (N—H), 2952, 2842, 1630 (C═O), 1489, 329, 1207, 1144, 1031 cm⁻¹. m/z (LC-MS ESI+) 292.3 [M+H]⁺, 583.4 [2M+H]⁺. Accurate mass (ES+) found [M+H]⁺ 292.0761, C₁₃H₁₄N₃O₃S requires M 292.0756.

N-(2-hydroxyethyl)naphthalene-1-sulfonamide (JAR88)

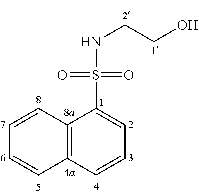 [SMILES: O=S(=O)(NCCO)c1cccc2ccccc12]

Triethylamine (0.176 mL, 1.32 mmol, 1.50 eq) was added to a solution of 1-sulfonyl chrloride naphthalene (200 mg, 0.882 mmol, 1.00 eq) in DCM (5.0 mL) and cooled to 0° C. Ethanolamine (0.080 mL, 1.32 mmol, 1.50 eq) was then added dropwise over a period of 5 minutes and upon completion of addition, the reaction mixture was allowed to reach ambient temperature. The mixture was stirred for 3 hours, quenched with water, separated and the aqueous fraction extracted with CHCl₃ (3×15 mL). The combined organic layers were washed with NaHCO₃ (3×10 mL), dried over MgSO₄, concentrated and purified by column chromatography (EtOAc in Hexane, 0-70%) to yield the title compound as a white solid (181 mg, 0.720 mmol, 82%). m.p.: 106-107° C. δ_{H} (599 MHz, CD₃OD) 7.17 (1H, dd, J=8.7, 1.1 Hz, 5-H), 6.68 (1H, dd, J=7.3, 1.2 Hz, 2-H), 6.58 (1H, dd, J=8.3, 1.2 Hz, 4-H), 6.45 (1H, dd, J=8.1, 1.4 Hz, 8-H), 6.14 (1H, ddd, J=8.5, 6.9, 1.4 Hz, 6-H), 6.07 (1H, ddd, J=8.1, 6.9, 1.1 Hz, 7-H), 6.03 (1H, dd, J=8.3, 7.3 Hz, 3-H), 1.94 (2H, t, J=6.1 Hz, 1′-H), 1.78 (1H, p, J=1.7 Hz, 2′-NH), 1.41 (2H, t, J=6.1 Hz, 2′-H). δ_{C} (151 MHz, CD₃OD) 135.3 (C-2), 134.4 (C-1), 133.7 (C-4a), 128.7 (C-5), 128.7 (C-4), 128.0 (C-7), 127.6 (C-8), 126.5 (C-8a), 124.4 (C-6), 123.9 (C-3), 60.5 (C-1′), 44.6 (C-2′). vₘₐₓ (ATR) 3487 (O—H), 3317 (N—H), 2921, 2872, 1428, 1330, 1314, 1160, 1131, 1057, 977 cm⁻¹. m/z (LC-MS ESI+) 252.176 [M+H]⁺, 503.255 [2M+H]⁺. Accurate mass (ES+) found [M+H]⁺ 252.0702, C₁₂H₁₄NO₃S requires M 252.0694.

N-(2-azaniumylethyl)-3-chloro-4-(2-ethoxyethoxy)naphthalene-1-sulfonamide Chloride (JAR141)

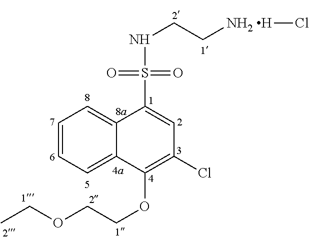

Excess 4 M HCl in dioxane (2.0 mL) was added to bis(tert-butyl N-{2′-[3-chloro-4-(2″-ethoxyethoxy)naphthalene-1-sulfonamido]ethyl}carbamate) (101 mg, 0.214 mmol, 1.00 eq). The mixture was left to stir at room temperature for 16 hours and concentrated to yield the title compound as a light brown oil (84.3 mg, 0.206 mmol, 96%). δ_{H} (700 MHz, CD₃OD) 8.30 (1H, dd, J=8.5, 1.2 Hz, H-5), 8.13 (ddd, J=8.1, 1.4 Hz, 8-H), 7.88 (1H, s, 2-H), 7.41 (1H, ddd, J=8.5, 6.8, 1.4 Hz, 6-H), 7.37 (1H, ddd, J=8.1, 6.8, 1.2 Hz, 7-H), 4.07-4.02 (2H, m, 1″-H₂), 3.54-3.49 (2H, m, 2″-H₂), 3.24 (2H, q, J=7.0 Hz, 1″-H₂), 2.97 (m, —NH₂), 2.75-2.72 (2H, m, 1′-H₂), 2.69-2.71 (2H, m, 2′-H₂), 0.86 (3H, t, J=7.0 Hz, 2″-H₃). δ_{C} (176 MHz, CD₃OD) 155.4 (C-4), 131.2 (C-2), 131.1 (C-1), 130.3 (C-3), 128.5 (C-6), 128.1 (C-8a), 127.4 (C-7), 124.5 (C-5), 123.3 (C-8), 120.8 (C-4a), 73.6 (C-1″), 69.3 (C-2″), 66.7 (C-1′″), 39.7 (C-1′), 39.3 (C-2′), 14.6 (C-2′″). m/z (LC-MS ESI+) 373.121 ([M+H (³⁵Cl)]⁺, 20), 375.146 ([M+H (³⁷Cl)]⁺, 7), 745.147 ([2M+H (³⁵Cl)]⁺, 35), 767.110 ([2M+H (³⁷Cl)]⁺, 10). Accurate mass (ES+) found [M+H]⁺ 373.0990, C₁₆H₂₂N₂O₄³⁵CIS requires M 373.0989

4-methyl-N-(2′-aminoethyl)benzene-1-sulfonamide Hydrogen Chloride (JAR142)

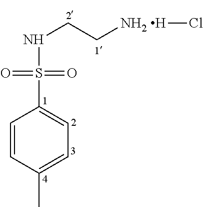

Excess 4 M HCl in dioxane (1.5 mL) was added to tert-butyl N-[2-(4-methylbenzenesulfonamido)ethyl]carbamate compound (53 mg, 0.168 mmol, 1.00 eq). The mixture was left to stir at room temperature for 16 hours and concentrated to yield the title compound as an off-white solid (40.9 mg, 0.163 mmol, 97.3%). m.p.: 153-154° C. δ_{H} (700 MHz, CD₃OD) 7.77 (2H, d, J=8.3 Hz, 3-H), 7.41 (2H, d, J=8.3 Hz, 4-H), 3.14-3.01 (4H, m, 1′-H₂, 2′-H₂), 2.44 (3H, s, —CH₃). δ_{C} (176 MHz, CD₃OD) 143.8 (C-1), 136.4 (C-4), 129.5 (C-4), 126.8 (C-3), 39.9 (C-1′), 39.3 (C-2′), 20.0 (—CH₃). m/z (LC-MS ESI+) 215.097 [M+H]⁺, 429.165 [2M+H]⁺. Accurate mass (ES+) found [M+H]⁺ 215.0844, C₉H₂₁₅N₂O₂S requires M 215.0854.

7-(methylamino)-N-(2′-aminoethyl)-2,1,3-benzoxadiazole-4-sulfonamide Hydrogen Chloride (JAR143)

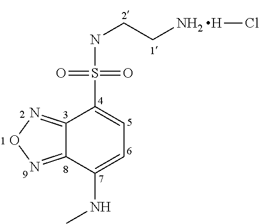

Excess 4 M HCl in dioxane (1.0 mL) was added to tert-butyl N-{2′-[7-(methylamino)-2,1,3-benzoxadiazole-4-sulfonamido]ethyl}carbamate (38 mg, 0.102 mmol, 1.00 eq). The mixture was left to stir at room temperature for 16 hours, concentrated and dried in vacuo to yield the title compound as a bright yellow solid (31 mg, 0.100 mmol, 98%). δ_{H} (700 MHz, CD₃OD) 8.12 (1H, d, J=7.8 Hz, 5-H), 6.91 (1H, d, J=7.8 Hz, 6-H), 4.17 (3H, s, —NHCH₃), 3.29 (2H, t, J=5.9 Hz, 1′-H₂), 3.09 (2H, t, J=5.9 Hz, 2′-H₂). δ_{C} (176 MHz, CD₃OD) 152.9 (C-7), 146.0 (C-3), 145.1 (C-8), 137.5 (C-5), 119.1 (C-4), 104.8 (C-6), 56.5 (—NHCH₃), 40.0 (C-1′), 39.4 (C-2′). m/z (LC-MS ESI+) 272.703 [M+H]⁺, 545.071 [2M+H]⁺. Accurate mass (ES+) found [M+H]⁺ 272.0820, C₉H₁₄N₅O₃S requires M 272.0817.

N-(2′-aminoethyl)-2-(2″-ethoxyethoxy)naphthalene-1-sulfonamide Hydrogen Chloride (JAR144)

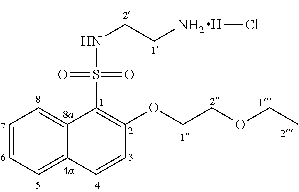

Excess 4 M HCl in dioxane (1.0 mL) was added to tert-butyl N-{2′-[2-(2″-ethoxyethoxy)naphthalene-1-sulfonamido]ethyl}carbamate (43.1 mg, 0.098 mmol, 1.00 eq). The mixture was left to stir at room temperature for 16 hours concentrated and dried to yield the title compound as a light brown amorphous solid (36.2 mg, 0.097 mmol, 98%). δ_{H} (700 MHz, CD₃OD) 8.76 (1H, dd, J=8.9, 0.9 Hz, 8-H), 7.84 (1H, d, J=9.1 Hz, 4-H), 7.58 (1H, dd, J=8.0, 1.4 Hz 5-H), 7.26 (1H, ddd, J=8.9, 6.8, 1.4 Hz, 7-H), 7.21 (1H, d, J=9.1 Hz, 3-H), 7.13 (1H, ddd, J=8.0, 6.8, 0.9 Hz, 6-H), 4.18-4.07 (2H, m, 1″-H₂), 3.65-3.54 (2H, m, 2″-H₂), 3.38 (q, J=7.0 Hz, 2H), 2.96 (2H, m, 1′-NH₂), 2.70-2.73 (4H, m, 1′-H₂, 2′-H₂), 0.97 (3H, t, J=7.0 Hz, 2″-H₂). δ_{C} (176 MHz, CD₃OD) 155.5 (C-2), 136.0 (C-4), 131.2 (C-8a), 129.6 (C-4a), 128.6 (C-5), 128.3 (C-7), 124.5 (C-6), 123.6 (C-8), 119.6 (C-1), 114.2 (C-3), 70.2 (C-1″), 68.1 (C-2″), 66.7 (C-1″'), 41.1 (C-1′), 38.8 (C-2′), 14.1 (C-2′″). m/z (LC-MS, ESI⁺) 339.618 [M+H]⁺, 677.298 [2M+H]⁺. Accurate mass (ES⁺) found [M+H]⁺ 339.1382, C₁₆H₂₃N₂O₄S requires M 339.1379.

N-(2′-aminoethyl)-4-(2″-ethoxyethoxy)naphthalene-1-sulfonamide Hydrogen Chloride (JAR145)

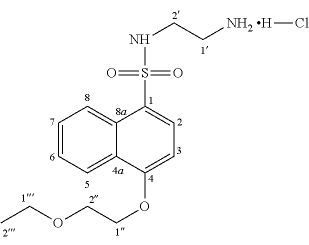

Excess 4 M HCl in dioxane (1.0 mL) was added to tert-butyl N-{2′-[4-(2″-ethoxyethoxy)naphthalene-1-sulfonamido]ethyl}carbamate (11.5 mg, 0.026 mmol, 1.00 eq). The mixture was left to stir at room temperature for 16 hours concentrated and dried to yield the title compound as a brown amorphous solid. (9.4 mg, 0.025 mmol, 95%). δ_{H} (700 MHz, CD₃OD) 8.59 (1H, dd, J=8.6, 0.9 Hz, 5-H), 8.43 (1H, d, J=8.3 Hz, 2-H), 8.20 (1H, dd, J=8.3, 1.4 Hz, 8-H), 7.72 (1H, ddd, J=8.6, 6.8, 1.4 Hz, 6-H), 7.63 (1H, ddd, J=8.3, 6.8, 0.9 Hz, 7-H), 7.04 (1H, d, J=8.3 Hz, 3-H), 4.46-4.35 (2H, m, 1″-H), 4.02-3.95 (2H, m, 2″-H), 3.68 (2H, q, J=7.0 Hz, 1″-H), 3.00 (4H, s, 1′-H, 2′-H), 1.25 (3H, t, J=7.0 Hz, 2″-H). δ_{C} (176 MHz, CD₃OD) 159.1 (C-4), 131.5 (C-2), 129.1 (C-1), 128.3 (C-6), 126.1 (C-8a), 125.9 (C-7), 125.4 (C-4a), 123.9 (C-5), 122.7 (C-8), 102.6 (C-3), 68.5 (C-1″), 68.3 (C-2″), 66.5 (C-1′″), 39.7 (C-1′), 39.3 (C-2′), 14.0 (C-2′″). m/z (LC-MS, ESI⁺) 339.158 [M+H]⁺, 677.243 [2M+H]⁺. Accurate mass (ES⁺) found [M+H]⁺ 339.1385, C₁₆H₂₃N₂O₄S requires M 339.1379.

N-(2′-aminolethyl)-N-(prop-2″-en-1′-yl)naphthalene-1-sulfonamide Hydrogen Chloride (SAM1)

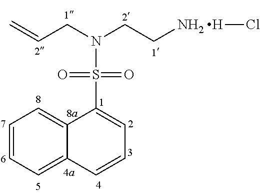

Tert-butyl N-{2′-[N-(prop-2″-en-1′-yl)naphthalene-1-sulfonamido]ethyl}carbamate (0.26 g, 2.56 mmol, 1 eq) was dissolved in dry DCM (5 mL). 1 mL (excess) of HCl in 4.0 M dioxane was added dropwise. The mixture was then stirred at room temperature for 16 h when TLC analysis (EtOAc in Hexane 60%) showed complete consumption of starting material. After concentration in vacuo, the residue obtained was washed with diethyl ether and dried under vacuum overnight to afford the title compound as a yellow semi-solid (0.16 g, 85%). V⁻max (ATR): 3050 (b), 2346, 1775, 1604 (s, NH₃⁺), 1055, 711 cm⁻¹. δ_{H} (400 MHz, CDCl₃): 8.66 (1H, d, J=8.4, 8-H), 8.36 (3H, s, NH₃), 8.27-8.12 (m, 1H, 5-H), 7.88 (d, 1H, J=7.3, 4-H), 7.80 (d, 1H, J=7.9, 2-H), 7.58 (t, 1H, J=7.6, 7-H), 7.47 (t, 1H, J=7.3, 6-H), 7.39 (d, 1H, J=7.5, 3-H), 5.40 (dd, 1H, J=15.0, 8.2, 2″-H), 5.07 (d, 1H, J=16.9, 3″-H trans), 4.90 (d, 1H, J=9.7, 3″-H cis), 3.99 (d, 2H, J=6.1, 1″-H), 3.67 (s, 2H, 2′-H), 3.36 (s, 2H, 1′-H). δ_{C} (CDCl₃, 400 MHz): 134.3 (C-4), 134.2 (C—Ar), 132.0 (C—Ar), 130.1 (C-6), 128.9 (C-2), 128.5 (C—Ar), 128.3 (C-8), 126.9 (C-7), 124.9 (C-9), 124.5 (C-3), 120.6 (C=3″), 67.0 (C-1″), 50.9 (C-2″), 44.1 (C-2′), 38.1 (C-1′). m/z (LCMS ES⁺); 291 [M+H]⁺. HRMS (ES⁺) found [M+H]⁺ 291.1167, C₁₅H₁₉N₂O₂S requires M 291.38.

N-(2′-aminoethyl)-N-benzylnaphthalene-1-sulfonamide Hydrogen Chloride (SAM2)

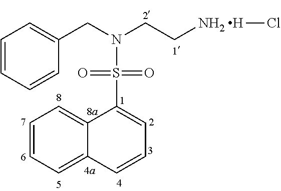

Tert-butyl N-[2-(N-benzylnaphthalene-1-sulfonamido)ethyl]carbamate (0.21 g, 0.48 mmol, 1 eq) was dissolved in dry DCM (5 mL). 1 mL (excess) of HCl in 4.0 M dioxane was added dropwise. The mixture was then stirred at room temperature for 16 h when TLC analysis (EtOAc in Hexane 60%) showed complete consumption of starting material. After concentration in vacuo, the residue obtained was washed with diethyl ether and dried under vacuum overnight to afford the title compound as a yellow semi-solid (0.16 g, 90%). V⁻max (ATR): 2870 (b, NH₃⁺), 1323, 915, 729 cm⁻¹. δ_{H} (700 MHz, CDCl₃): 8.68 (1H, d, J=8.3, 8-H), 8.24 (3H, s, NH₃), 8.11 (s, 1H, 5-H), 7.89 (d, 1H, J=7.1, 4-H), 7.82 (d, 1H, J=7.9, 2-H), 7.57 (t, 1H, J=7.7, 7-H), 7.50 (t, 1H, J=7.3, H-6), 7.35 (s, 1H, 3-H), 7.02 (s, 5H, Ar—H), 4.47 (s, 2H, N-CH₂—Bn), 3.66 (s, 2H, 2′-H), 3.05 (s, 2H, 1′-H). δ_{C} (CDCl₃, 176 MHz): 135.1 (C—Ar), 134.3 (C—Ar), 134.3 (C—Ar), 134.0 (C—Ar), 130.1 (C—Ar), 128.9 (C—Ar), 128.7 (C—Ar), 128.7 (2×C-Ar), 128.5 (C—Ar), 128.4 (2×C—Ar), 128.0 (C—Ar), 126.9 (C—Ar), 125.0 (C—Ar), 124.5 (C—Ar), 52.2 (_{C}H₂—Bn), 44.9 (C-2′), 38.1 (C-1′). m/z (LCMS ES⁺) 342 [M+H]⁺. HRMS (ES⁺) found [M+H]⁺ 341.1324, C₁₉H₂₁N₂O₂S requires M341.45.

ethyl 2″-[N-(2′-aminoethyl)naphthalene-1-sulfonamido]acetate Hydrogen Chloride (SAM3)

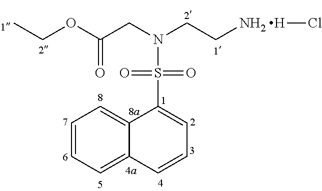

Ethyl 2-[N-(2-{[(tert-butoxy)carbonyl]amino}ethyl)naphthalene-1-sulfonamido]acetate (0.12 g, 0.27 mmol, 1 eq) was dissolved in dry DCM (5 mL). 1 mL (excess) of HCl in 4.0 M dioxane was added dropwise. The mixture was then stirred at room temperature for 16 h when TLC analysis (EtOAc in Hexane 60%) showed complete consumption of starting material. After concentration in vacuo, the residue obtained was washed with diethyl ether and dried under vacuum overnight to afford the title compound as a yellow semi-solid (0.09 g, 87%). V⁻max (ATR): 2491 (m, NH₃⁺), 1731 (s, C═O), 1312, 1121, 975 cm⁻¹. δ_{H} (700 MHz, CDCl₃): 8.58 (1H, d, J=8.7, 8-H), 8.42 (3H, s, NH3), 8.31 (d, 1H, J=8.4, 5-H), 7.95 (d, 1H, J=8.2, 4-H), 7.84 (dd, 1H, J=8.2, 1.3, 2-H), 7.62 (t, 1H, J=8.5, 7-H), 7.55-7.46 (m, 2H, 6-H, 3-H), 4.80 (q, 1H, J=7.4, N—CH₂—COOEt), 3.84 (dq, 1H, J=10.7, 7.1, N—CH₂—COOEt), 3.75 (m, 2′-H), 3.67 (m, 2H, 1′-H), 3.45-3.28 (m, 2H, 2″-H), 0.96 (t, 3H, J=7.1, 1″-H). δ_{C} (CDCl₃, 176 MHz): 172.5 (C═O), 134.6 (C-4), 134.3 (C—Ar), 133.6 (C—Ar), 130.7 (C-6), 129.0 (C-2), 128.5 (C—Ar), 128.4 (C-8), 126.8 (C-7), 124.5 (C-9), 124.5 (C-3), 67.5 (N—CH₂—COOEt), 62.0 (C-2″), 55.4 (C-2′), 41.9 (C-1′), 13.7 (C-1″). m/z (LCMS ES⁺) 338 [M+H]⁺. HRMS (ES⁺) found [M+H]⁺ 338.1256, C₁₆H₂₁N₂O₄S requires M 338.40.

ethyl 2-[N-(2-azaniumylethyl)naphthalene-1-sulfonamido]propanoate Chloride (SAM4)

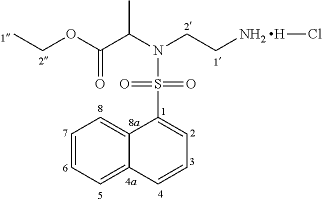

Ethyl 2-[N-(2-{[(tert-butoxy)carbonyl]amino}ethyl)naphthalene-1-sulfonamido]propanoate (0.22 g, 0.49 mmol, 1 eq) was dissolved in dry DCM (5 mL). 1 mL (excess) of HCl in 4.0 M dioxane was added dropwise. The mixture was then stirred at room temperature for 16 h when TLC analysis (EtOAc in Hexane 60%) showed complete consumption of starting material. After concentration in vacuo, the residue obtained was washed with diethyl ether and dried under vacuum overnight to afford the title compound as a white semi-solid (0.17 g, 91%). V⁻max (ATR): 2902 (b, N—H), 1726 (s, C═O), 1318, 895, 729 cm⁻¹. δ_{H} (700 MHz, MeOD): 8.88 (1H, d, J=8.7, 8-H), 8.27-8.16 (3H, m, NH₃), 8.09-8.02 (2H, m, 5-H, 4-H), 7.74-7.60 (4H, m, 2-H, 7-H, 3-H, 6-H), 3.92 (dq, 1H, J=10.7, 7.1, N—CH), 3.85 (dq, 1H, J=10.7, 7.1, 2″-H), 3.64 (dd, 2H, J=14.3, 7.8, 2′-H), 3.64 (t, 2H, J=7.8, 1′-H), 1.44 (d, 3H, J=7.5, CH—CH₃), 1.05 (t, 3H, J=7.2, 1″-H). δ_{C} (MeOD, 176 MHz): 173.8 (C═O), 136.1 (C-4), 135.8 (C—Ar), 135.4 (C—Ar), 131.1 (C-6), 130.4 (C-2), 128.3 (C—Ar), 128.3 (C-8), 125.9 (C-7), 125.6 (C-9), 125.5 (C-3), 63.0 (N—CH), 56.8 (C2″), 54.0 (C-2′), 40.7 (C-1′), 16.3 (N—CH(CH₃)—COO—), 14.1 (C-1″). m/z (LCMS ES⁺) rt 2.13; 352 [M+H]+. HRMS (ES⁺) found [M+H]⁺ 351.1379, C₁₇H₂₃N₂O₄S requires M 351.44.

### Results—Additional Compounds

The effect of additional compounds on hypocotyl growth was investigated using the same methods as described above (100 μM of each compound was used). The results are tabulated below. The results that are indicative of growth promotion are shown in bold.

| | | | New | | | |
|---|---|---|---|---|---|---|
| | | | length | Relative | | |
| Trial | Structure | Compound | (cm) | growth (cm) | SD | SE |
| 1 | | DMSO | 0.235 | 0 | 0.056 | 0.039598 |
| 1 | | eW5 | 0.318 | 0.353191489 | 0.072 | 0.050912 |
| 1 | 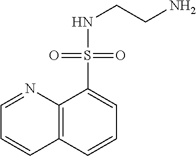 [SMILES: NCCNS(=O)(=O)c1cccc2cccnc12] | JAR13 | 0.212 | −0.09787234 | 0.046 | 0.032527 |
| 1 | 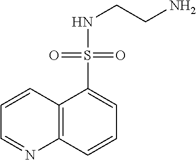 [SMILES: NCCNS(=O)(=O)c1cccc2ncccc12] | JAR30 | 0.333 | 0.417021277 | 0.1 | 0.070711 |
| 1 | 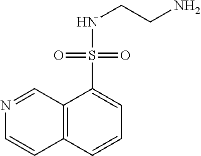 [SMILES: NCCNS(=O)(=O)c1cccc2ccncc12] | JAR31 | 0.274 | 0.165957447 | 0.073 | 0.051619 |
| 1 | 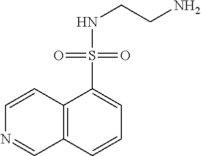 [SMILES: NCCNS(=O)(=O)c1cccc2cnccc12] | JAR32 | 0.202 | −0.140425532 | 0.029 | 0.020506 |
| 1 | 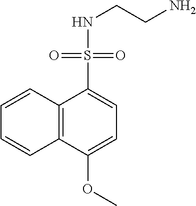 [SMILES: COc1ccc(S(=O)(=O)NCCN)c2ccccc12] | JAR33 | 0.298574 | 0.27052766 | 0.056361 | 0.039853 |
| 1 | 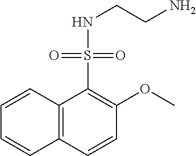 [SMILES: COc1ccc2ccccc2c1S(=O)(=O)NCCN] | JAR36 | 0.329 | 0.4 | 0.068 | 0.048083 |
| 2 | | DMSO | 0.241 | 0 | | |
| 2 | | eW5 | 0.322 | 0.336099585 | | |
| 2 | 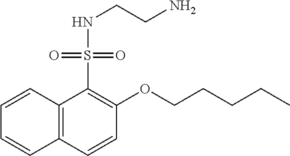 [SMILES: CCCCCOc1ccc2ccccc2c1S(=O)(=O)NCCN] | JAR68 | 0.197 | −0.182572614 | | |
| 2 | 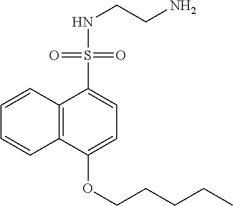 [SMILES: CCCCCOc1ccc(S(=O)(=O)NCCN)c2ccccc12] | JAR70 | 0.173 | −0.282157676 | | |
| 2 | 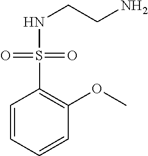 | JAR69 | 0.316 | 0.31120332 | | |
| 2 | 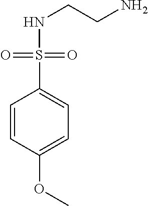 | JAR71 | 0.331 | 0.373443983 | | |
| 2 | 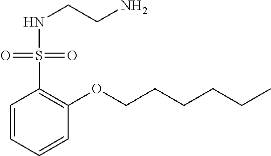 [SMILES: CCCCCCOc1ccccc1S(=O)(=O)NCCN] | JAR73 | 0.202 | −0.161825726 | | |
| 2 | 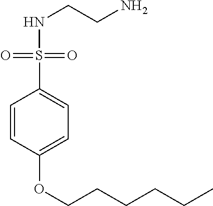 [SMILES: CCCCCCOc1ccc(S(=O)(=O)NCCN)cc1] | JAR72 | 0.195 | −0.190871369 | | |
| 2 | 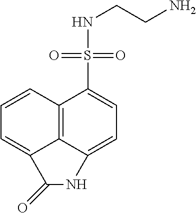 [SMILES: NCCNS(=O)(=O)c1ccc2c3c(cccc13)C(=O)N2] | JAR67 | 0.187 | −0.22406639 | | |
| 3 | | DMSO | 0.402406 | 0 | 0.101683 | 0.071901 |
| 3 | | eW5 | 0.605841 | 0.505546637 | 0.186736 | 0.132042 |
| 3 | 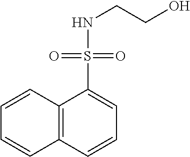 [SMILES: O=S(=O)(NCCO)c1cccc2ccccc12] | JAR88 | 0.28271 | −0.297450833 | 0.059443 | 0.042033 |
| 3 | 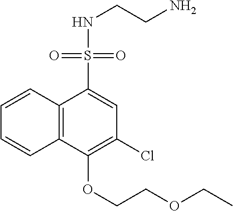 [SMILES: CCOCCOc1c(Cl)cc(S(=O)(=O)NCCN)c2ccccc12] | JAR141 | 0.438727 | 0.090259589 | 0.115937 | 0.08198 |
| 3 | 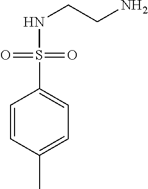 | JAR142 | 0.58685 | 0.458353007 | 0.173897 | 0.122964 |
| 3 | 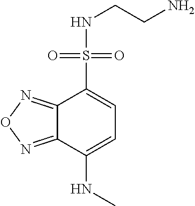 [SMILES: CNc1ccc(S(=O)(=O)NCCN)c2nonc12] | JAR143 | 0.284714 | −0.292470788 | 0.079005 | 0.055865 |
| 3 | 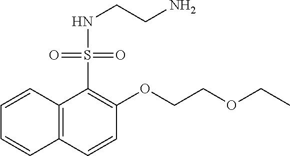 [SMILES: CCOCCOc1ccc2ccccc2c1S(=O)(=O)NCCN] | JAR144 | 0.600659 | 0.492669095 | 0.144753 | 0.102356 |
| 3 | 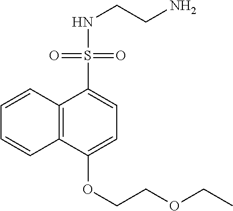 [SMILES: CCOCCOc1ccc(S(=O)(=O)NCCN)c2ccccc12] | JAR145 | 0.642443 | 0.596504525 | 0.154914 | 0.109541 |
| SAM | | DMSO | 0.197 | 0 | | |
| SAM | | ew5 | 0.285 | 0.446700508 | | |
| SAM | 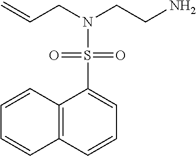 [SMILES: C=CCN(CCN)S(=O)(=O)c1cccc2ccccc12] | SAM1 | 0.193 | −0.020304569 | | |
| SAM | 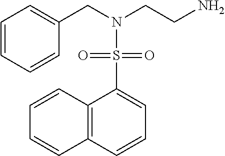 [SMILES: NCCN(Cc1ccccc1)S(=O)(=O)c1cccc2ccccc12] | SAM2 | 0.191 | −0.030456853 | | |
| SAM | 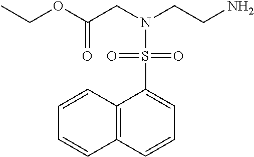 [SMILES: CCOC(=O)CN(CCN)S(=O)(=O)c1cccc2ccccc12] | SAM3 | 0.272 | 0.38071066 | | |
| SAM | 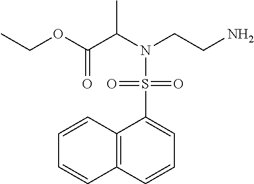 [SMILES: CCOC(=O)C(C)N(CCN)S(=O)(=O)c1cccc2ccccc12] | SAM4 | 0.228 | 0.157360406 | | |

### Further Examples

### General Procedure A

4M HCl in dioxane (1 mL) was added to a vial containing the starting Boc-protected compound. The reaction was allowed to stir at room temperature for 3 hours after which volatiles were evaporated to yield the title compound.

### General Procedure B

A DCM solution of the starting sulfonyl chloride was added to a solution of triethylamine (1.200 eq) and the starting amine (1.200 eq) in DCM. The reaction mixture was stirred for 3 hours at room temperature and quenched with 1M NaHCO₃. Extraction was conducted with DCM (3×5 mL) and the combined organic layers were dried over MgSO₄ and concentrated. Purification through flash chromatography using the stated solvent system yielded the title compound.

N-(2′-aminoethyl)-3-methoxybenzene-1-sulfonamide Hydrochloride (JAR490)

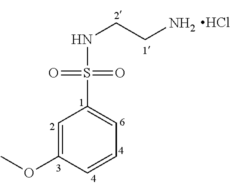

Compound was prepared through general procedure A, starting with tert-butyl N-[2′-(3-methoxybenzenesulfonamido)ethyl]carbamate (20.0 mg, 0.061 mmol, 1.00 eq) to yield the title compound as a white amorphous solid (15.4 mg, 0.058 mmol, 95.4%). δ_{H} (400 MHz, MeOD) 7.51 (1H, t, J=7.9 Hz, 5-H), 7.47-7.42 (1H, m, 6-H), 7.40 (1H dd, J=2.6, 1.6 Hz, 2-H), 7.21 (1H, ddd, J=8.2, 2.6, 1.1 Hz, 4-H), 3.87 (3H, s, —OCH₃), 3.07 (4H m, 2′H, 1′H). δ_{C} (101 MHz, MeOD) 160.3 (C-3), 140.6 (C-1), 130.2 (C-6), 118.7 (C-2), 118.4 (C-5), 111.8 (C-4), 54.8 (—OCH₃), 40.0 (C-2′), 39.3 (C-1′). vₘₐₓ (ATR) 3378 (b, N—H), 2502, 1638, 1598, 1481, 1436, 1319, 1247, 1155 cm⁻¹. m/z (LC-MS ESI+) 231.266 [M+H]⁺, 461.458 [2M+H]⁺. Accurate mass (ES+) found [M+H]⁺ 231.0811, C₉H₁₅N₂O₃S requires M 231.0803.

N-(2′-aminoethyl)-[1,1″-biphenyl]-4-sulfonamide Hydrochloride (JAR479)

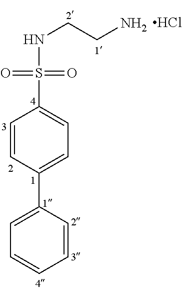 [SMILES: Cl ; NCCNS(=O)(=O)c1ccc(-c2ccccc2)cc1]

Compound was prepared through general procedure A, starting with tert-butyl N-(2′-{[1,1″-biphenyl]-4-sulfonamido}ethyl)carbamate (20.0 mg, 0.053 mmol, 1.00 eq) to yield the title compound as a white amorphous solid (16.5 mg, 0.053 mmol, 99.3%). δ_{H} (400 MHz, MeOD) 8.02-7.82 (4H, m, 2″-H, 3″-H), 7.75-7.67 (2H, m, 3-H), 7.55-7.48 (2H, m, 2-H), 7.47-7.40 (1H, m, 4″-H), 3.18-3.06 (4H, m, 2′-H, 1′-H). δ_{C} (101 MHz, MeOD) 145.7 (C-4), 139.1 (C-1′), 138.0 (C-1″), 128.8 (C-3), 128.3 (C-4″), 127.5 (C-2), 127.4 (C-2″), 126.9 (C-3″), 40.0 (C-2′), 39.3 (C-1′). vₘₐₓ (ATR) 3261 (b, N—H), 3038, 2871, 1584, 1489, 1311, 1152, 1099, 1042, 765 cm⁻¹. m/z (LC-MS ESI+) 277.290 [M+H]⁺, 553.461 [2M+H]⁺. Accurate mass (ES+) found [M+H]⁺ 277.1014, C₁₄H₁₇N₂O₂S requires M 277.1011.

N-(2′-aminoethyl)cyclohexanesulfonamide Hydrochloride (JAR488)

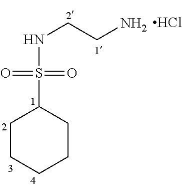 [SMILES: Cl ; NCCNS(=O)(=O)C1CCCCC1]

Compound was prepared through general procedure A, using tert-butyl N-(2′-cyclohexanesulfonamidoethyl)carbamate (20.0 mg, 0.065 mmol, 1.00 eq) to yield the title compound as a colourless oil (15.5 mg, 0.064 mmol, 97.8%). δ_{H} (400 MHz, MeOD) 3.35 (2H, m, 2′-H), 3.09-3.00 (3H, m, 1′-H, 1-H), 2.20-1.83 (4H, m, 2-H)), 1.79-1.15 (6H, m, 3-H, 4-H). δ_{C} (101 MHz, MeOD) 60.1 (C-1), 40.1 (C-2′), 40.0 (C-1′), 26.2 (C-2), 24.9 (C-4), 24.7 (C-3). vₘₐₓ (ATR) 3346 (b, N—H), 2488, 2077, 1116, 971 cm⁻¹. m/z (LC-MS ESI+) 207.284 [M+H]⁺, 413.498 [2M+H]⁺. Accurate mass (ES+) found [M+H]⁺ 207.1166, C₈H₁₉N₂O₂S requires M 207.1167.

N-(2′-aminoethyl)-2″-(naphthalen-1-yl)ethane-1″-sulfonamide Hydrochloride (JAR486)

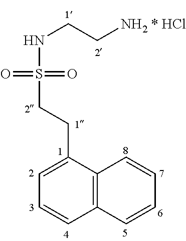 [SMILES: NCCNS(=O)(=O)CCc1cccc2ccccc12]

Compound was prepared through general procedure A, using tert-butyl N-{2-[2-(naphthalen-1-yl)ethanesulfonamido]ethyl}carbamate+(20.0 mg, 0.053 mmol, 1.000 eq) to yield the title compound as light brown amorphous solid (15.8 mg, 0.050 mmol, 95.0%). δ_{H} (400 MHz, MeOD) 8.08 (1H, dd, J=8.4, 2.1 Hz, 2-H), 7.92 (1H, dd, J=8.0, 1.4 Hz, 5-H), 7.81 (1H, dd, J=7.2, 2.1 Hz, 4-H), 7.60 (1H, ddd, J=8.4, 6.8, 1.4 Hz, 7-H), 7.53 (1H, ddd, J=8.0, 6.8, 1.2 Hz, 6-H), 7.49-7.40 (2H, m, 8-H, 3-H), 3.63-3.46 (4H, m, 2′-H, 1′H), 3.40 (2H, t, J=5.7 Hz, 2″-H), 3.10 (2H, t, J=5.7 Hz, 1″-H). δ_{C} (101 MHz, MeOD) 134.1 (C-1), 134.0 (C-4a), 131.3 (C-8a), 128.7 (C-2), 127.4 (C-5), 126.3 (C-4), 126.2 (C-7), 125.5 (C-8), 125.3 (C-6), 122.6 (C-3), 51.8 (C-2″), 40.0 (C-2′), 39.8 (C-1′), 26.5 (C-1″). vₘₐₓ (ATR) 3361 (b, N—H), 3208, 2946, 2403, 1598, 1496, 1439, 1329, 1137, 794 cm⁻¹. m/z (LC-MS ESI+) 279.305 [M+H]⁺, 557.490 [2M+H]⁺. Accurate mass (ES+) found [M+H]⁺ 279.1169, C₁₄H₁₉N₂O₂S requires M 279.1169.

N-(2-aminoethyl)-3-fluorobenzene-1-sulfonamide Hydrochloride (JAR478)

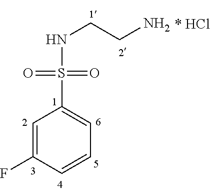 [SMILES: NCCNS(=O)(=O)c1cccc(F)c1]

Compound was prepared through general procedure A, starting tert-butyl N-[2′-(3-fluorobenzenesulfonamido)ethyl]carbamate (20.0 mg, 0.063 mmol, 1.00 eq) to yield the title compound as an off white amorphous solid (15.8 mg, 0.062 mmol, 98.7%). δ_{H} (400 MHz, MeOD) 7.82-7.56 (3H, m, 2′-H, 4′-H, 6′H), 7.44 (1H, m, 5-H), 3.10 (4H, m, 2′-H, 1′-H). δ_{C} (101 MHz, MeOD) 162.6 (d, J=248.1 Hz, C-1), 141.7 (d, J=6.4 Hz, C-1), 131.4 (d, J=8.0 Hz, C-5), 122.9 (d, J=2.8 Hz, C-6), 119.7 (d, J=21.3 Hz, C-2), 114.9 (d, J=24.5 Hz, C-4), 40.23 (C-2′), 39.62 (C-1′). δ_{F} (376 MHz, MeOD) −111.97. vₘₐₓ (ATR) 3283 (b, N—H), 3066, 2977, 2857, 1591, 1457, 1327, 1149, 1064, 1025, 966 cm⁻¹. m/z (LC-MS ESI+) 219.218 [M+H]⁺, 437.441 [2M+H]⁺. Accurate mass (ES+) found [M+H]⁺ 219.0603, C₈H₁₂N₂O₂SF requires M 219.0604.

N-(2′-aminoethyl)-2-fluorobenzene-1-sulfonamide Hydrochloride (JAR480)

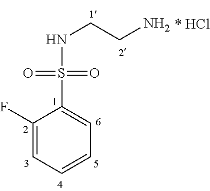 [SMILES: NCCNS(=O)(=O)c1ccccc1F]

Compound was prepared through general procedure A, starting tert-butyl N-[2′-(2-fluorobenzenesulfonamido)ethyl]carbamate (20.0 mg, 0.063 mmol, 1.00 eq) to yield the title compound as a light yellow amorphous solid (16.0 mg, 0.063 mmol, 100.0%). δ_{H} (400 MHz, MeOD) 7.92 (1H, td, J=7.6, 1.7 Hz, 3-H), 7.80-7.62 (1H m, 6-H), 7.46-7.28 (2H, m, 4-H, 5-H), 3.22 (2H, t, J=5.7 Hz, 2′-H), 3.08 (2H, t, J=5.7 Hz, 1′-H). δ_{C} (101 MHz, MeOD) 158.9 (d, J=254.7 Hz, C-2) 135.4 (d, J=8.8 Hz, C-4), 130.05 (C-5), 127.4 (d, J=16.5 Hz, C-1), 124.5 (d, J=4.0 Hz, C-6), 116.89 (d, J=22.6 Hz, C-3), 39.86 (2′-H), 39.45 (1′-H). δ_{F} (376 MHz, MeOD) -111.84. vₘₐₓ (ATR) 3389 (b, N—H), 3077, 2861, 1598, 1513, 1474, 1336, 1144 cm⁻¹. m/z (LC-MS ESI+) 219.218 [M+H]⁺, 437.403 [2M+H]⁺. Accurate mass (ES+) found [M+H]⁺ 219.0592, C₈H₁₂N₂O₂SF requires M 219.0604.

N-(2′-aminoethyl)-5-chloronaphthalene-1-sulfonamide Hydrochloride (JAR482)

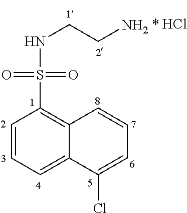 [SMILES: NCCNS(=O)(=O)c1cccc2c(Cl)cccc12]

Compound was prepared through general procedure A, using tert-butyl N-[2-(5-chloronaphthalene-1-sulfonamido)ethyl]carbamate (20.0 mg, 0.052 mmol, 1.000 eq) to yield the title compound as an amorphous white solid (15.0 mg, 0.047 mmol, 89.9%). δ_{H} (400 MHz, MeOD) 8.70 (1H, d, J=8.5 Hz, 8-H), 8.63 (1H, d, J=8.4 Hz, 4-H), 8.35 (1H, d, J=7.0 Hz, 2-H), 7.85-7.73 (2H, m, 6-H, 3-H), 7.69 (1H, t, J=8.5 Hz, 7-H), 3.07 (4H, m, 2′-H, 1′-H). δ_{C} (101 MHz, MeOD) 135.2 (C-1), 132.5 (C-5), 131.5 (C-4a), 130.0 (C-4), 129.9 (C-2), 129.3 (C-8a), 127.9 (C-7), 127.4 (C-7), 125.4 (C-6), 123.7 (C-3), 33.9 (C-1′), 33.5 (C-2′). vₘₐₓ (ATR) 3271 (b, N—H), 2988, 2854, 1591, 1563, 1496, 1319, 1134, 1031 cm⁻¹. m/z (LC-MS ESI+) 285.233 [M(³⁵Cl)+H]⁺(100), 287.248 [M(³⁷Cl)+H]⁺ (80). Accurate mass (ES+) found [M+H]⁺ 285.0467, C₁₂H₂₄N₂O₂S³⁵Cl requires M 285.0465.

N-(2′-aminoethyl)-4-tent-butylbenzene-1-sulfonamide Hydrochloride (JAR484)

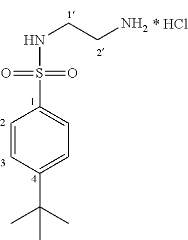 [SMILES: CC(C)(C)c1ccc(S(=O)(=O)NCCN)cc1]

Compound was prepared through general procedure A, starting with tert-butyl N-[2′-(4-tert-butylbenzenesulfonamido)ethyl]carbamate (20.0 mg, 0.056 mmol, 1.00 eq) to yield the title compound as a light yellow amorphous solid (13.3 mg, 0.045 mmol, 81.0%). δ_{H} (400 MHz, MeOD) 7.83 (2H, d, J=8.2 Hz, 2-H), 7.66 (2H, d, J=8.2 Hz, 3-H), 3.17-3.02 (4H, m, 2′-H, 3′-H), 1.37 (9H, s, -tBu). δ_{C} (101 MHz, MeOD) 156.6 (C-1), 136.5 (C-4), 126.7 (C-2), 126.1 (C-3), 40.0 (C-2′), 39.4 (C-1′), 34.7 (—C(CH₃)₃), 30.1 (—C(CH₃)₃). vₘₐₓ (ATR) 3041 (b, N—H), 2959, 2864, 1598, 1474, 1311, 1152, 1092, 1031 cm⁻¹. m/z (LC-MS ESI+) 257.300 [M+H]⁺, 513.522 [2M+H]⁺. Accurate mass (ES+) found [M+H]⁺ 257.1329, C₁₂H₂₁N₂O₂S requires M 257.1324.

N-(2-aminoethyl)-4-propylbenzene-1-sulfonamide (JAR489)

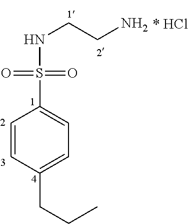 [SMILES: CCCc1ccc(S(=O)(=O)NCCN)cc1]

Compound was prepared through general procedure A, starting with tert-butyl N-[2′-(4-propylbenzenesulfonamido)ethyl]carbamate (20.0 mg, 0.058 mmol, 1.000 eq) to yield the title compound as an off white amorphous solid (16.0 mg, 0.057 mmol, 98.3%). δ_{H} (400 MHz, MeOD) 7.81 (2H, d, J=8.2 Hz, 2-H), 7.44 (2H, d, J=8.2 Hz, 3-H), 3.13-2.99 (4H, m, 2′-H. 3′-H), 2.71 (2H, d, J=8.5, Hz, Ar—CH₂), 1.80-1.60 (2H, m, —CH₂CH₂CH₃), 0.98 (3H, t, J=7.4 Hz, —CH₃). δ_{C} (101 MHz, MeOD) 148.4 (C-1), 136.7 (C-4), 129.1 (C-2), 126.8 (C-3), 40.0 (C-2′), 39.3 (C-1′), 37.4 (Ar—CH₂), 24.0 (—CH₂CH₂CH₃), 12.6 (—CH₃). vₘₐₓ (ATR) 3396 (b, N—H), 2964, 2871, 1595, 1326, 1155, 1092 cm⁻¹. m/z (LC-MS ESI+) 243.314[M+H]⁺, 485.514 [2M+H]⁺. Accurate mass (ES+) found [M+H]⁺ 243.1166, C₁₁H₁₉N₂O₂S requires M 243.1167.

N-(2′-aminoethyl)-4-nitrobenzene-1-sulfonamide Hydrochloride (JAR483)

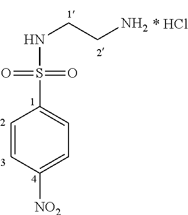 [SMILES: NCCNS(=O)(=O)c1ccc([N+](=O)[O-])cc1]

Compound was prepared through general procedure A, starting with tert-butyl N-[2′-(4-nitrobenzenesulfonamido)ethyl]carbamate (20.0 mg, 0.058 mmol, 1.00 eq) to yield the title compound as a light green solid (16.0 mg, 0.057 mmol, 98.1%). δ_{H} (400 MHz, MeOD) 8.44 (2H, d, J=8.3 Hz, 3-H), 8.13 (2H, d, J=8.3 Hz, 2-H), 3.13 (4H, m, 2′H, 1′-H). δ_{C} (101 MHz, MeOD) 150.3 (C-4), 145.3 (C-1), 128.31 (C-3), 124.24 (C-2), 40.12 (C-2′), 39.4 (C-1′). vₘₐₓ (ATR) 3399 (b, N—H), 3214, 3044, 2964, 2882, 1606, 1541, 1336, 1152, 1084, 1020, 850 cm⁻¹. m/z (LC-MS ESI+) 246.240 [M+H]⁺. Accurate mass (ES+) found [M+H]⁺ 246.0546, C₈H₁₂N₃O₄S requires M 246.0549.

N-[2′-(methylamino)ethyl]naphthalene-1-sulfonamide Hydrochloride (JAR493)

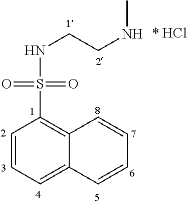 [SMILES: CNCCNS(=O)(=O)c1cccc2ccccc12]

Compound was prepared through general procedure A, starting with tert-butyl N-methyl-N-[2′-(naphthalene-1-sulfonamido)ethyl]carbamate (20.0 mg, 0.055 mmol, 1.00 eq) to yield the title compound as a white amorphous solid (15.8 mg, 0.053 mmol, 96%). δ_{H} (400 MHz, MeOD) 8.68 (1H, dd, J=8.5, 1.0 Hz, 5-H), 8.29-8.17 (2H, m, 2-H, 4-H), 8.09-8.02 (1H, m, 8-H), 7.73 (1H, ddd, J=8.5, 6.9, 1.5 Hz, 6-H), 7.70-7.59 (2H, m, 7-H, 3-H), 3.15-3.02 (4H, m, 1′H, 2′H), 2.73 (3H, s, NH—CH₃). δ_{C} (101 MHz, MeOD) 134.6 (C-2), 134.3 (C-1), 134.0 (C-4a), 129.3 (C-5), 128.9 (C-4), 128.0 (C-7), 127.9 (C-8), 126.8 (C-8a), 124.1 (C-6), 124.0 (C-3′), 48.6 (NH—CH₃), 38.6 (C-2′), 32.4 (C-1′). vₘₐₓ (ATR) 3353 (b, N—H), 2981, 2485, 2073, 1116, 974 cm⁻¹. m/z (LC-MS ESI+) 265.281 [M+H]⁺. Accurate mass (ES+) found [M+H]⁺ 265.1013, C₁₃H₁₇N₂O₂S requires M 265.1011.

N-(3′-aminopropyl)naphthalene-1-sulfonamide Hydrochloride (JAR481)

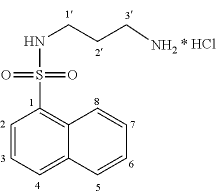 [SMILES: NCCCNS(=O)(=O)c1cccc2ccccc12]

Compound was prepared through general procedure A, starting with tert-butyl N-[3-(naphthalene-1-sulfonamido)propyl]carbamate (20.0 mg, 0.055 mmol, 1.00 eq) to yield the title compound off white amorphous solid (16.1 mg, 0.054 mmol, 98%). δ_{H} (400 MHz, MeOD) 8.33 (1H, dd, J=8.6, 1.1 Hz, 5-H), 7.87 (1H. dd, J=7.3, 1.1 Hz, 2-H), 7.82 (1H, dt, J=8.3, 1.1 Hz, 4-H), 7.72-7.64 (1-H, m, 8-H), 7.36 (1H, ddd, J=8.6, 6.9, 1.5 Hz, 6-H), 7.32-7.22 (2H, m, 7-H, 3-H), 2.60 (4H, m, 3′H, 1′H), 1.51-1.39 (2H, m, 2′-H). δ_{C} (101 MHz, MeOD) 136.4 (C-2), 135.9 (C-1), 135.3 (C-4a), 130.2 (C-5), 130.2 (C-4), 129.3 (C-7), 129.2 (C-8), 128.0 (C-8a), 125.7 (C-6), 125.3 9C-3), 40.8 (C-2′), 38.3 (C-1′), 29.1 (C-2′). vₘₐₓ (ATR) 3396 (b, N—H), 2981, 2885, 1382, 1319, 1155, 1134, 1084, 954 cm⁻¹. m/z (LC-MS ESI+) 265.281 [M+H]⁺, 529.482 [2M+H]⁺. Accurate mass (ES+) found [M+H]⁺ 265.1021, C₁₃H₁₇N₂O₂S requires M 265.1011.

N-(2′-aminoethyl)-N-methylnaphthalene-1-sulfonamide (JAR491)

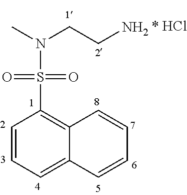 [SMILES: CN(CCN)S(=O)(=O)c1cccc2ccccc12]

Compound was prepared through general procedure A, starting with tert-butyl N-[2′-(N-methylnaphthalene-1-sulfonamido)ethyl]carbamate (20.0 mg, 0.055 mmol, 1.00 eq). The reaction was allowed to stir at room temperature for 3 hours after which volatiles were evaporated to yield the title compound as an off white amorphous solid (15.8 mg, 0.053 mmol, 96%). δ_{H} (400 MHz, MeOD) 8.81 (1H, dd, J=8.6, 1.1 Hz, 5-H), 8.24 (1H, dd, J=8.3, 1.2 Hz, 2-H), 8.18 (1H, dd, J=7.4, 1.1 Hz, 4-H), 8.10-8.05 (1H, m, 8-H), 7.77-7.62 (3H, m, 6-H, 7-H, 3-H), 3.44 (t, J=5.9 Hz, 2H), 3.18 (t, J=5.9 Hz, 2H), 2.98 (3H, s, N—CH₃). δ_{C} (101 MHz, MeOD) 134.7 (C-2), 134.4 (C-1), 133.1 (C-4a), 129.2 (C-5), 128.9 (C-4), 128.6 (C-7), 127.9 (C-8), 126.8 (C-8a), 124.6 (C-6), 124.1 (C-3), 66.7 (N—CH₃), 37.0 (C-2′), 34.4 (C-1′). vₘₐₓ (ATR) 3406 (b, N—H), 2971, 2917, 1595, 1506, 1322 1155, 1127, 996, 772 cm⁻¹. m/z (LC-MS ESI+) 265.281 [M+H]⁺, 529.482 [2M+H]⁺. Accurate mass (ES+) found [M+H]⁺ 265.1010, C₁₃H₁₇N₂O₂S requires M 265.1011.

N-(2-methoxyethyl)naphthalene-2-sulfonamide (JAR401)

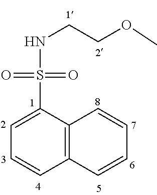 [SMILES: COCCNS(=O)(=O)c1cccc2ccccc12]

Compound was prepared through general procedure B using naphthyl-1 sulfonyl chloride (0.050 g, 0.221 mmol, 1.00 eq) and 2-methoxyethan-1-amine (0.023 mL, 0.265 mmol, 1.20 eq). Purification through flash chromatography (EtOAc in Hex, 0-50%) yielded the title compound as a white semi solid (51.0 mg, 0.192 mmol, 87.1%). 5 H (400 MHz, CDCl₃) 8.66 (1H dq, J=8.6, 1.2 Hz, 5-H), 8.29 (1H, dd, J=7.3, 1.3 Hz, 2-H), 8.10 (1H, dt, J=8.3, 1.3 Hz, 4H), 8.01-7.94 (1H, m, 8-H), 7.71 (1H, ddd, J=8.6, 6.9, 1.5 Hz, 6-H), 7.63 (1H, ddd, J=8.1, 6.9, 1.2 Hz, 7-H), 7.57 (1H, dd, J=8.2, 7.3 Hz, 3-H), 5.15 (1H, d, J=6.8 Hz, N—H), 3.26 (2H, dd, J=5.6, 4.5 Hz, 2′-H), 3.15-3.07 (5H, m, 1′-H, —OCH₃). δ_{C} (101 MHz, CDCl₃) 134.7 (C-2), 134.3 (C-1), 129.5 (C-41), 129.1 (C-5), 128.4 (C-4), 128.1 (C-7), 128.1 (C-8), 126.9 (C-8a), 124.37 (C-6), 124.2 (C-3), 70.34 (OCH₃), 58.58 (C-2′), 42.9 (C-1′). vₘₐₓ (ATR) 3296 (N—H), 2984, 2899, 1506, 1322, 1159, 1134, 755 cm⁻¹. m/z (LC-MS ESI+) 266.269 [M+H]⁺. Accurate mass (ES+) found [M+H]⁺ 266.0869, C₁₃H₁₆NO₃S requires M 266.0851.

N-[2′-(dimethylamino)ethyl]naphthalene-2-sulfonamide (JAR403)

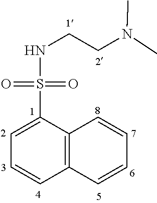 [SMILES: CN(C)CCNS(=O)(=O)c1cccc2ccccc12]

Compound was prepared through general procedure B using naphthyl-1 sulfonyl chloride (0.050 g, 0.221 mmol, 1.00 eq) and N,N dimethyl ethylene diamine (0.029 mL, 0.265 mmol, 1.20 eq) . Purification was achieved through column chromatography (EtOAc in Hex, 0-100%) to yield the title compound as a light brown oil (0.052 g, 0.187 mmol, 84.7%). 5H (400 MHz, CDC_{1 3}) 8.69 (1H, dd, J=8.6, 1.1 Hz, 5-H), 8.30 (1H, d, J=7.3 Hz, 2-H), 8.09 (1H, dt, J=8.3, 1.1 Hz, 4-H), 7.97 (1H dd, J=8.2, 1.5 Hz, 8-H), 7.71 (1H, ddd, J=8.6, 6.9, 1.5 Hz, 6-H), 7.63 (1J, dd, J=8.2, 6.9 Hz, 7-H), 7.57 (1h dd, J=8.3, 7.3 Hz, 3-H), 2.97-2.82 (4H, m, 1′-H), 2.29-2.06 (2H, m, 2′-H), 1.90 (6H, s, —N(CH₃)₂). δ_{C} (101 MHz, CDCl₃) 134.3 (C-2), 134.2 (C-1), 134.1 (C-4a), 129.9 (C-5), 129.1 (C-4), 128.3 (C-7), 128.2 (C-8), 126.7 (C-8a), 124.5 (C-6), 124.1 (C-3), 56.7 (C-1′), 44.5 (—N(CH₃)₂), 40.2 (C-2′). vₘₐₓ (ATR) 3276 (N—H), 2952, 2775, 1461, 1322, 1159, 1134, 747 cm⁻¹. m/z (LC-MS ESI+) 279.305 [M+H]⁺. Accurate mass (ES+) found [M+H]⁺ 279.1164, C₁₄H₁₉N₂O₂S requires M 279.1167.

### Hypocotyl Data

The effect of additional compounds on hypocotyl growth was investigated using the same methods as described above (100 μM of each compound was used). The results are tabulated below. The results that are indicative of growth promotion are shown in bold.

| | | | Relative | | |
|---|---|---|---|---|---|
| | | New | growth | | |
| Structure | Compound | Length | (cm) | SD | SE |
| | DMSO | 0.685514 | 0 | 0.150873 | 0.104609 |
| | eW5 | 0.92525 | 0.349717 | 0.130784 | 0.090681 |
| 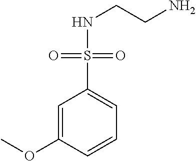 | JAR490 | 0.829938 | 0.21068 | 0.089308 | 0.061923 |
| 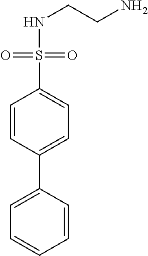 [SMILES: NCCNS(=O)(=O)c1ccc(-c2ccccc2)cc1] | JAR479 | 0.777056 | 0.133538 | 0.146684 | 0.101705 |
| 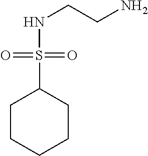 [SMILES: NCCNS(=O)(=O)C1CCCCC1] | JAR488 | 0.668 | −0.02555 | 0.15206 | 0.105433 |
| 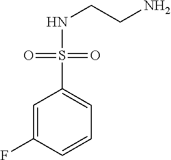 [SMILES: NCCNS(=O)(=O)c1cccc(F)c1] | JAR478 | 0.84241 | 0.228874 | 0.15438 | 0.107041 |
| 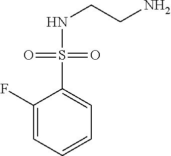 [SMILES: NCCNS(=O)(=O)c1ccccc1F] | JAR480 | 0.84241 | 0.228874 | 0.15438 | 0.107041 |
| 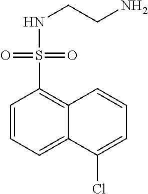 [SMILES: NCCNS(=O)(=O)c1cccc2c(Cl)cccc12] | JAR482 | 0.588811 | −0.14107 | 0.114856 | 0.079637 |
| 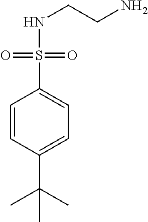 [SMILES: CC(C)(C)c1ccc(S(=O)(=O)NCCN)cc1] | JAR484 | 0.871318 | 0.271043 | 0.12078 | 0.083744 |
| 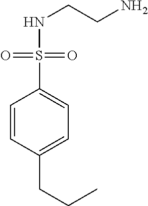 [SMILES: CCCc1ccc(S(=O)(=O)NCCN)cc1] | JAR489 | 0.913301 | 0.332286 | 0.1044 | 0.072387 |
| 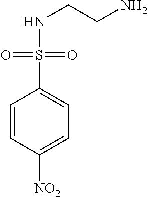 [SMILES: NCCNS(=O)(=O)c1ccc([N+](=O)[O-])cc1] | JAR483 | 0.870656 | 0.270078 | 0.144058 | 0.099884 |
| 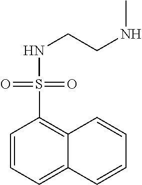 [SMILES: CNCCNS(=O)(=O)c1cccc2ccccc12] | JAR493 | 0.897022 | 0.308539 | 0.089466 | 0.062032 |
| 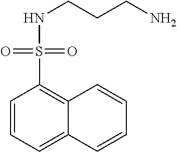 [SMILES: NCCCNS(=O)(=O)c1cccc2ccccc12] | JAR481 | 0.807186 | 0.17749 | 0.098451 | 0.068262 |
| 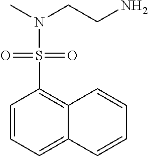 [SMILES: CN(CCN)S(=O)(=O)c1cccc2ccccc12] | JAR491 | 0.828463 | 0.208528 | 0.103219 | 0.071568 |
| 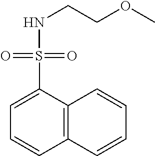 [SMILES: COCCNS(=O)(=O)c1cccc2ccccc12] | JAR401 | 0.550143 | −0.19747 | 0.121426 | 0.084192 |
| 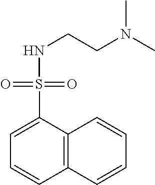 [SMILES: CN(C)CCNS(=O)(=O)c1cccc2ccccc12] | JAR403 | 0.60113 | −0.1231 | 0.18221 | 0.126337 |

1-31. (canceled)

32. A method of promoting plant growth comprising contacting a plant, seed, bulb or tuber with a compound or selection of compounds of formula (I) and optionally a fertiliser, wherein the compound of formula al is: 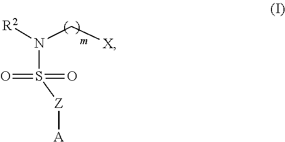
wherein Z-A is any one of the structures represented by formulae (IIIb), (IVb), (Vb) and (VIb): 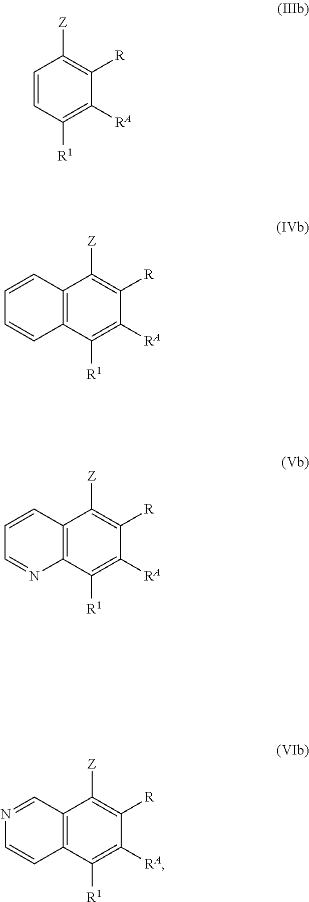
X is NH₂, NHCH₃ or NHCH₂CH₃,
Z is —(CH₂)ₙ— or —O(CH₂)ₙ—, wherein n is 0 or 1,
m is 2, 3 or 4,
R is selected from the group consisting of H, C₁-C₈alkyleneoxyC₁-C₈alkoxy, C₁-C₈alkyl, C₁-C₄alkoxy, fluoro, nitro and optionally substituted phenyl,
R¹ is selected from the group consisting of H, C₁-C₈alkyleneoxyC₁-C₈alkoxy, C₁-C₈alkyl, C₁-C₄alkoxy, optionally substituted phenyl, nitro and fluoro,
R^{A} is selected from the group consisting of H, C₁-C₄alkoxy, fluoro, C₁-C₈alkyleneoxyC₁-C₈alkoxy, C₁-C₈alkyl, optionally substituted phenyl and nitro,
R² is H, C₁-C₄alkyl or of formula (II): 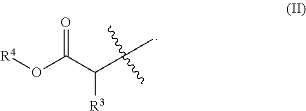
wherein R₃ and R₄ are each H or C₁-C₄alkyl.

33. The method of claim 32, wherein Z is:
(i) —(CH₂)₀— or Z is —O(CH₂)₁—; or
(ii) —(CH₂)₀—.

34. The method of claim 32, wherein X is NH₂ or NHCH₃.

35. The method of claim 32, wherein m is 2 or 3, such as 2.

36. The method of claim 32, wherein at least two of R, R¹ and R^{A} are H.

37. The method of claim 32, wherein R is selected from:
(i) the group consisting of H, C₁-C₂alkyleneoxyC₁-C₂alkoxy, C₁-C₄alkyl, C₁-C₄alkoxy, fluoro and nitro; or
(ii) the group consisting of H, ethoxyethoxy, methoxy and fluoro.

38. The method of claim 32, wherein R¹ is selected from:
(i) the group consisting of H, C₁-C₂alkyleneoxyC₁-C₂alkoxy, C₁-C₄alkyl, C₁-C₄alkoxy, phenyl, nitro and fluoro; or
(ii) the group consisting of H, ethoxyethoxy, methyl, ethyl, n-propyl, tent-butyl, methoxy, phenyl and nitro.

39. The method of claim 32, wherein R^{A} is selected from:
(i) the group consisting of H, C₁-C₄alkoxy, fluoro, C₁-C₂alkyleneoxyC₁-C₂alkoxy, C₁-C₄alkyl, phenyl and nitro; or
(ii) the group consisting of H, methoxy and fluoro.

40. The method of claim 32, wherein:
(i) R^{A} is H and R and R¹ are each independently selected from the group consisting of H, C₁-C₈alkyleneoxyC₁-C₈alkoxy, C₁-C₈alkyl and C₁-C₄alkoxy;
(ii) R^{A} is H and R and R¹ are each independently selected from the group consisting of H, ethoxyethoxy, methyl, ethyl, n-propyl and methoxy; or
(iii) R^{A} is H and R and R¹ are each independently selected from the group consisting of H, ethoxyethoxy and methoxy.

41. The method of claim 32, wherein R² is H, methyl or of formula (II).

42. The method of claim 32, wherein R³ is H or methyl, such as H.

43. The method of claim 32, wherein R⁴ is methyl or ethyl, such as ethyl.

44. The method of claim 32, wherein the compound is any one of formulae (Ia) to (Iz):

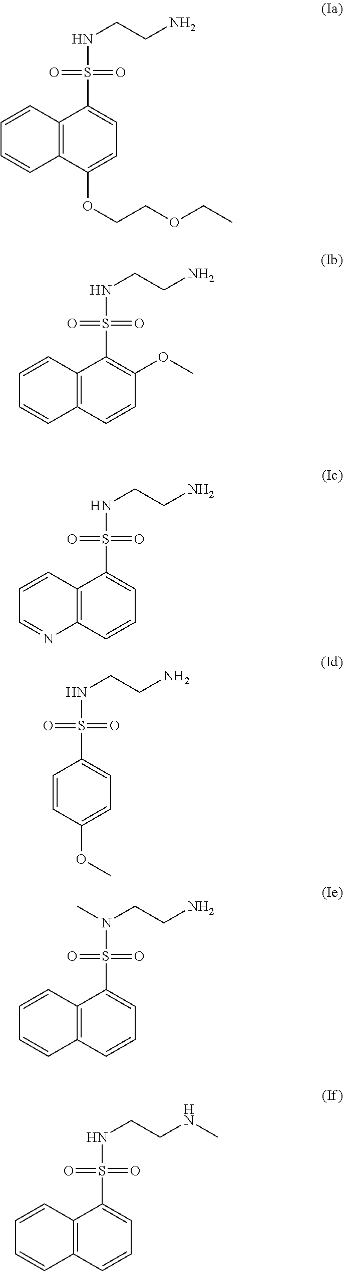

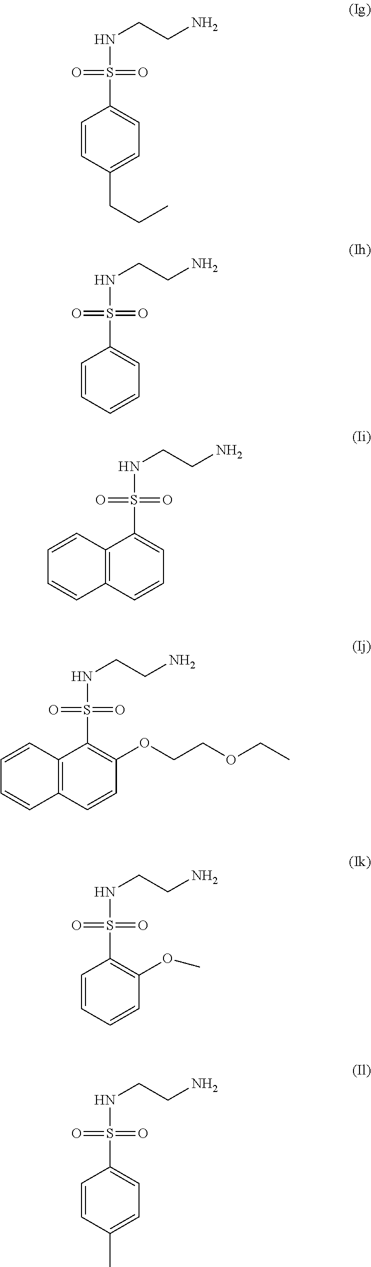

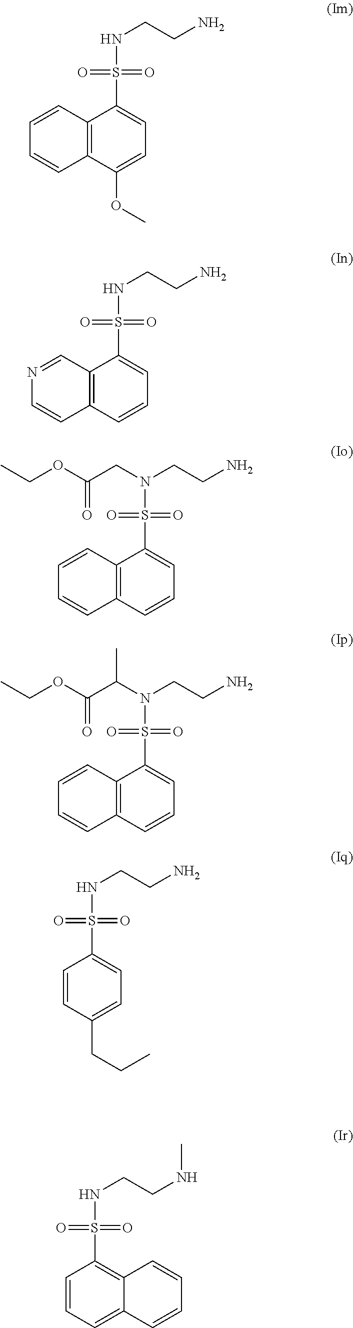

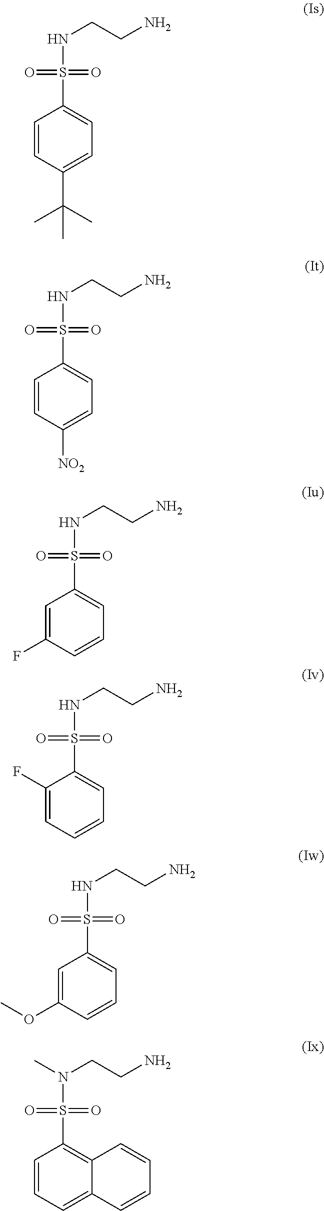

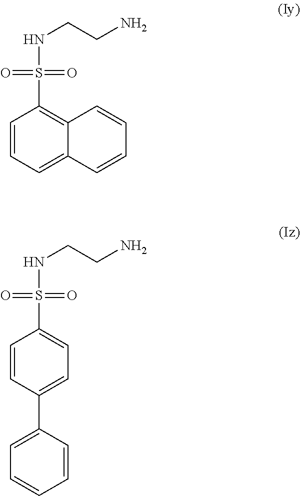 [SMILES: NCCNS(=O)(=O)c1cccc2ccccc12 ; NCCNS(=O)(=O)c1ccc(-c2ccccc2)cc1]

45. The method of claim 32, wherein the compound is any one of formulae (Ia) to (IP):

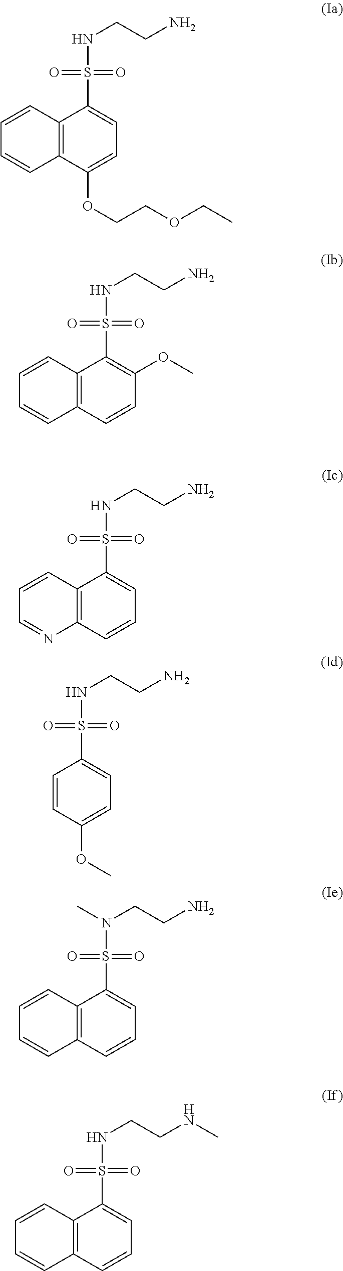

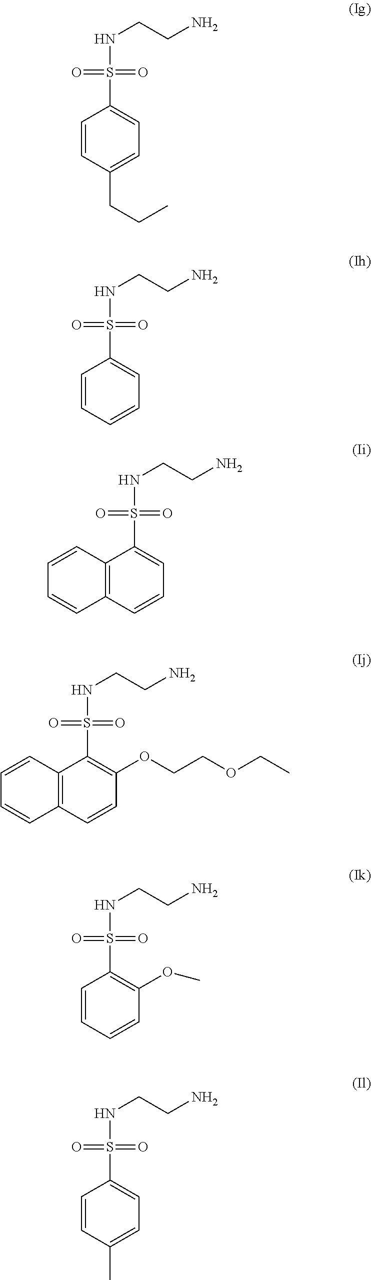 [SMILES: CCCc1ccc(S(=O)(=O)NCCN)cc1 ; NCCNS(=O)(=O)c1ccccc1 ; NCCNS(=O)(=O)c1cccc2ccccc12 ; CCOCCOc1ccc2ccccc2c1S(=O)(=O)NCCN ; COc1ccccc1S(=O)(=O)NCCN ; Cc1ccc(S(=O)(=O)NCCN)cc1]

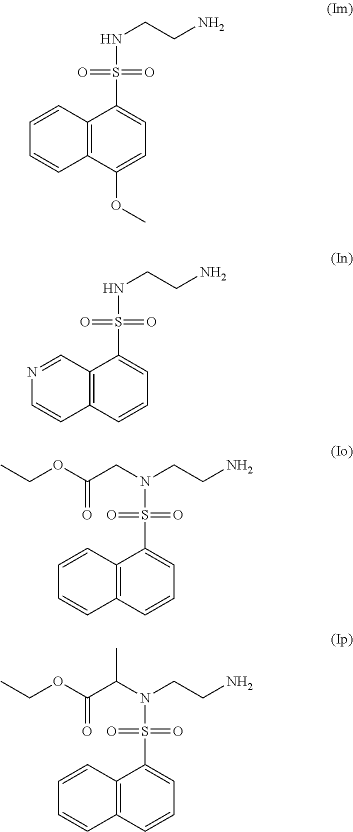

46. The method of claim 32, wherein the compound or selection of compounds is at a concentration of about 20 to 200 μM.

47. The method of claim 32, comprising contacting a seed with:
(i) a mixture comprising a compound or selection of compounds defined in claim 32 and optionally a fertiliser; and
(ii) a solvent.

48. The method of claim 47, further comprising drying the seed.

49. A composition comprising any one or a selection of compounds defined in claim 32 and a fertiliser.

50. A plant, seed, bulb or tuber comprising a compound or selection of compounds defined in claim 32 and optionally a fertiliser.

51. A plant, seed, bulb or tuber obtainable by the method of claim 32.
